(19) United States
(12) Patent Application Publication
(10) Pub. No.: US 2026/0093126 A1
(43) Pub. Date: Apr. 2, 2026

(54) LASER PROJECTION DEVICES AND RELATED METHODS

(71) Applicant: Meta Platforms Technologies, LLC, Menlo Park, CA (US)

(72) Inventors: Zhuoliang Ni, Kenmore, WA (US); Wai Sze Tiffany Lam, Lynnwood, WA (US); Wanli Chi, Sammamish, WA (US); Jacques Gollier, Sammamish, WA (US); Zhimin Shi, Bellevue, WA (US); Ziyuan Zhou, Redmond, WA (US)

(21) Appl. No.: 19/345,555

(22) Filed: Sep. 30, 2025

Related U.S. Application Data
(60) Provisional application No. 63/701,784, filed on Oct. 1, 2024.
(60) Provisional application No. 63/713,745, filed on Oct. 30, 2024.
(60) Provisional application No. 63/713,754, filed on Oct. 30, 2024.

(51) Int. Cl. G02B 27/48; G02B 27/09; G02B 27/10; G02B 27/42; G03B 21/00; G03B 21/20

(52) U.S. Cl. CPC G02B 27/48; G02B 27/0961; G02B 27/1033; G02B 27/4261; G03B 21/006; G03B 21/2033

(57) ABSTRACT

A display system includes a narrow band light source having a bandwidth (Δλ), an illumination module optically coupled to the light source, a spatial light modulator arranged to be illuminated by the array of diffusing elements, and a projector system configured to substantially collimate light received from the spatial light modulator, where the illumination module includes a 2D array of diffusing elements and a coherent length (λ²/Δλ) of the light source is less than a difference between an optical path length from the light source to a first diffusing element and an optical path length from the light source to a second diffusing element.

### CROSS-REFERENCE TO RELATED APPLICATIONS

This application claims the benefit of priority under 35 U.S.C. § 119(e) of U.S. Provisional Application No. 63/701,784, filed Oct. 1, 2024, U.S. Provisional Application No. 63/713,745, filed Oct. 30, 2024, and U.S. Provisional Application No. 63/713,754, filed Oct. 30, 2024, the contents of which are incorporated herein by reference in their entirety.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a schematic cross-sectional view of exemplary LCoS display engines having different projector configurations according to some embodiments.

FIG. 2 is a schematic cross-sectional view of an LCoS display system including an illumination module having a refractive grating element with a co-integrated microlens array according to some embodiments.

FIG. 3 is a schematic cross-sectional view of the LCoS display system of FIG. 2, including polarization states for source light and image light according to certain embodiments.

FIG. 4 is a schematic cross-sectional view of an LCoS display system illustrating principles of contrast reduction according to various embodiments.

FIG. 5 illustrates principles of contrast reduction in example LCoS display systems according to certain embodiments.

FIG. 6 shows single color pupil intensity maps in an exampled display system according to some embodiments.

FIG. 7 is a contrast map over an entire field of view for a display system including a co-integrated VBG/MLA according to some embodiments.

FIG. 8 is a graph of contrast as a function of grating thickness for green light in an example LCoS display according to various embodiments.

FIG. 9 is a map showing multi-color exposure leakage light for an example display system according to certain embodiments.

FIG. 10 shows contrast maps over an entire field of view for red, green, and blue image light according to some embodiments.

FIG. 11 is a plot of contrast for green light versus grating element thickness according to some embodiments.

FIG. 12 are graphs of contrast versus grating element thickness for red, green, and blue image light according to certain embodiments.

FIG. 13 shows the influence of grating element thickness on various design considerations according to some embodiments.

FIG. 14 is a schematic cross-sectional view of an LCoS display system illustrating principles of contrast reduction according to various embodiments.

FIG. 15 shows a simulation of contrast reduction due to conical diffraction of source light according to certain embodiments.

FIG. 16 shows the combined effect on contrast of illumination light polarization state uniformity and image light polarization state uniformity according to some embodiments.

FIG. 17 is a graphic showing the effects of light leakage due to illumination light polarization state variability on corner contrast according to certain embodiments.

FIG. 18 illustrates example split grating element architectures for improving corner contrast according to some embodiments.

FIG. 19 illustrates an example method for manufacturing a display system including an illumination module with a co-integrated diffractive grating element and a one-way diffuser according to some embodiments.

FIG. 20 is a schematic cross-sectional view of an LCoS display engine including a one-way diffuser according to some embodiments.

FIG. 21 shows the operation of a one-way diffuser in accordance with various embodiments.

FIG. 22 shows illustrations of example one-way diffuser architectures according to some embodiments.

FIG. 23 is a schematic view of an LCoS display engine including a lenslet array according to some embodiments.

FIG. 24 is a schematic cross-sectional view of an integrated LCoS display engine according to some embodiments.

FIG. 25 shows example cross-sectional views of integrated LCoS display engines according to further embodiments.

FIG. 26 is an illustration of an example artificial-reality system according to some embodiments of this disclosure.

FIG. 27 is an illustration of an example artificial-reality system with a handheld device according to some embodiments of this disclosure.

FIG. 28A is an illustration of example user interactions within an artificial-reality system according to some embodiments of this disclosure.

FIG. 28B is an illustration of example user interactions within an artificial-reality system according to some embodiments of this disclosure.

FIG. 29A is an illustration of example user interactions within an artificial-reality system according to some embodiments of this disclosure.

FIG. 29B is an illustration of example user interactions within an artificial-reality system according to some embodiments of this disclosure.

FIG. 30 is an illustration of an example wrist-wearable device of an artificial-reality system according to some embodiments of this disclosure.

FIG. 31 is an illustration of an example wearable artificial-reality system according to some embodiments of this disclosure.

FIG. 32 is an illustration of an example augmented-reality system according to some embodiments of this disclosure.

FIG. 33A is an illustration of an example virtual-reality system according to some embodiments of this disclosure.

FIG. 33B is an illustration of another perspective of the virtual-reality system shown in FIG. 33A.

FIG. 34 is a block diagram showing system components of example artificial-and virtual-reality systems.

FIG. 35A is an illustration of an example intermediary processing device according to embodiments of this disclosure.

FIG. 35B is a perspective view of the intermediary processing device shown in FIG. 35A.

FIG. 36 is a block diagram showing example components of the intermediary processing device illustrated in FIGS. 35A and 35B.

FIG. 37A is front view of an example haptic feedback device according to embodiments of this disclosure.

FIG. 37B is a back view of the example haptic feedback device shown in FIG. FIG. 37A according to embodiments of this disclosure.

FIG. 38 is a block diagram of example components of a haptic feedback device according to embodiments of this disclosure.

FIG. 39 an illustration of an example system that incorporates an eye-tracking subsystem capable of tracking a user's eye(s).

FIG. 40 is a more detailed illustration of various aspects of the eye-tracking subsystem illustrated in FIG. 39.

FIG. 41 is an illustration of an example fluidic control system that may be used in connection with embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within this disclosure.

### DETAILED DESCRIPTION OF EXEMPLARY EMBODIMENTS

Virtual reality (VR) and augmented reality (AR) eyewear devices and headsets enable users to experience events, such as interactions with people in a computer-generated simulation of a three-dimensional world or viewing data superimposed on a real-world view. Superimposing information onto a field of view may be achieved through an optical head-mounted display (OHMD) or by using embedded wireless glasses with a transparent heads-up display (HUD) or augmented reality overlay. VR/AR eyewear devices and headsets may be used for a variety of purposes. Governments may use such devices for military training, medical professionals may use such devices to simulate surgery, and engineers may use such devices as design visualization aids.

Virtual reality and augmented reality devices and headsets typically include an optical system having a microdisplay and imaging optics. Display light may be generated and projected to the eyes of a user using a display system where the light is in-coupled into a waveguide, transported therethrough by total internal reflection (TIR), replicated to form an expanded field of view, and out-coupled when reaching the position of a viewer's eye.

The microdisplay may be configured to provide an image to be viewed either directly or indirectly using, for example, a micro OLED display or by illuminating a liquid-crystal based display such as a liquid crystal on silicon (LCoS) microdisplay. Liquid crystal on silicon is a miniaturized reflective active-matrix display having a liquid crystal layer disposed over a silicon backplane. During operation, light from a light source is directed at the liquid crystal layer and as the local orientation of the liquid crystals is modulated by a pixel-specific applied voltage, the phase retardation of the incident wavefront can be controlled to generate an image from the reflected light. In some instantiations, a liquid crystal on silicon display may be referred to as a spatial light modulator.

LCoS-based projectors typically use a single LCoS display to modulate red, green, and blue light sequentially to generate a color image. An LCoS projector may be configured to deliver the red, green, and blue components of image light, which may result in a projected image having rich and well-saturated colors. As will be appreciated, an LCoS display may be configured for wavelength selective switching, structured illumination, optical pulse shaping, in addition to near-eye displays.

Due at least in part to inherent high resolution and high fill factors (minimal inter-pixel spacing), visible pixelation on an LCoS machine may be essentially nonexistent resulting in a continuous high fidelity image. Moreover, in contrast to micro-mirror based projection systems that can generate high frequencies that accentuate their digital nature, LCoS pixel edges tend to be smoother, which may give them an analog-like response resulting in a more natural image.

Notwithstanding recent developments, it would be advantageous to develop an LCoS display engine having a commercially-relevant form factor and weight, particularly for use in portable and wearable optics such as AR glasses.

In various embodiments, an LCoS display engine may be fitted with a polarization selective diffuser that is configured to interact with and diffuse light having a first polarization state while remaining essentially transparent to light having a second polarization state.

In various embodiments, an LCoS display engine may include a microlens array (MLA) that is configured to interact with and diffuse light passing therethrough in a first direction while remaining essentially transparent to light passing in a second direction. Such a display engine may be integrated with various display waveguide architectures, including geometric waveguides (GWG), surface relief gratings (SRG), polarization volume holograms (PVH), volumetric Bragg gratings (VBG), etc.

The intervening diffuser is configured to diffuse light having one polarization state (e.g., p-polarized light) and transmit light having a complementary polarization state (e.g., s-polarized light).

As disclosed herein, in some embodiments, an LCoS display engine is configured without a polarization beam splitter. In accordance with certain embodiments, a display engine includes a light source, an illumination module, an LCoS display panel, and a polarization selective diffuser located between the illumination module and the display panel. In accordance with certain embodiments, a display engine includes a light source, an illumination module, an LCoS display panel, and an angularly selective microlens array incorporated into the illumination module. In particular embodiments, the illumination module includes a refractive grating element and the microlens array is co-integrated with the refractive grating element. The display may additionally include a waveguide and projection optics configured to direct image light reflected from the LCoS display panel to the waveguide.

In some embodiments, the light source may be a narrow band light source. As used herein, a narrow band light source is a light-emitting device that produces light concentrated within a limited range of wavelengths, resulting in a small spectral bandwidth (Δλ). The emitted light is nearly monochromatic, with most of its energy confined to a specific color or wavelength region. In some embodiments, a narrow band light source may have an output bandwidth of less than 5 nm. Examples light sources include certain types of lasers and light-emitting diodes (LEDs) designed for precise wavelength output.

The light source may include a laser that is optically coupled to the illumination module. The illumination module is configured to receive source light from the light source and direct the source light as collimated and polarized light toward the display panel. The microlens array is configured to diffuse light passing from the illumination module to the display panel (e.g., p-polarized light directed at the display panel) and transmit light returning to the illumination module from the display panel (e.g., s-polarized light reflected from the display panel).

In accordance with various embodiments, the illumination module may include a grating element, such as a volumetric Bragg grating (VBG). The microlens array may include a plurality of lenslets distributed across two dimensions that are co-integrated with the grating element. In particular embodiments, the grating element and the microlens array may be co-extensive.

During operation, the grating element/microlens array may be configured to both modulate source light and direct the transformed source light to the display panel and receive image light from the display panel and pass the image light without any substantial alteration thereto.

In accordance with various embodiments, the diffuser may include a liquid crystal (LC) element that may be tuned in real time to decrease wave interference (i.e., speckle) and enhance display image quality. By way of example, the diffuser may include a liquid crystal layer, such as an actuatable liquid crystal polymer network or an electroded liquid crystal layer having a variable thickness profile. Such diffusers may be tuned by applying a high-frequency voltage signal thereto. In further examples, the diffuser may include a static element. According to further examples, the diffuser may include a grating element, such as a volumetric Bragg grating. A driving module including a piezoelectric element, for example, may be used to induce oscillations in the grating element or such a driving module may be omitted.

Features from any of the embodiments described herein may be used in combination with one another in accordance with the general principles described herein. These and other embodiments, features, and advantages will be more fully understood upon reading the following detailed description in conjunction with the accompanying drawings and claims.

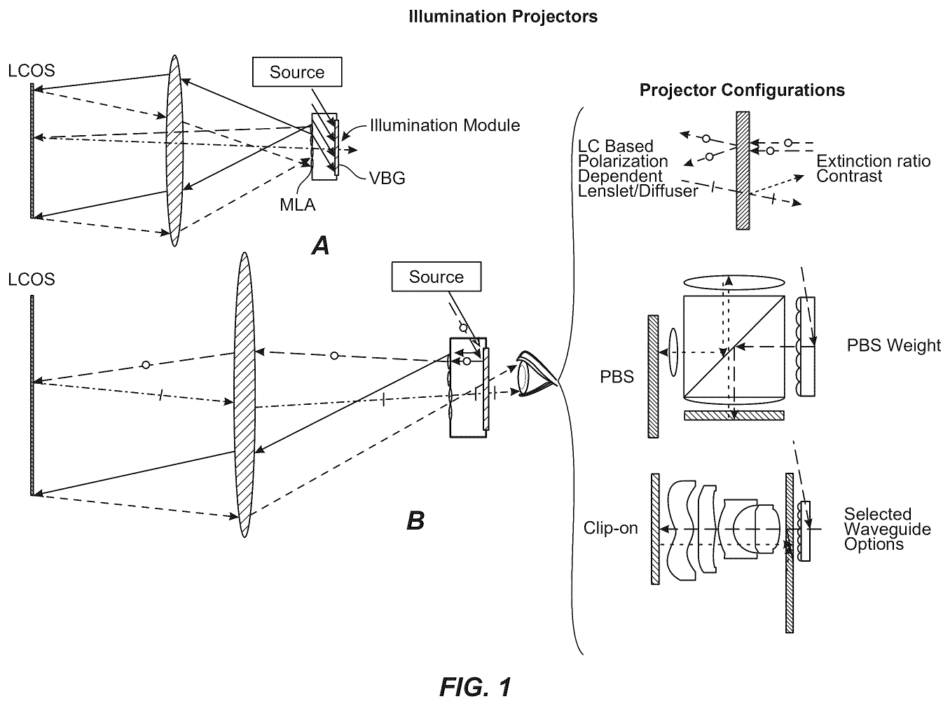

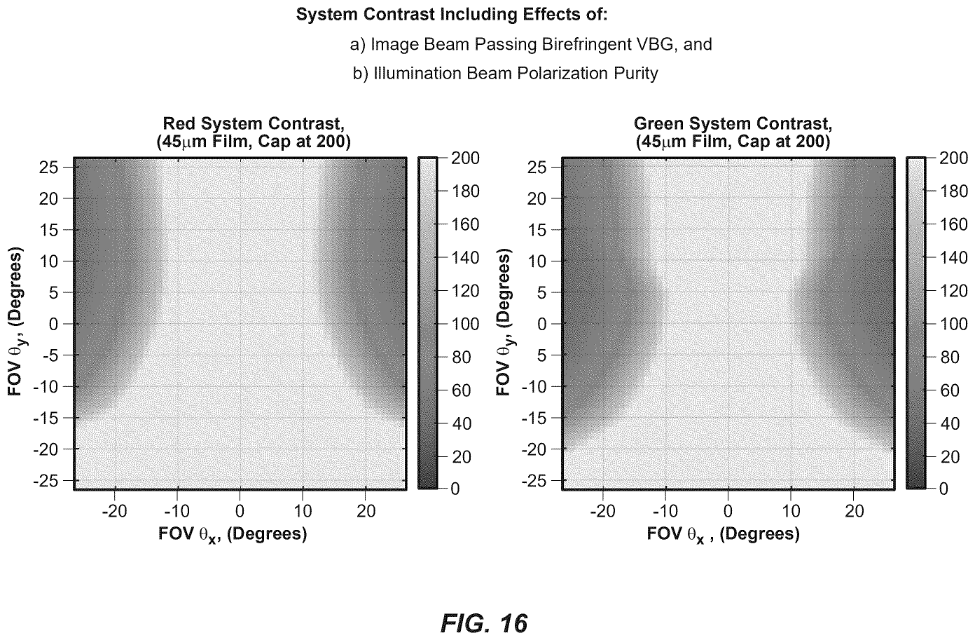

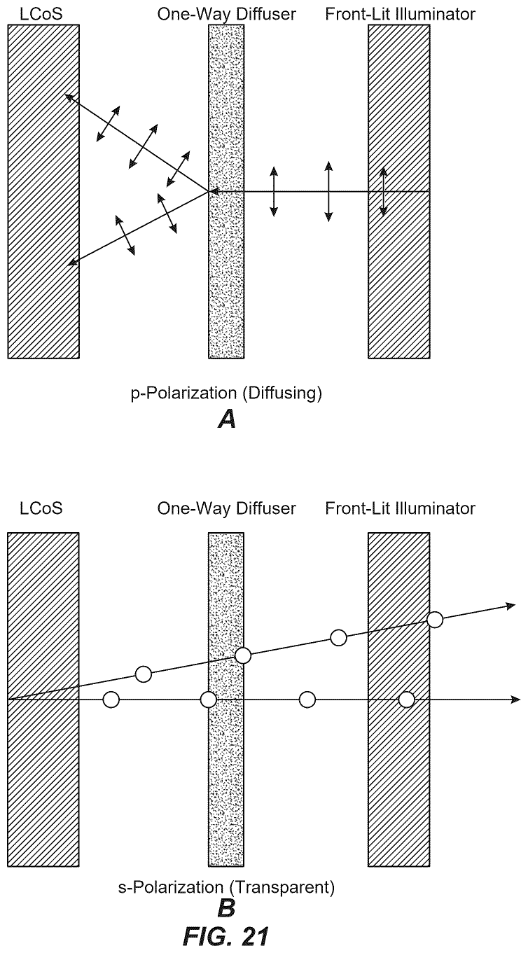

The following will provide, with reference to FIGS. 1-41, detailed descriptions of display systems including a polarization selective diffuser located proximate to the display panel. The discussion associated with FIGS. 1-19 includes a description of example display system architectures including an angularly selective lenslet array (i.e., microlens array). The discussion associated with FIGS. 20-25 includes a description of example system and diffuser architectures. The discussion associated with FIGS. 26-41 relates to exemplary augmented reality and virtual reality devices and systems that may include a polarization selective diffuser as disclosed herein.

Referring to FIG. 1A, in an example LCoS display engine, source light may be diffracted by an illumination module and directed to an LCoS panel. In the illustrated configuration, collimated light from a light source (e.g., laser) may illuminate a grating element located on a back surface of the illumination module. The grating element may include a volumetric Bragg grating (VBG). The source light refracted by the grating element may pass through a microlens array (MLA) located on a front surface of the illumination module. The MLA may diffuse the collimated light, and the diffused light may be directed to the LCoS display panel via a projection lens. Light reflected from the display panel may return through the projection lens and pass again through the microlens array but without any divergent effect.

Referring to FIG. 1B, in a more detailed view, shown is the polarization state for one beam of light interacting with the display system. As will be appreciated, light directed at the display panel may have a first polarization state (e.g., s-polarized source light) while light reflected from the display panel may have a second polarizations state (e.g., p-polarized image light).

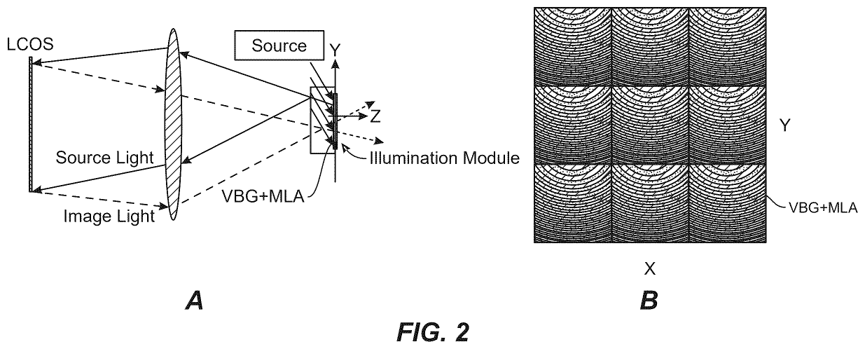

Referring to FIG. 2, shown is an example LCoS display engine with an illumination module having a grating element and a co-integrated microlens array (MLA). Ray tracings are depicted in FIG. 2A and a plan view of the grating element/microlens array is depicted in FIG. 2B. The grating element may include an off-axis Fresnel VBG element that is configured as a 2D array capable of providing both beam expansion and angular spread. The lenslet array may be configured to have positive optical power or negative optical power. A projector lens configured with negative optical power may be shorter than a projector lens having positive optical power.

According to some embodiments, a lenslet array may be paired with a grating beam expander to reduce or eliminate speckle in laser illumination. In some examples, speckle mitigation may exclude the use of moving parts. Static de-speckle can be achieved using various system-level configurations, including a liquid crystal one-way diffuser, or a holographic volume grating one-way diffuser.

Collimated light from a light source may be diffracted and diffused by the grating element and MLA and directed as illuminating light toward the display panel. In particular embodiments, the angular spread of the source light is increased by the microlens array. Image light reflected by the display panel may return through the projection lens and pass through the illumination module substantially unperturbed due to the relatively narrow angular acceptance window of the grating element. That is, the returning image light may not satisfy the Bragg condition of the grating element and may thus pass through the illumination module without further modification. In some instantiations, the grating/microlens array may be referred to as an angularly selective diffuser.

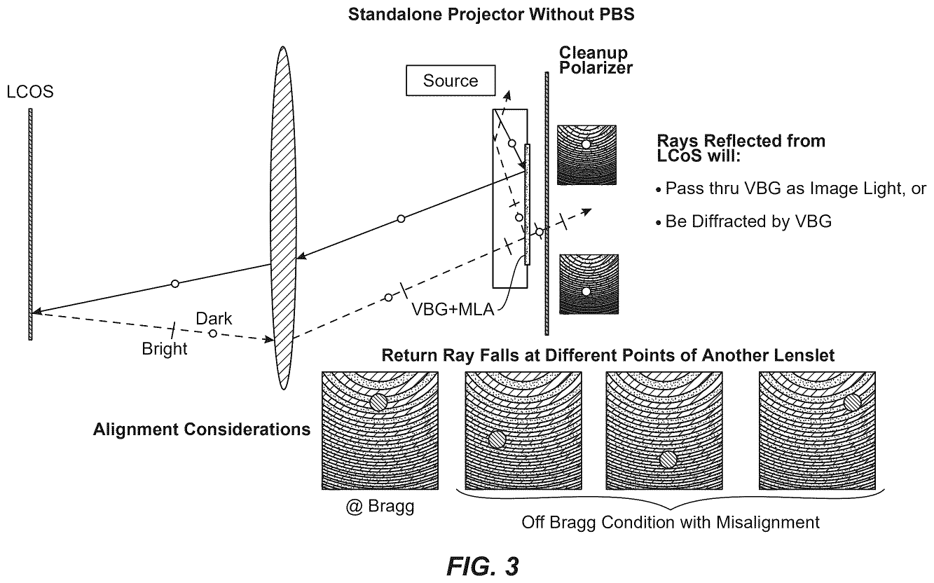

Referring to FIG. 3, shown is the LCoS display engine architecture of FIG. 2 with additional detail, including the polarization states for an example light ray and a schematic illustration of stray light generation due to the refraction of image light by the grating element. Although 0^{th} order image light returning from the display panel may pass through the grating element without further modification, 1^{st} order image light may be diffracted away from a user's eye in the direction of the illumination source and thus not adversely affect the image quality of the display.

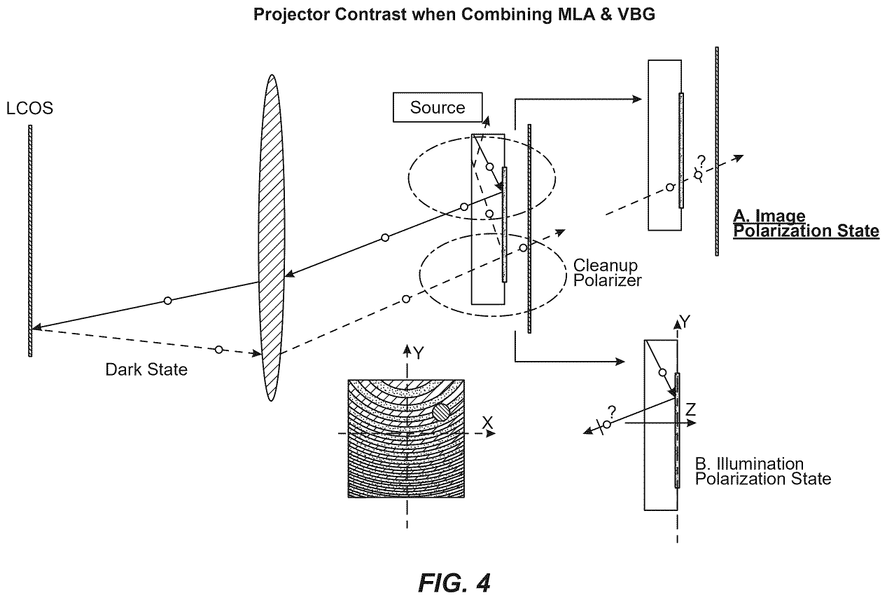

The co-integration of the microlens array with the grating element may minimally affect image contrast. As shown schematically in FIG. 4, both the polarization state of image light and the polarization state of illumination light may contribute to contrast reduction. Applicants have shown that a display system featuring a co-integrated grating element/microlens array may produce image light having a contrast ratio of at least approximately 150:1 and that these polarization state effects do not significantly impact image quality.

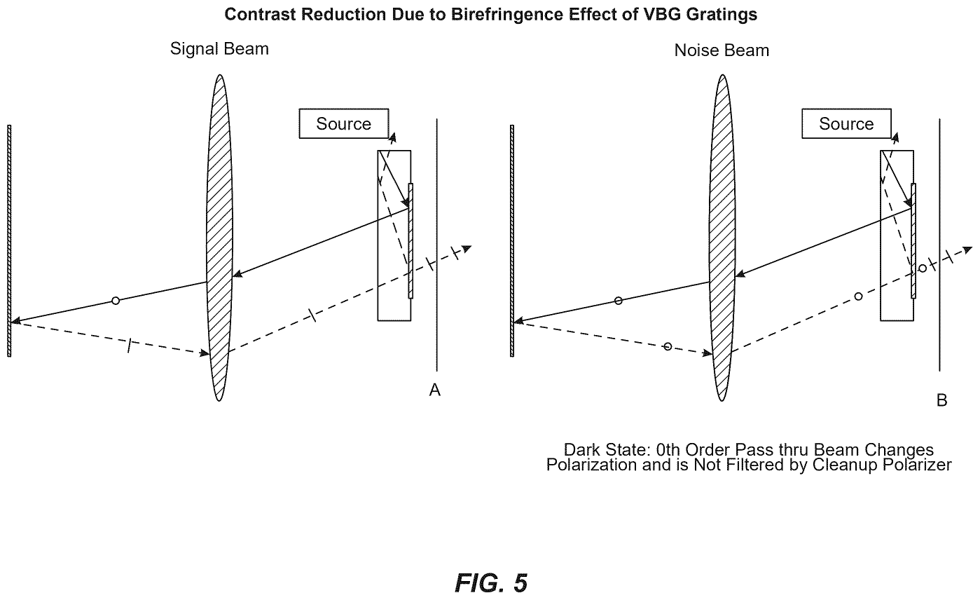

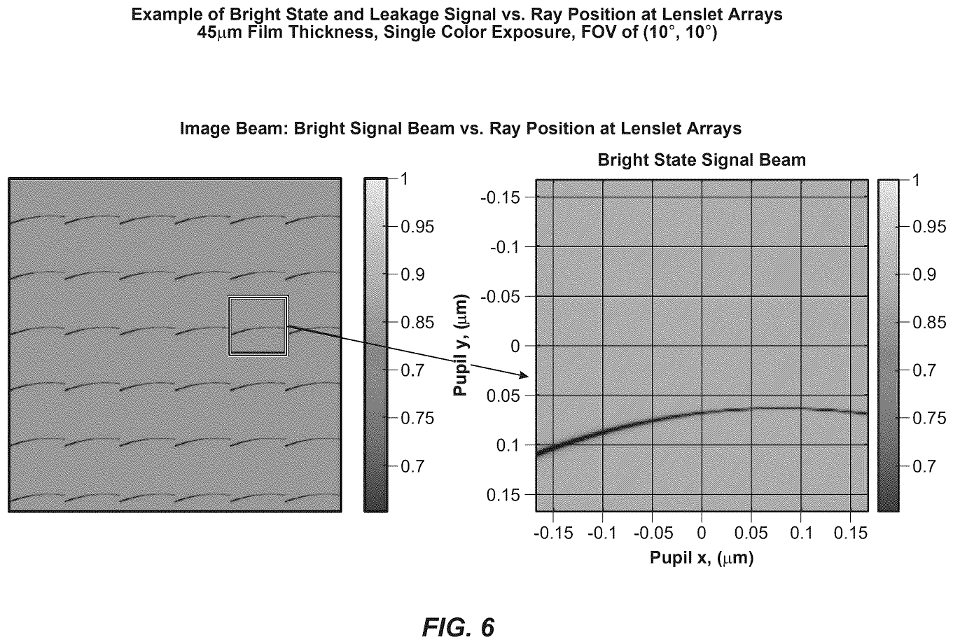

Aspects related to the polarization state of image light and its impact on the performance of an associated projected image for a VBG/one-way lenslet array-based display are shown in FIGS. 5-13. FIG. 5 illustrates principles of contrast reduction in example LCoS display systems. The white image polarization state is depicted in FIG. 5A, and the dark image polarization state is depicted in FIG. 5B. A small differential in polarization for 0^{th} order diffraction is observed, which may be influenced by the specific landing point on the lenslet array. FIG. 6 shows single color pupil intensity in an example system for a 45 micrometer grating thickness at a particular field of view (θₓ=10° and θ_{y}=10°). The mean contrast is approximately 1220:1.

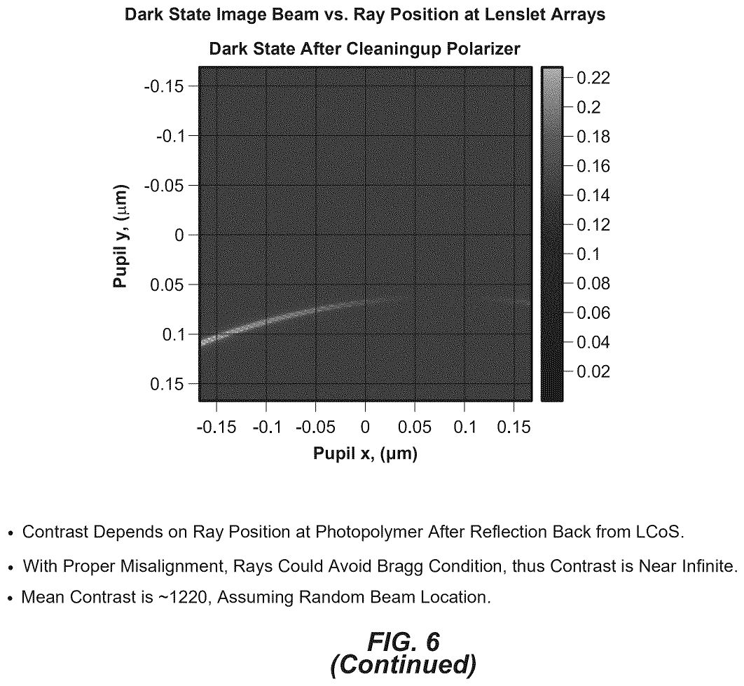

Referring to FIG. 7, shown is a contrast map over an entire field of view for a green light projector including a co-integrated VBG/MLA having a grating element thickness of approximately 45 micrometers. The mean contrast over the full field of view is approximately 990:1. Within region A, which encompasses a central 30° field of view, the mean contrast is advantageously approximately 1550:1.

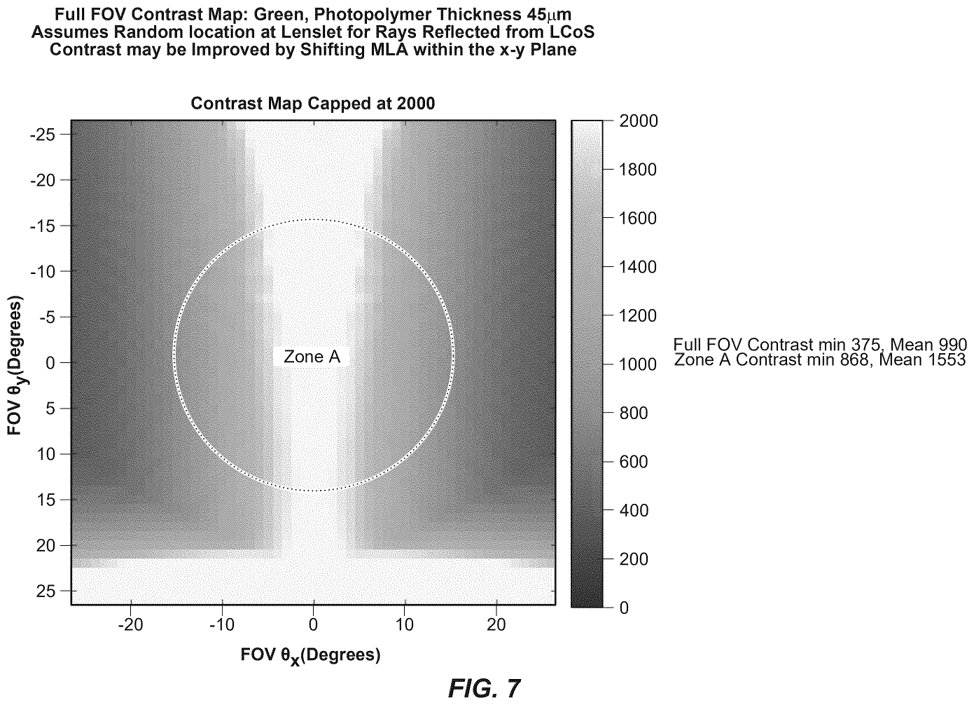

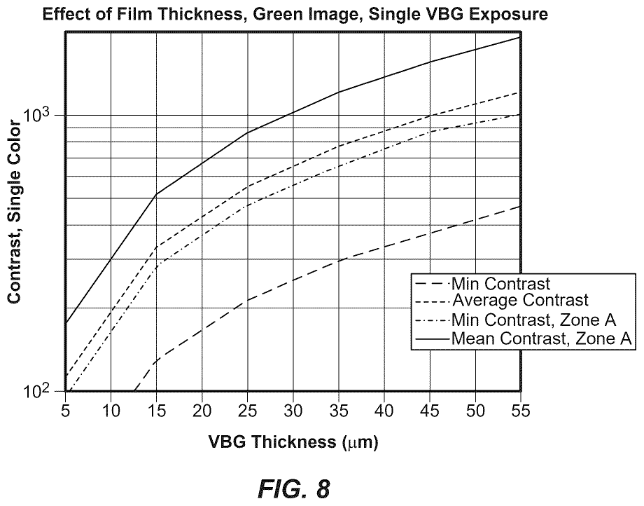

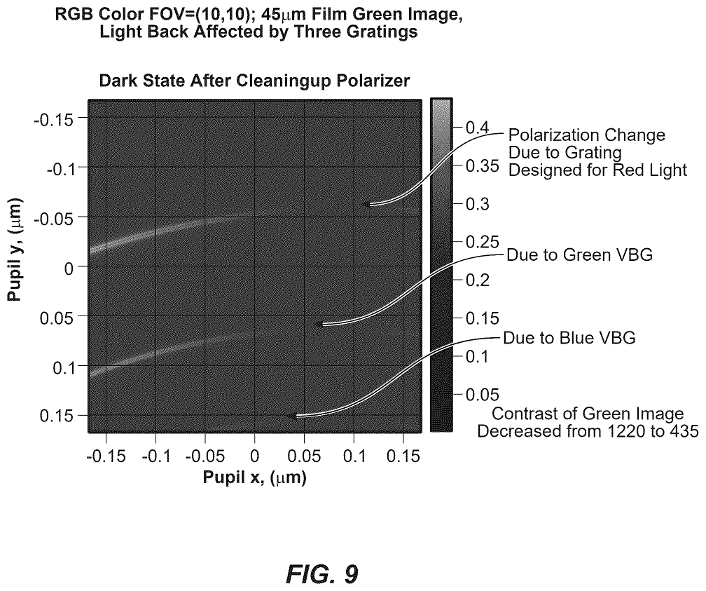

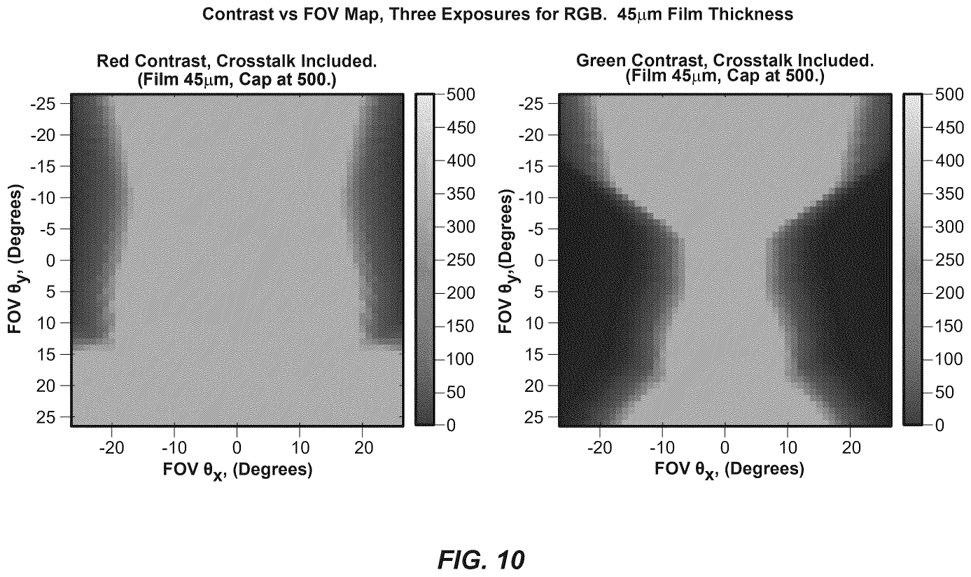

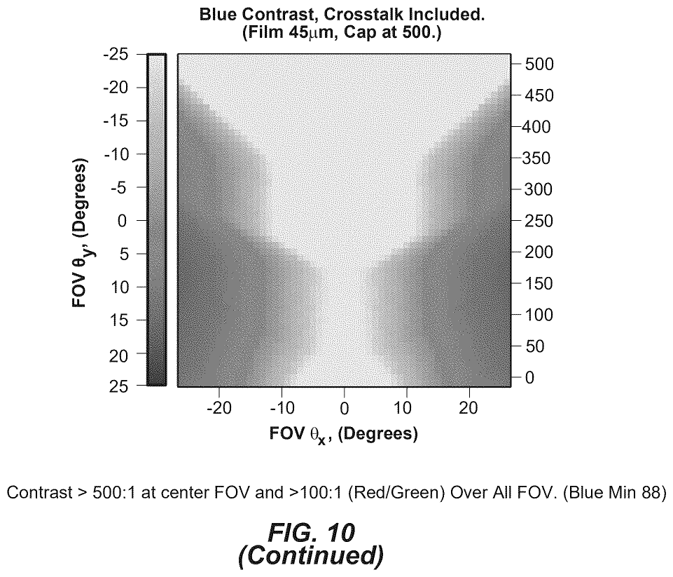

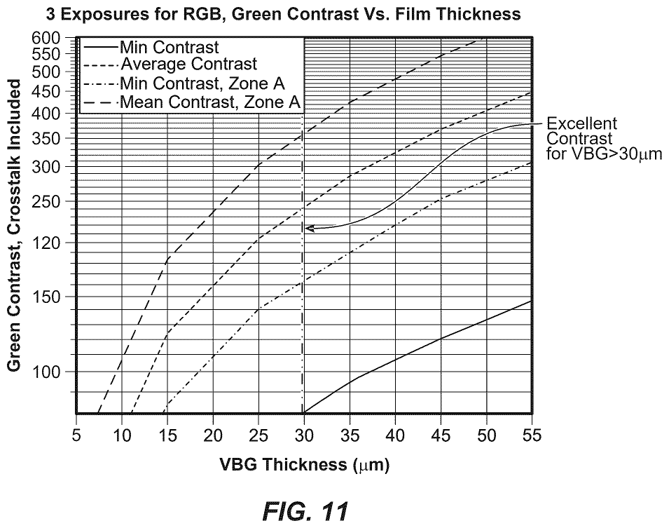

Referring to FIG. 8, shown is a graph of contrast as a function of grating thickness for green light in an example LCoS display. Turning to FIG. 9, the graphic illustrates multi-color exposure leakage light for an example display system. For the multi-color example, the green image contrast is decreased from approximately 1220:1 to approximately 435:1. Contrast maps over an entire field of view for red, green, and blue are shown in FIG. 10, and a corresponding plot of contrast for green light versus grating element thickness for polychromatic exposure (RGB) is shown in FIG. 11. Referring to FIG. 12, shown are graphs of contrast versus grating element thickness for red, green, and blue image light. The combined contrast weighting for red, green, and blue is approximately 3:6:1. Applicants have shown that the mean contrast is at least approximately 150:1, e.g., at least approximately 200:1, 250:1, or 300:1, including ranges between any of the foregoing ratios. Further considerations related to the polarization state of image light and its effect on image contrast are shown graphically in FIG. 13.

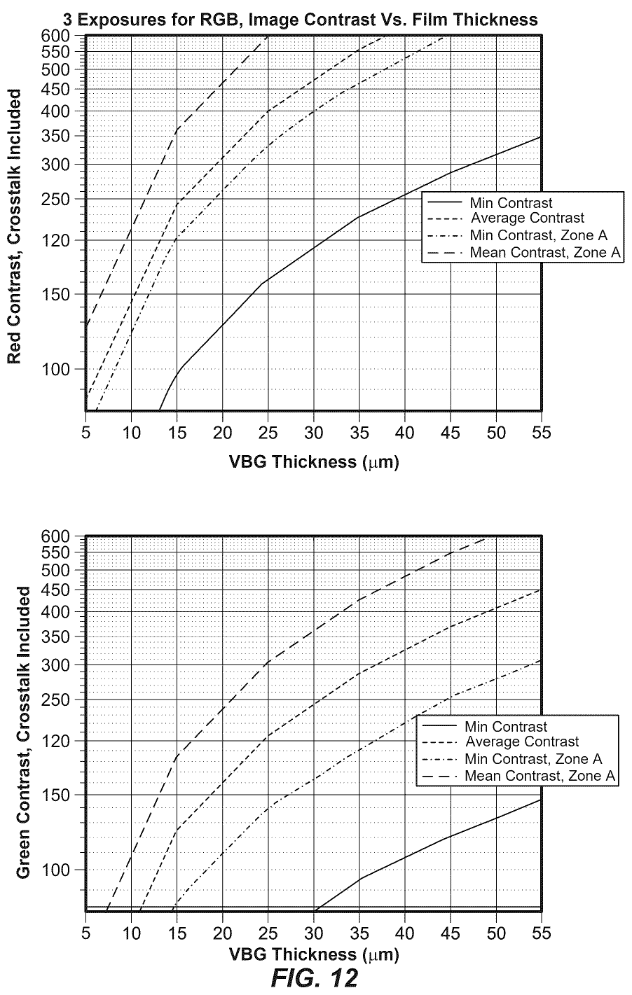

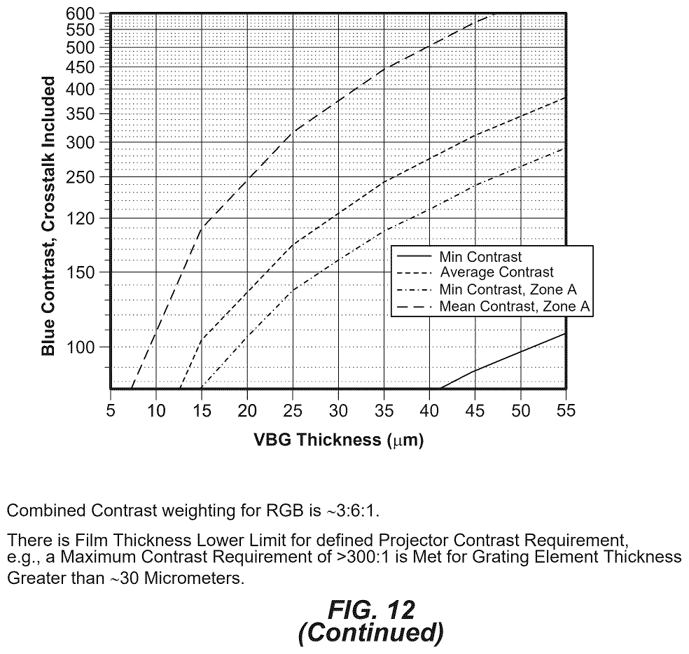

Shown schematically in FIG. 14 is an LCoS display system having a co-integrated VBG/MLA element. In the example where a co-integrated grating element/lenslet array is illuminated by s-polarized source light, the polarization state of a 1^{st} order diffracted beam may change for conical diffractions. Referring to FIG. 15, shown is a simulation of the interaction of source light with an illumination module having a co-integrated VBG/MLA element and the modification of the polarization state of the source light, which may have a minor adverse effect on the contrast of image light.

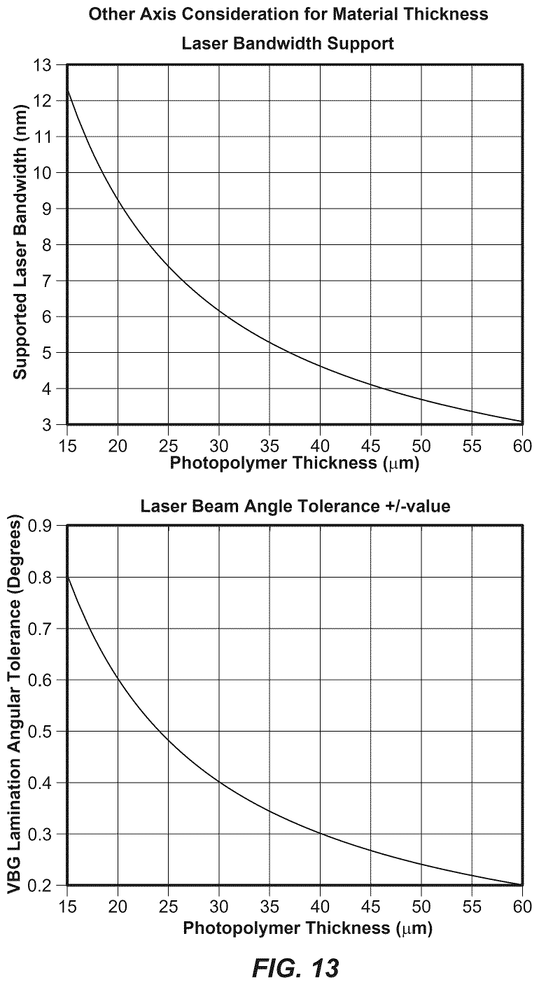

Illustrated in FIG. 16 is the combined impact on system contrast of (a) the polarization state of image light, as described above with reference to FIGS. 5-13, and (b) the polarization state (i.e., purity) of source light, as described with reference to FIG. 15.

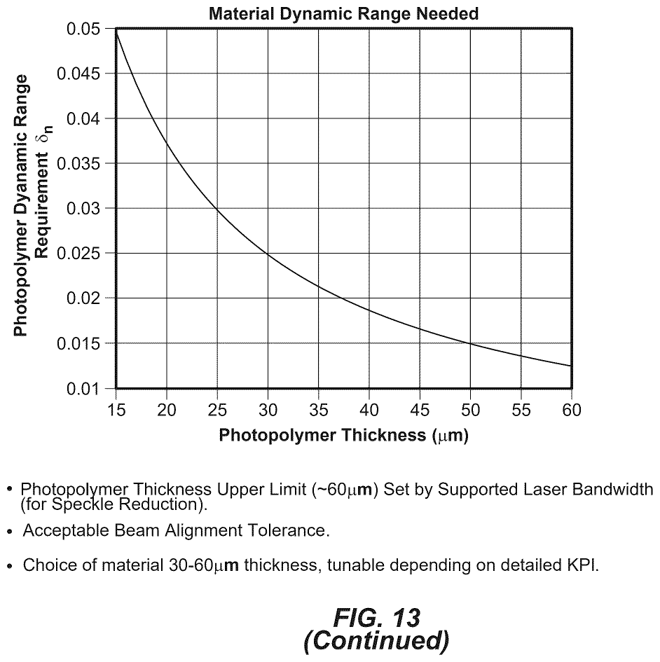

A further embodiment directed at improving the polarization state uniformity of illumination light is shown in FIG. 17, which includes providing an illumination module having two separate grating elements, where one grating element is disposed over a first (front) surface of the illumination module and a second grating element is disposed over a second (back) surface of the illumination module. A one-way diffuser, such as a microlens array, may be co-integrated with the second grating element where the second grating element is arranged to receive diffracted light from the first grating element. Such an architecture may increase the contrast and improve the contrast uniformity of image light.

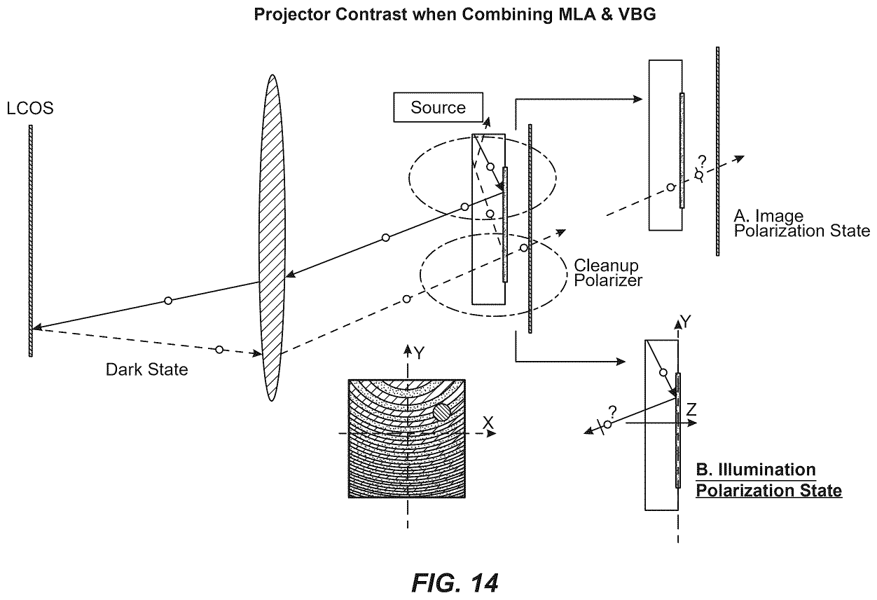

According to further embodiments, corner contrast may be improved using a an angularly-dependent clean-up polarizer. Additional display system embodiments having an illumination module that includes opposing (i.e., first and second) grating elements are shown schematically in FIG. 18.

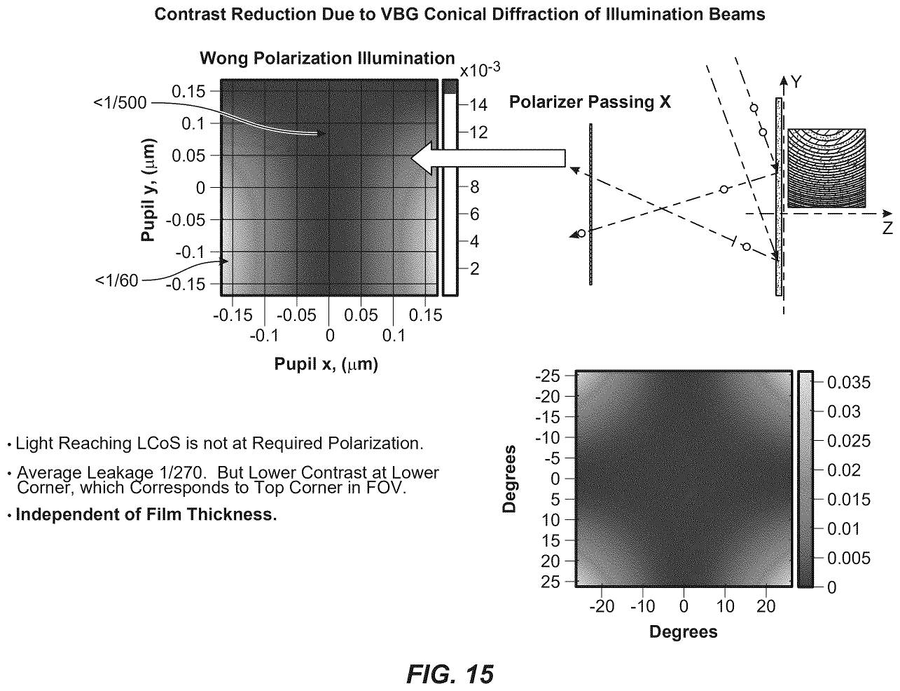

Referring to FIG. 19, shown is a manufacturing method for forming an illumination module having a co-integrated refractive grating element/microlens array.

Referring to FIG. 20, illustrated is an example display system. Display system 2000 includes a light source optically coupled to an illumination module, a display panel, an active LC diffuser located between the illumination module and the display panel, and display optics for directing image light received from the display panel.

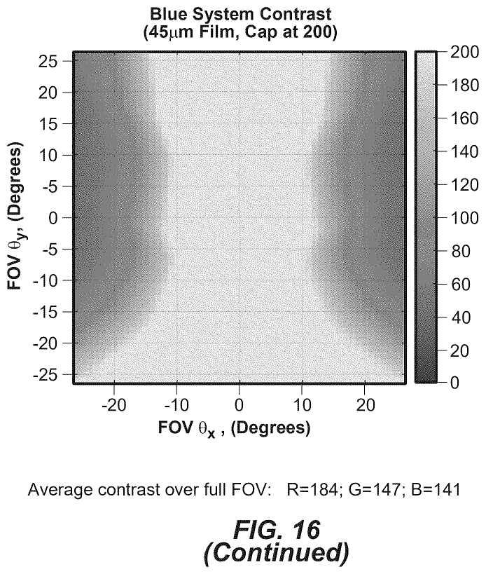

A schematic diagram showing operation of the diffuser is shown in FIG. 21. The diffuser is configured to interact with, and diffuse, incident light having one polarization state and transmit light having a complementary polarization state.

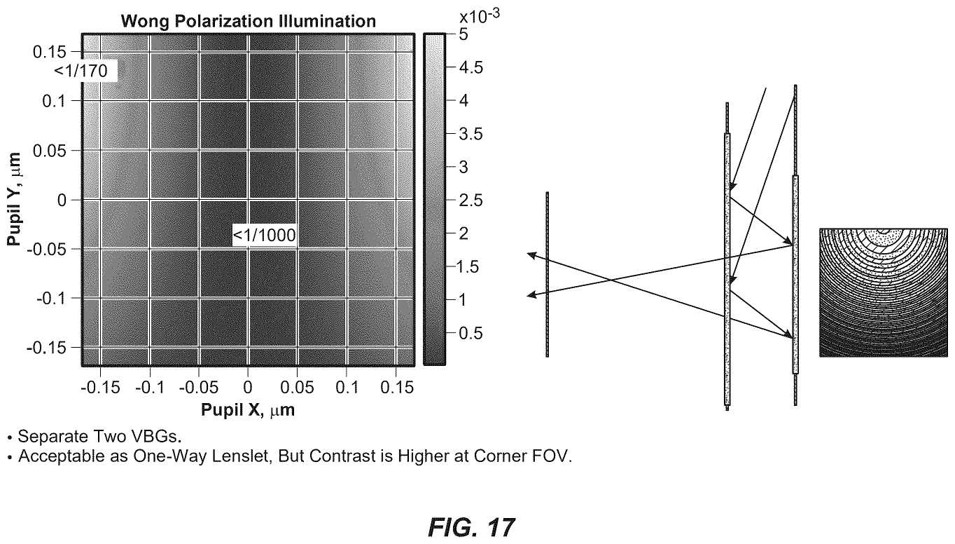

Example active diffuser architectures are illustrated in FIG. 22. As will be appreciated, the structure of an active diffuser may be manipulated in real time to mitigate speckle and accordingly improve the quality of display image light. Referring initially to FIG. 22A, a diffuser may include an active liquid crystal polymer network located between electroded glass plates. By applying a voltage across the LC polymer network, the orientation of the liquid crystal molecules may be controlled, which may influence their real time interaction with light. A further active liquid crystal (LC) diffuser architecture is depicted in FIG. 22B. In FIG. 22B, a liquid crystal layer having a varying thickness profile is disposed between a pair of electrodes (e.g., indium tin oxide electrodes). As with the configuration of FIG. 22A, a voltage may be applied across the liquid crystal layer to tune the interaction of light with the LC layer. Referring to FIG. 22C, an active diffuser may include a vibrating volumetric Bragg grating. In certain embodiments, the grating may be disposed over a piezoelectrically-driven stage.

Laser LCoS displays are susceptible to speckle artifacts, which may arise from constructive and destructive interference of laser light across the display, resulting in light and/or dark spots. Unwanted speckle may be addressed by providing static or dynamic elements to cause the laser light to avoid or reduce constructive or destructive interference.

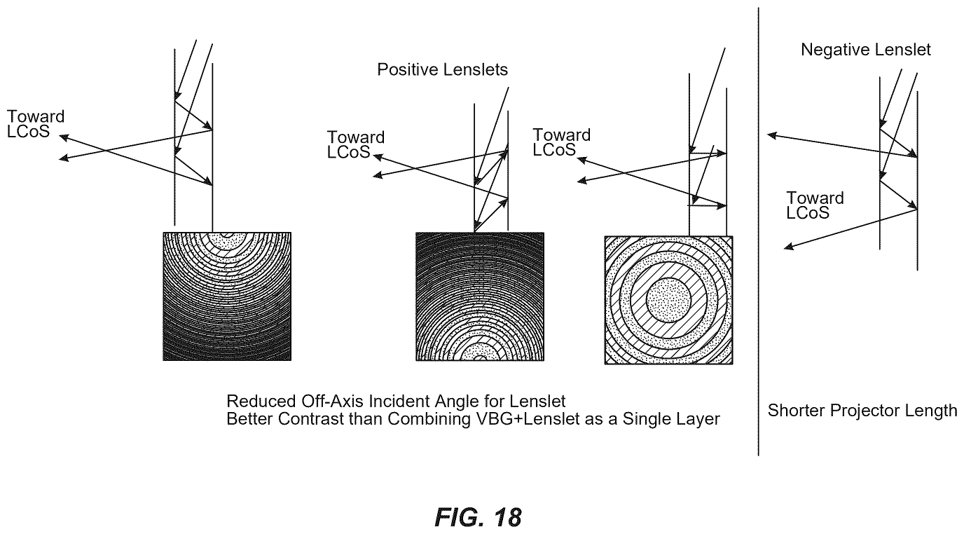

The present disclosure is generally directed to laser liquid crystal on silicon (“LCoS”) display components and systems that may reduce speckle issues without the addition of moving parts. For example, embodiments of the present disclosure may include a lenslet array paired with a grating beam expander, as shown and described in FIGS. 23-25.

For example, as illustrated in FIG. 23, collimated illumination (e.g., laser light) may be directed to a grating expander and lenslet array at an angle to spread the illumination across the lenslet array. The light may exit the lenslet array at various discrete portions through respective lenslets of the lenslet array. The light may be directed through a lens or series of lenses (e.g., the projector in FIG. 23) toward a reflective LCoS substrate to recombine the light at the reflective LCoS substrate.

In accordance with some embodiments, a display system includes (a) a narrow band light source having a bandwidth (Δλ), (b) an illumination system optically coupled to the light source, where the illumination system includes a 2D array of diffusing elements and a coherent length (λ²/Δλ) of the light source is less than a difference between an optical path length from the light source to a first diffusing element and an optical path length from the light source to a second diffusing element, (c) a spatial light modulator arranged to be illuminated by the array of diffusing elements, and (d) a projector system configured to substantially collimate light received from the spatial light modulator. The illumination system may include a lenslet array, for example, where the period of the array may be engineered to define optical path length differences between the light source and each lenslet that are greater than the coherent length of the light source. The display system may be configured to have light rays pass through each lenslet and incoherently combined at the LCoS plane.

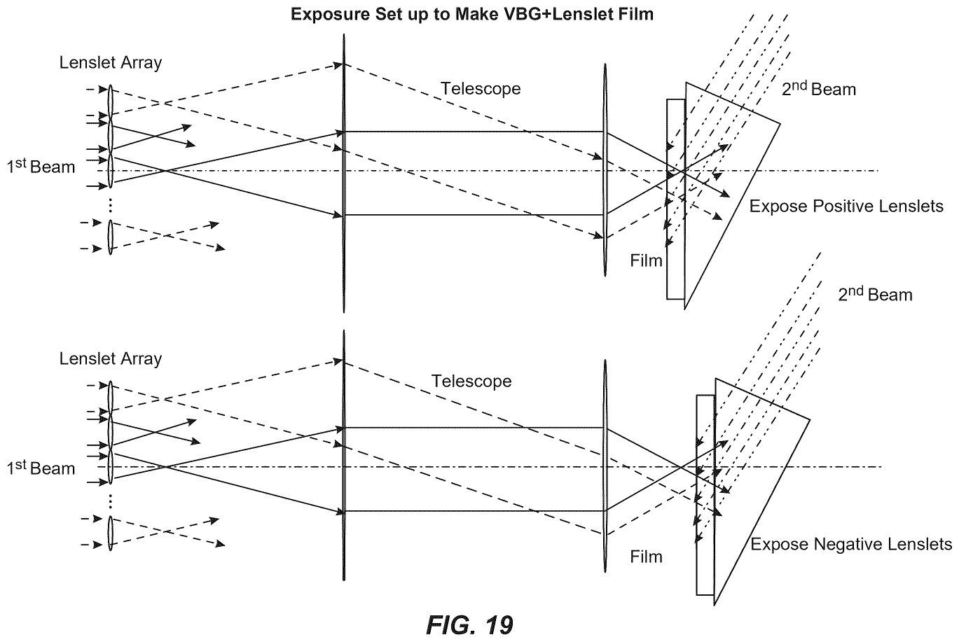

As illustrated in FIG. 24, pixels (one of which is shown) may be directed from the LCoS substrate to a waveguide (“WG”) or other display screen, such as through another lens or set of lenses, for displaying an image to a user. In some examples, the waveguide may be implemented in a head-mounted display device or system, such as an augmented-reality glasses system, a virtual-reality system, a mixed-reality system, etc. FIG. 24 illustrates the light transmitting through the LCoS substrate. However, the present disclosure is not so limited. In additional examples, the light may reflect from the LCoS substrate back toward the source of the light (e.g., the lenslet array).

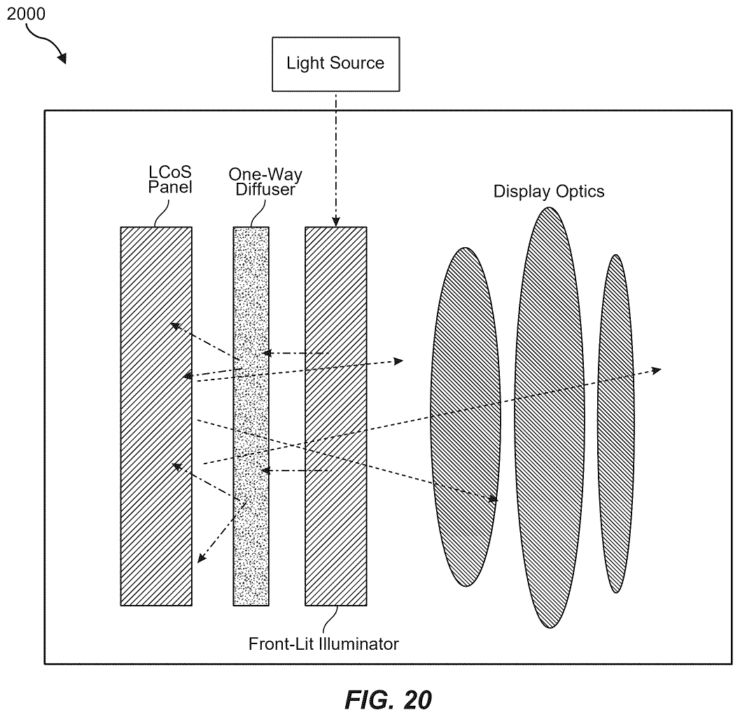

Referring to FIG. 25, various system configurations may implement the embodiments discussed in the present disclosure. FIG. 25A shows a lenslet array and grating beam expander that receives laser light as described herein. The light passes through a polarizing beam splitter (“PBS”) before reaching the LCoS substrate. The LCoS substrate may reverse polarity of the light as it reflects from the LCoS substrate. When the light again reaches the polarizing beam splitter, the light may reflect in a different direction due to the reversed polarity, such as into a waveguide for display.

FIG. 25B shows a lenslet array that is a polarization-sensitive lenslet array. For example, the polarization-sensitive lenslet may include a cholesteric liquid crystal (“CLC”) lens configuration. Polarized light entering the polarization-sensitive lenslet array may reflect toward the LCoS substrate, where the polarization is reversed. As the reversed polarity light reflects back to the polarization-sensitive lenslet array, the reversed-polarity light may pass through the polarization-sensitive lenslet array, such as to the eye(s) of a user, to a display screen, to a waveguide, etc.

FIG. 25C shows a lenslet array with a patterned volume Bragg grating (“VBG”) configuration that redirects light of a first polarization and allows light of a second, reversed polarization to pass. For example, a representation of the patterned VBG viewed from above is shown. As light enters the lenslet and grating beam splitter from the side, the light is redirected toward the LCoS substrate. Reversed-polarity light reflecting from the LCoS substrate may be able to pass through the patterned VBG, such as to the eye(s) of a user, to a display screen, to a waveguide, etc.

In accordance with various embodiments, a laser projection display system utilizing liquid crystal on silicon (LCoS) technology is disclosed, addressing the challenge of speckle artifacts that may arise from the coherent nature of laser illumination. The system may employ a static de-speckle mechanism, eliminating the need for moving components typically used to reduce speckle. This may be accomplished by integrating either a liquid crystal-based one-way diffuser or a holographic volume grating-based one-way diffuser within the illumination module. These diffusers may selectively scatter light based on polarization or direction, minimizing interference patterns and improving image uniformity. The architecture may further include a microlens array co-integrated with a diffractive grating element, which may enhance light diffusion and maintain high image contrast. A narrow spectrum light source, such as a laser, may provide precise wavelength output for optimal display performance. The design may be compatible with configurations that use or omit a polarization beam splitter, offering flexibility for various optical system requirements. This approach may enable high-contrast, high-fidelity image projection suitable for applications in augmented reality (AR), mixed reality (MR), virtual reality (VR), head-mounted displays, and other wearable or portable optical devices. By providing a static solution to speckle reduction, the system may improve visual clarity, simplify device architecture, and enhance the overall user experience in advanced display technologies.

### EXAMPLE EMBODIMENTS

Example 1: A display system includes (a) a narrow band light source having a bandwidth (Δλ), (b) an illumination module optically coupled to the light source, where the illumination module includes a 2D array of diffusing elements and a coherent length (λ²/Δλ) of the light source is less than a difference between an optical path length from the light source to a first diffusing element and an optical path length from the light source to a second diffusing element, (c) a spatial light modulator arranged to be illuminated by the array of diffusing elements, and (d) a projector system configured to substantially collimate light received from the spatial light modulator.

Example 2: The display system of Example 1, where the narrow band light source includes a laser.

Example 3: The display system of Example 1 or 2, where the illumination module includes a polarization selective diffuser configured to diffuse light having a first polarization state and transmit light having a second polarization state.

Example 4: The display system of any of Examples 1-3, where the 2D array of diffusing elements is configured as a microlens array.

Example 5: The display system of any of Examples 1-4, where the 2D array of diffusing elements is arranged such that a period of the array defines an optical path length difference between the light source and each diffusing element that is greater than the coherent length of the light source.

Example 6: The display system of any of Examples 1-5, where the spatial light modulator is configured to modulate red, green, and blue light sequentially to generate a color image.

Example 7: The display system of any of Examples 1-6, where the spatial light modulator includes a liquid crystal on silicon (LCoS) display panel.

Example 8: The display system of any of Examples 1-7, where the projector system is optically coupled to a waveguide configured to direct image light to a user's eye.

Example 9: The display system of any of Examples 1-8, further including a polarization beam splitter located between the illumination module and the spatial light modulator.

Example 10: A display engine includes a light source, an illumination module optically coupled to the light source, a liquid crystal on silicon (LCoS) display panel, and a polarization selective diffuser located between the illumination module and the LCoS display panel, where the polarization selective diffuser is configured to diffuse light having a first polarization state and transmit light having a second polarization state.

Example 11: The display engine of Example 10, where the illumination module includes a microlens array configured to diffuse light passing from the illumination module to the LCoS display panel.

Example 12: The display engine of Example 10 or 11, where the illumination module includes a diffractive grating element disposed over a surface of the illumination module.

Example 13: The display engine of any of Examples 10-12, where the LCoS display panel is configured to modulate red, green, and blue light sequentially to generate a color image.

Example 14: The display engine of any of Examples 10-13, where the polarization selective diffuser includes a liquid crystal-polymer network located between opposing electrodes.

Example 15: The display engine of any of Examples 10-14, where the polarization selective diffuser includes a piezoelectrically-actuatable volumetric Bragg grating.

Example 16: The display engine of any of Examples 10-12, further including projection optics configured to direct image light emitted from the LCoS display panel.

Example 17: The display engine of Example 16, further including a waveguide configured to receive the image light from the projection optics.

Example 18: A display engine includes a light source, an illumination module optically coupled to the light source, a diffractive grating element disposed over a surface of the illumination module, a liquid crystal on silicon (LCoS) display panel arranged to receive light from the illumination module, and a microlens array co-integrated with the diffractive grating element, where the microlens array is configured to diffuse source light directed toward the display panel.

Example 19: The display engine of Example 18, where the microlens array includes a plurality of lenslets distributed across two dimensions, each lenslet having a defined optical power.

Example 20: The display engine of Example 18 or 19, where the microlens array is co-extensive with the diffractive grating element and is configured to increase the angular spread of source light directed toward the display panel.

Embodiments of the present disclosure may include or be implemented in conjunction with various types of Artificial-Reality (AR) systems. AR may be any superimposed functionality and/or sensory-detectable content presented by an artificial-reality system within a user's physical surroundings. In other words, AR is a form of reality that has been adjusted in some manner before presentation to a user. AR can include and/or represent virtual reality (VR), augmented reality, mixed AR (MAR), or some combination and/or variation of these types of realities. Similarly, AR environments may include VR environments (including non-immersive, semi-immersive, and fully immersive VR environments), augmented-reality environments (including marker-based augmented-reality environments, markerless augmented-reality environments, location-based augmented-reality environments, and projection-based augmented-reality environments), hybrid-reality environments, and/or any other type or form of mixed-or alternative-reality environments.

AR content may include completely computer-generated content or computer-generated content combined with captured (e.g., real-world) content. Such AR content may include video, audio, haptic feedback, or some combination thereof, any of which may be presented in a single channel or in multiple channels (such as stereo video that produces a three-dimensional (3D) effect to the viewer). Additionally, in some embodiments, AR may also be associated with applications, products, accessories, services, or some combination thereof, that are used to, for example, create content in an artificial reality and/or are otherwise used in (e.g., to perform activities in) an artificial reality.

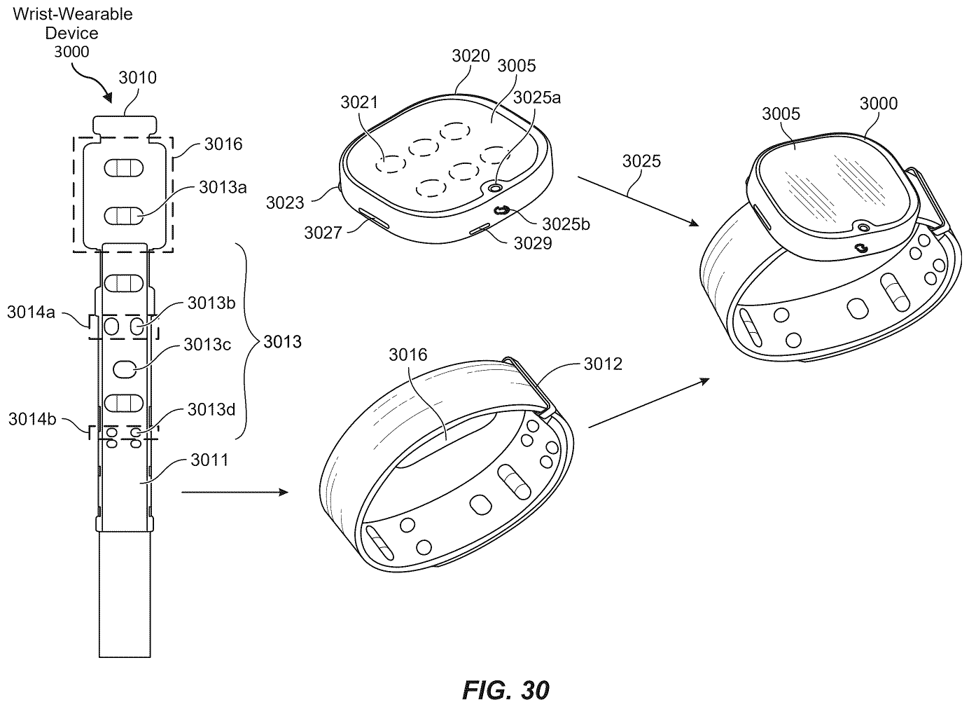

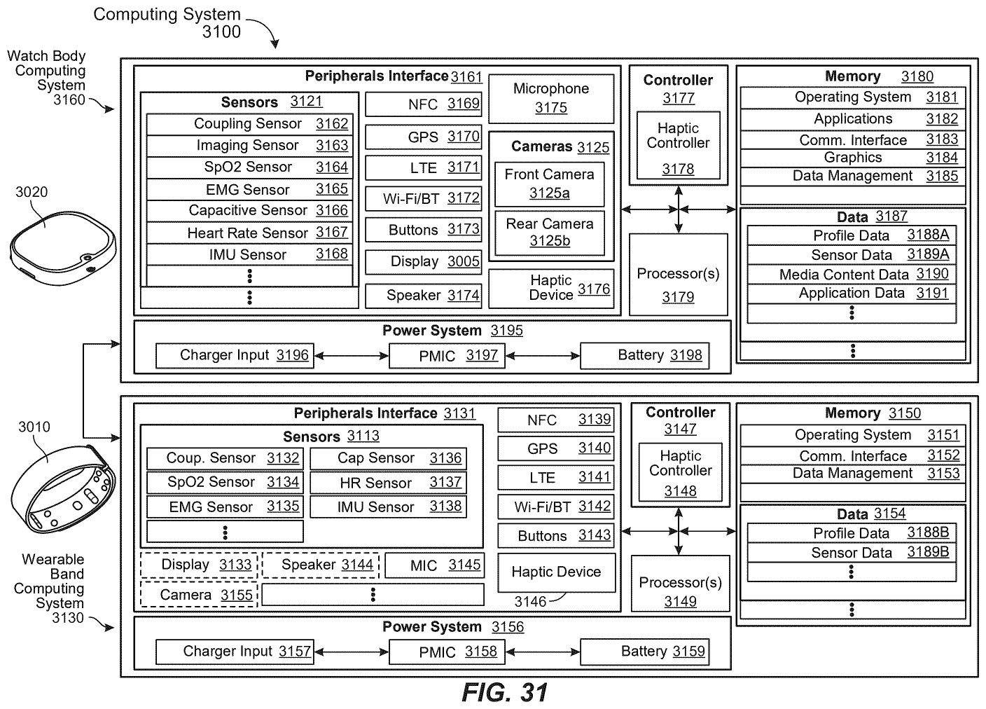

AR systems may be implemented in a variety of different form factors and configurations. Some AR systems may be designed to work without near-eye displays (NEDs). Other AR systems may include a NED that also provides visibility into the real world (such as, e.g., VR system 3300 in FIGS. 33A and 33B). While some AR devices may be self-contained systems, other AR devices may communicate and/or coordinate with external devices to provide an AR experience to a user. Examples of such external devices include handheld controllers, mobile devices, desktop computers, devices worn by a user, devices worn by one or more other users, and/or any other suitable external system.

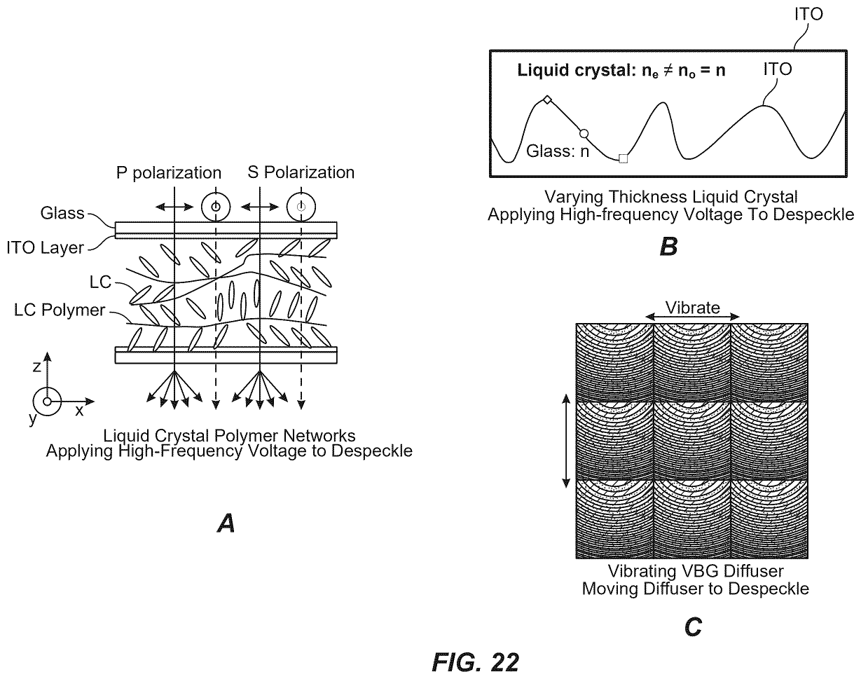

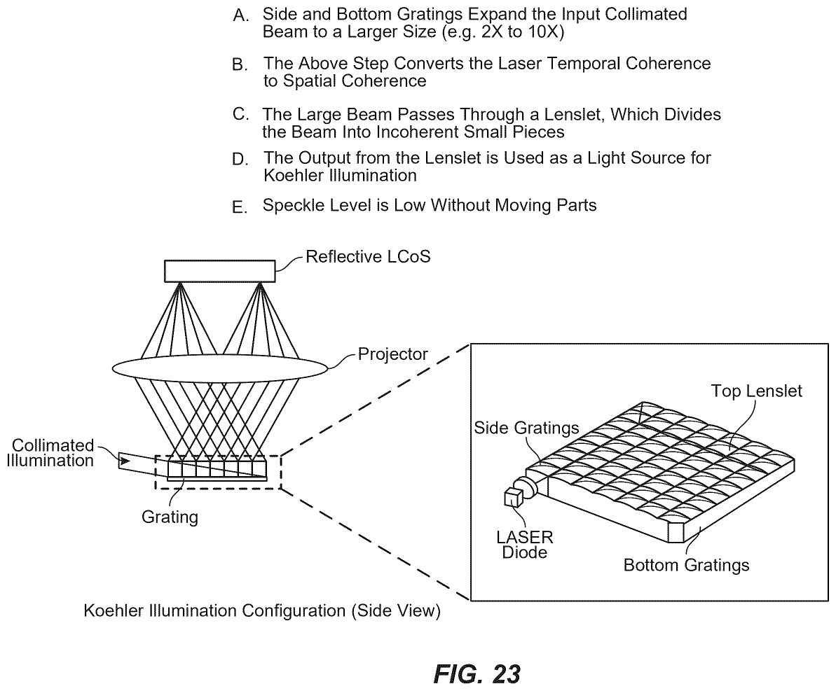

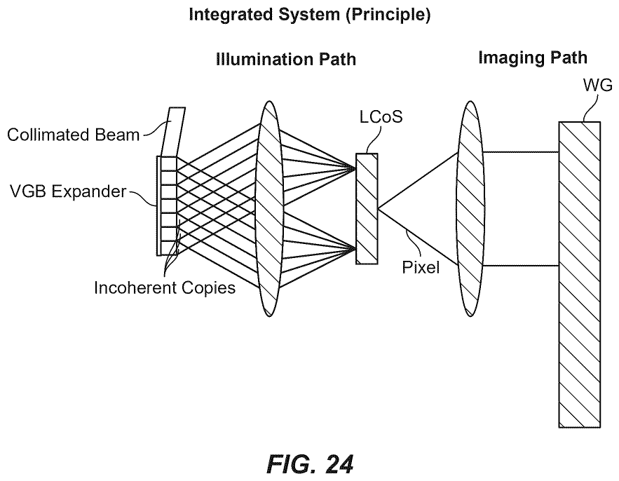

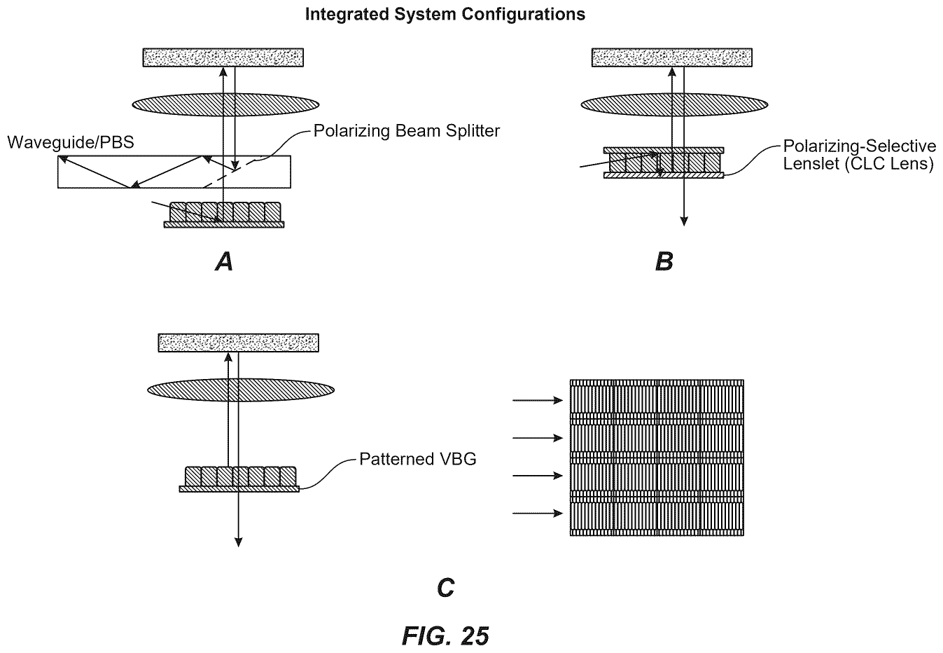

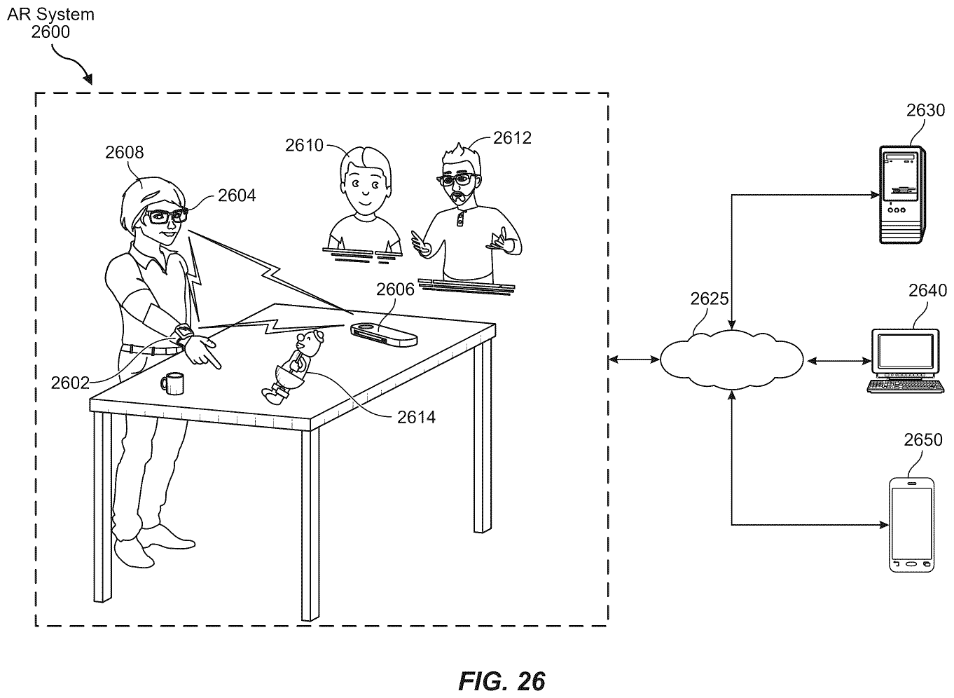

FIGS. 26-29B illustrate example artificial-reality (AR) systems in accordance with some embodiments. FIG. 26 shows a first AR system 2600 and first example user interactions using a wrist-wearable device 2602, a head-wearable device (e.g., AR system 3200), and/or a handheld intermediary processing device (HIPD) 2606. FIG. 27 shows a second AR system 2700 and second example user interactions using a wrist-wearable device 2702, AR glasses 2704, and/or an HIPD 2706. FIGS. 28A and 28B show a third AR system 2800 and third example user 2808 interactions using a wrist-wearable device 2802, a head-wearable device (e.g., VR headset 2850), and/or an HIPD 2806. FIGS. 29A and 29B show a fourth AR system 2900 and fourth example user 2908 interactions using a wrist-wearable device 2930, VR headset 2920, and/or a haptic device 2960 (e.g., wearable gloves).

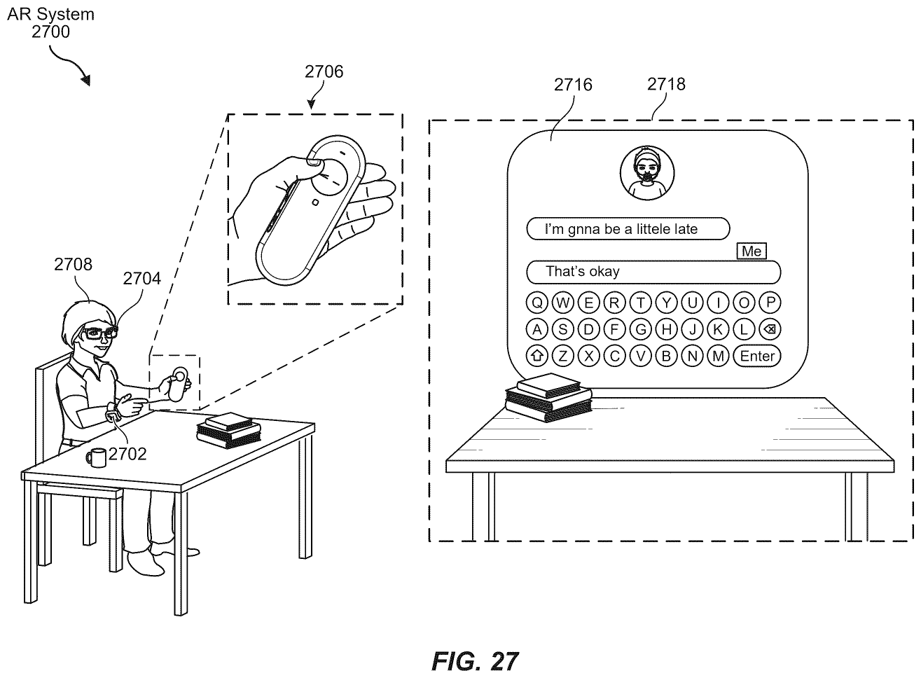

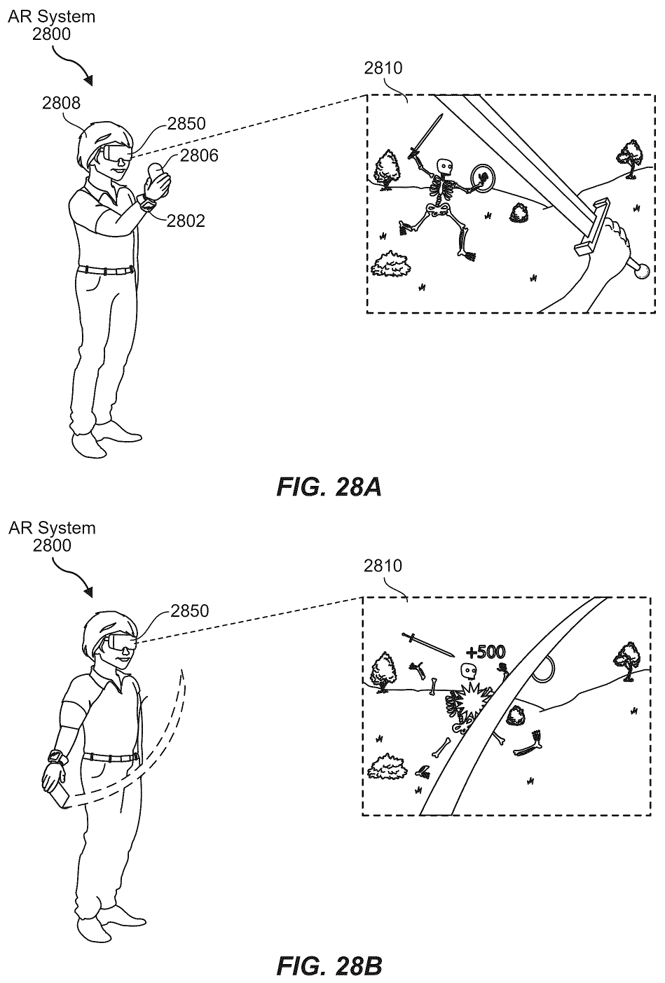

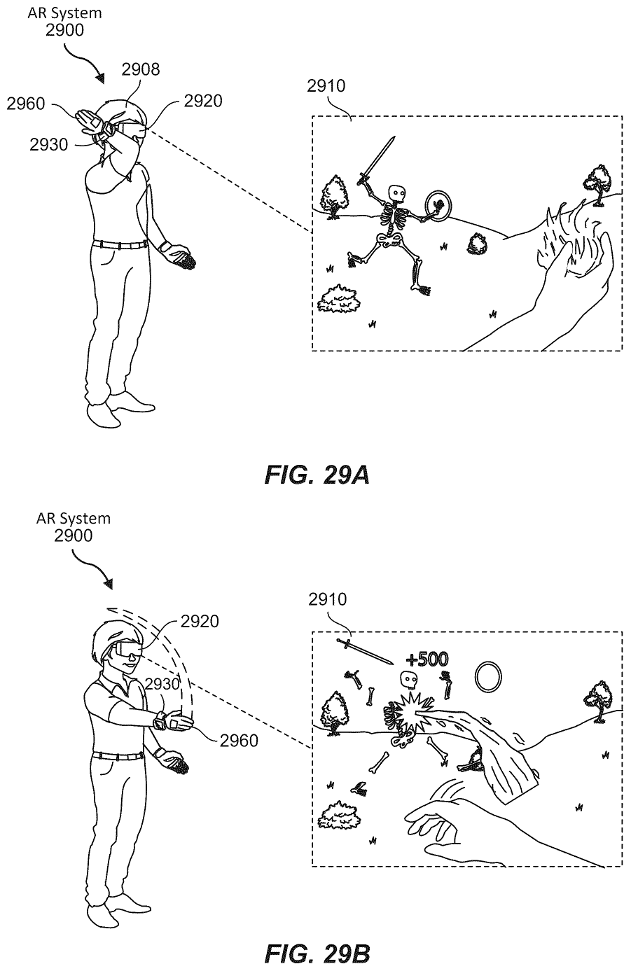

A wrist-wearable device 3000, which can be used for wrist-wearable device 2602, 2702, 2802, 2930, and one or more of its components, are described below in reference to FIGS. 30 and 31; AR system 3200 and VR system 3300, which can respectively be used for AR glasses 2604, 2704 or VR headset 2850, 2920, and their one or more components are described below in reference to FIGS. 32-34.

Referring to FIG. 26, wrist-wearable device 2602, AR glasses 2604, and/or HIPD 2606 can communicatively couple via a network 2625 (e.g., cellular, near field, Wi-Fi, personal area network, wireless LAN, etc.). Additionally, wrist-wearable device 2602, AR glasses 2604, and/or HIPD 2606 can also communicatively couple with one or more servers 2630, computers 2640 (e.g., laptops, computers, etc.), mobile devices 2650 (e.g., smartphones, tablets, etc.), and/or other electronic devices via network 2625 (e.g., cellular, near field, Wi-Fi, personal area network, wireless LAN, etc.).

In FIG. 26, a user 2608 is shown wearing wrist-wearable device 2602 and AR glasses 2604 and having HIPD 2606 on their desk. The wrist-wearable device 2602, AR glasses 2604, and HIPD 2606 facilitate user interaction with an AR environment. In particular, as shown by first AR system 2600, wrist-wearable device 2602, AR glasses 2604, and/or HIPD 2606 cause presentation of one or more avatars 2610, digital representations of contacts 2612, and virtual objects 2614. As discussed below, user 2608 can interact with one or more avatars 2610, digital representations of contacts 2612, and virtual objects 2614 via wrist-wearable device 2602, AR glasses 2604, and/or HIPD 2606.

User 2608 can use any of wrist-wearable device 2602, AR glasses 2604, and/or HIPD 2606 to provide user inputs. For example, user 2608 can perform one or more hand gestures that are detected by wrist-wearable device 2602 (e.g., using one or more EMG sensors and/or IMUs, described below in reference to FIGS. 30 and 31) and/or AR glasses 2604 (e.g., using one or more image sensor or camera, described below in reference to FIGS. 32-10) to provide a user input. Alternatively, or additionally, user 2608 can provide a user input via one or more touch surfaces of wrist-wearable device 2602, AR glasses 2604, HIPD 2606, and/or voice commands captured by a microphone of wrist-wearable device 2602, AR glasses 2604, and/or HIPD 2606. In some embodiments, wrist-wearable device 2602, AR glasses 2604, and/or HIPD 2606 include a digital assistant to help user 2608 in providing a user input (e.g., completing a sequence of operations, suggesting different operations or commands, providing reminders, confirming a command, etc.). In some embodiments, user 2608 can provide a user input via one or more facial gestures and/or facial expressions. For example, cameras of wrist-wearable device 2602, AR glasses 2604, and/or HIPD 2606 can track eyes of user 2608 for navigating a user interface.

Wrist-wearable device 2602, AR glasses 2604, and/or HIPD 2606 can operate alone or in conjunction to allow user 2608 to interact with the AR environment. In some embodiments, HIPD 2606 is configured to operate as a central hub or control center for the wrist-wearable device 2602, AR glasses 2604, and/or another communicatively coupled device. For example, user 2608 can provide an input to interact with the AR environment at any of wrist-wearable device 2602, AR glasses 2604, and/or HIPD 2606, and HIPD 2606 can identify one or more back-end and front-end tasks to cause the performance of the requested interaction and distribute instructions to cause the performance of the one or more back-end and front-end tasks at wrist-wearable device 2602, AR glasses 2604, and/or HIPD 2606. In some embodiments, a back-end task is a background processing task that is not perceptible by the user (e.g., rendering content, decompression, compression, etc.), and a front-end task is a user-facing task that is perceptible to the user (e.g., presenting information to the user, providing feedback to the user, etc.). As described below, HIPD 2606 can perform the back-end tasks and provide wrist-wearable device 2602 and/or AR glasses 2604 operational data corresponding to the performed back-end tasks such that wrist-wearable device 2602 and/or AR glasses 2604 can perform the front-end tasks. In this way, HIPD 2606, which has more computational resources and greater thermal headroom than wrist-wearable device 2602 and/or AR glasses 2604, performs computationally intensive tasks and reduces the computer resource utilization and/or power usage of wrist-wearable device 2602 and/or AR glasses 2604.

In the example shown by first AR system 2600, HIPD 2606 identifies one or more back-end tasks and front-end tasks associated with a user request to initiate an AR video call with one or more other users (represented by avatar 2610 and the digital representation of contact 2612) and distributes instructions to cause the performance of the one or more back-end tasks and front-end tasks. In particular, HIPD 2606 performs back-end tasks for processing and/or rendering image data (and other data) associated with the AR video call and provides operational data associated with the performed back-end tasks to AR glasses 2604 such that the AR glasses 2604 perform front-end tasks for presenting the AR video call (e.g., presenting avatar 2610 and digital representation of contact 2612).

In some embodiments, HIPD 2606 can operate as a focal or anchor point for causing the presentation of information. This allows user 2608 to be generally aware of where information is presented. For example, as shown in first AR system 2600, avatar 2610 and the digital representation of contact 2612 are presented above HIPD 2606. In particular, HIPD 2606 and AR glasses 2604 operate in conjunction to determine a location for presenting avatar 2610 and the digital representation of contact 2612. In some embodiments, information can be presented a predetermined distance from HIPD 2606 (e.g., within 5 meters). For example, as shown in first AR system 2600, virtual object 2614 is presented on the desk some distance from HIPD 2606. Similar to the above example, HIPD 2606 and AR glasses 2604 can operate in conjunction to determine a location for presenting virtual object 2614. Alternatively, in some embodiments, presentation of information is not bound by HIPD 2606. More specifically, avatar 2610, digital representation of contact 2612, and virtual object 2614 do not have to be presented within a predetermined distance of HIPD 2606.

User inputs provided at wrist-wearable device 2602, AR glasses 2604, and/or HIPD 2606 are coordinated such that the user can use any device to initiate, continue, and/or complete an operation. For example, user 2608 can provide a user input to AR glasses 2604 to cause AR glasses 2604 to present virtual object 2614 and, while virtual object 2614 is presented by AR glasses 2604, user 2608 can provide one or more hand gestures via wrist-wearable device 2602 to interact and/or manipulate virtual object 2614.

FIG. 27 shows a user 2708 wearing a wrist-wearable device 2702 and AR glasses 2704, and holding an HIPD 2706. In second AR system 2700, the wrist-wearable device 2702, AR glasses 2704, and/or HIPD 2706 are used to receive and/or provide one or more messages to a contact of user 2708. In particular, wrist-wearable device 2702, AR glasses 2704, and/or HIPD 2706 detect and coordinate one or more user inputs to initiate a messaging application and prepare a response to a received message via the messaging application.

In some embodiments, user 2708 initiates, via a user input, an application on wrist-wearable device 2702, AR glasses 2704, and/or HIPD 2706 that causes the application to initiate on at least one device. For example, in second AR system 2700, user 2708 performs a hand gesture associated with a command for initiating a messaging application (represented by messaging user interface 2716), wrist-wearable device 2702 detects the hand gesture and, based on a determination that user 2708 is wearing AR glasses 2704, causes AR glasses 2704 to present a messaging user interface 2716 of the messaging application. AR glasses 2704 can present messaging user interface 2716 to user 2708 via its display (e.g., as shown by a field of view 2718 of user 2708). In some embodiments, the application is initiated and executed on the device (e.g., wrist-wearable device 2702, AR glasses 2704, and/or HIPD 2706) that detects the user input to initiate the application, and the device provides another device operational data to cause the presentation of the messaging application. For example, wrist-wearable device 2702 can detect the user input to initiate a messaging application, initiate and run the messaging application, and provide operational data to AR glasses 2704 and/or HIPD 2706 to cause presentation of the messaging application. Alternatively, the application can be initiated and executed at a device other than the device that detected the user input. For example, wrist-wearable device 2702 can detect the hand gesture associated with initiating the messaging application and cause HIPD 2706 to run the messaging application and coordinate the presentation of the messaging application.

Further, user 2708 can provide a user input provided at wrist-wearable device 2702, AR glasses 2704, and/or HIPD 2706 to continue and/or complete an operation initiated at another device. For example, after initiating the messaging application via wrist-wearable device 2702 and while AR glasses 2704 present messaging user interface 2716, user 2708 can provide an input at HIPD 2706 to prepare a response (e.g., shown by the swipe gesture performed on HIPD 2706). Gestures performed by user 2708 on HIPD 2706 can be provided and/or displayed on another device. For example, a swipe gestured performed on HIPD 2706 is displayed on a virtual keyboard of messaging user interface 2716 displayed by AR glasses 2704.

In some embodiments, wrist-wearable device 2702, AR glasses 2704, HIPD 2706, and/or any other communicatively coupled device can present one or more notifications to user 2708. The notification can be an indication of a new message, an incoming call, an application update, a status update, etc. User 2708 can select the notification via wrist-wearable device 2702, AR glasses 2704, and/or HIPD 2706 and can cause presentation of an application or operation associated with the notification on at least one device. For example, user 2708 can receive a notification that a message was received at wrist-wearable device 2702, AR glasses 2704, HIPD 2706, and/or any other communicatively coupled device and can then provide a user input at wrist-wearable device 2702, AR glasses 2704, and/or HIPD 2706 to review the notification, and the device detecting the user input can cause an application associated with the notification to be initiated and/or presented at wrist-wearable device 2702, AR glasses 2704, and/or HIPD 2706.

While the above example describes coordinated inputs used to interact with a messaging application, user inputs can be coordinated to interact with any number of applications including, but not limited to, gaming applications, social media applications, camera applications, web-based applications, financial applications, etc. For example, AR glasses 2704 can present to user 2708 game application data, and HIPD 2706 can be used as a controller to provide inputs to the game. Similarly, user 2708 can use wrist-wearable device 2702 to initiate a camera of AR glasses 2704, and user 308 can use wrist-wearable device 2702, AR glasses 2704, and/or HIPD 2706 to manipulate the image capture (e.g., zoom in or out, apply filters, etc.) and capture image data.

Users may interact with the devices disclosed herein in a variety of ways. For example, as shown in FIGS. 28A and 28B, a user 2808 may interact with an AR system 2800 by donning a VR headset 2850 while holding HIPD 2806 and wearing wrist-wearable device 2802. In this example, AR system 2800 may enable a user to interact with a game 2810 by swiping their arm. One or more of VR headset 2850, HIPD 2806, and wrist-wearable device 2802 may detect this gesture and, in response, may display a sword strike in game 2810. Similarly, in FIGS. 29A and 29B, a user 2908 may interact with an AR system 2900 by donning a VR headset 2920 while wearing haptic device 2960 and wrist-wearable device 2930. In this example, AR system 2900 may enable a user to interact with a game 2910 by swiping their arm. One or more of VR headset 2920, haptic device 2960, and wrist-wearable device 2930 may detect this gesture and, in response, may display a spell being cast in game 2810.

Having discussed example AR systems, devices for interacting with such AR systems and other computing systems more generally will now be discussed in greater detail. Some explanations of devices and components that can be included in some or all of the example devices discussed below are explained herein for ease of reference. Certain types of the components described below may be more suitable for a particular set of devices, and less suitable for a different set of devices. But subsequent reference to the components explained here should be considered to be encompassed by the descriptions provided.

In some embodiments discussed below, example devices and systems, including electronic devices and systems, will be addressed. Such example devices and systems are not intended to be limiting, and one of skill in the art will understand that alternative devices and systems to the example devices and systems described herein may be used to perform the operations and construct the systems and devices that are described herein.

An electronic device may be a device that uses electrical energy to perform a specific function. An electronic device can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device may be a device that sits between two other electronic devices and/or a subset of components of one or more electronic devices and facilitates communication, data processing, and/or data transfer between the respective electronic devices and/or electronic components.

An integrated circuit may be an electronic device made up of multiple interconnected electronic components such as transistors, resistors, and capacitors. These components may be etched onto a small piece of semiconductor material, such as silicon. Integrated circuits may include analog integrated circuits, digital integrated circuits, mixed signal integrated circuits, and/or any other suitable type or form of integrated circuit. Examples of integrated circuits include application-specific integrated circuits (ASICs), processing units, central processing units (CPUs), co-processors, and accelerators.

Analog integrated circuits, such as sensors, power management circuits, and operational amplifiers, may process continuous signals and perform analog functions such as amplification, active filtering, demodulation, and mixing. Examples of analog integrated circuits include linear integrated circuits and radio frequency circuits.

Digital integrated circuits, which may be referred to as logic integrated circuits, may include microprocessors, microcontrollers, memory chips, interfaces, power management circuits, programmable devices, and/or any other suitable type or form of integrated circuit. In some embodiments, examples of integrated circuits include central processing units (CPUs), Processing units, such as CPUs, may be electronic components that are responsible for executing instructions and controlling the operation of an electronic device (e.g., a computer). There are various types of processors that may be used interchangeably, or may be specifically required, by embodiments described herein. For example, a processor may be: (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) an accelerator, such as a graphics processing unit (GPU), designed to accelerate the creation and rendering of images, videos, and animations (e.g., virtual-reality animations, such as three-dimensional modeling); (iv) a field-programmable gate array (FPGA) that can be programmed and reconfigured after manufacturing and/or can be customized to perform specific tasks, such as signal processing, cryptography, and machine learning; and/or (v) a digital signal processor (DSP) designed to perform mathematical operations on signals such as audio, video, and radio waves. One or more processors of one or more electronic devices may be used in various embodiments described herein.

Memory generally refers to electronic components in a computer or electronic device that store data and instructions for the processor to access and manipulate. Examples of memory can include: (i) random access memory (RAM) configured to store data and instructions temporarily; (ii) read-only memory (ROM) configured to store data and instructions permanently (e.g., one or more portions of system firmware, and/or boot loaders) and/or semi-permanently; (iii) flash memory, which can be configured to store data in electronic devices (e.g., USB drives, memory cards, and/or solid-state drives (SSDs)); and/or (iv) cache memory configured to temporarily store frequently accessed data and instructions. Memory, as described herein, can store structured data (e.g., SQL databases, MongoDB databases, GraphQL data, JSON data, etc.). Other examples of data stored in memory can include (i) profile data, including user account data, user settings, and/or other user data stored by the user, (ii) sensor data detected and/or otherwise obtained by one or more sensors, (iii) media content data including stored image data, audio data, documents, and the like, (iv) application data, which can include data collected and/or otherwise obtained and stored during use of an application, and/or any other types of data described herein.

Controllers may be electronic components that manage and coordinate the operation of other components within an electronic device (e.g., controlling inputs, processing data, and/or generating outputs). Examples of controllers can include: (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs.

A power system of an electronic device may be configured to convert incoming electrical power into a form that can be used to operate the device. A power system can include various components, such as (i) a power source, which can be an alternating current (AC) adapter or a direct current (DC) adapter power supply, (ii) a charger input, which can be configured to use a wired and/or wireless connection (which may be part of a peripheral interface, such as a USB, micro-USB interface, near-field magnetic coupling, magnetic inductive and magnetic resonance charging, and/or radio frequency (RF) charging), (iii) a power-management integrated circuit, configured to distribute power to various components of the device and to ensure that the device operates within safe limits (e.g., regulating voltage, controlling current flow, and/or managing heat dissipation), and/or (iv) a battery configured to store power to provide usable power to components of one or more electronic devices.

Peripheral interfaces may be electronic components (e.g., of electronic devices) that allow electronic devices to communicate with other devices or peripherals and can provide the ability to input and output data and signals. Examples of peripheral interfaces can include (i) universal serial bus (USB) and/or micro-USB interfaces configured for connecting devices to an electronic device, (ii) Bluetooth interfaces configured to allow devices to communicate with each other, including Bluetooth low energy (BLE), (iii) near field communication (NFC) interfaces configured to be short-range wireless interfaces for operations such as access control, (iv) POGO pins, which may be small, spring-loaded pins configured to provide a charging interface, (v) wireless charging interfaces, (vi) GPS interfaces, (vii) Wi-Fi interfaces for providing a connection between a device and a wireless network, and/or (viii) sensor interfaces.

Sensors may be electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device), (ii) biopotential-signal sensors, (iii) inertial measurement units (e.g., IMUs) for detecting, for example, angular rate, force, magnetic field, and/or changes in acceleration, (iv) heart rate sensors for measuring a user's heart rate, (v) SpO2 sensors for measuring blood oxygen saturation and/or other biometric data of a user, (vi) capacitive sensors for detecting changes in potential at a portion of a user's body (e.g., a sensor-skin interface), and/or (vii) light sensors (e.g., time-of-flight sensors, infrared light sensors, visible light sensors, etc.).

Biopotential-signal-sensing components may be devices used to measure electrical activity within the body (e.g., biopotential-signal sensors). Some types of biopotential-signal sensors include (i) electroencephalography (EEG) sensors configured to measure electrical activity in the brain to diagnose neurological disorders, (ii) electrocardiography (ECG or EKG) sensors configured to measure electrical activity of the heart to diagnose heart problems, (iii) electromyography (EMG) sensors configured to measure the electrical activity of muscles and to diagnose neuromuscular disorders, and (iv) electrooculography (EOG) sensors configured to measure the electrical activity of eye muscles to detect eye movement and diagnose eye disorders.

An application stored in memory of an electronic device (e.g., software) may include instructions stored in the memory. Examples of such applications include (i) games, (ii) word processors, (iii) messaging applications, (iv) media-streaming applications, (v) financial applications, (vi) calendars. (vii) clocks, and (viii) communication interface modules for enabling wired and/or wireless connections between different respective electronic devices (e.g., IEEE 3202.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocols).

A communication interface may be a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, Bluetooth). In some embodiments, a communication interface can refer to a software layer that enables different software programs to communicate with each other (e.g., application programming interfaces (APIs), protocols like HTTP and TCP/IP, etc.).

A graphics module may be a component or software module that is designed to handle graphical operations and/or processes and can include a hardware module and/or a software module.

Non-transitory computer-readable storage media may be physical devices or storage media that can be used to store electronic data in a non-transitory form (e.g., such that the data is stored permanently until it is intentionally deleted or modified).

FIGS. 30 and 31 illustrate an example wrist-wearable device 3000 and an example computer system 3100, in accordance with some embodiments. Wrist-wearable device 3000 is an instance of wearable device 2602 described in FIG. 26 herein, such that the wearable device 2602 should be understood to have the features of the wrist-wearable device 3000 and vice versa. FIG. 31 illustrates components of the wrist-wearable device 3000, which can be used individually or in combination, including combinations that include other electronic devices and/or electronic components.

FIG. 30 shows a wearable band 3010 and a watch body 3020 (or capsule) being coupled, as discussed below, to form wrist-wearable device 3000. Wrist-wearable device 3000 can perform various functions and/or operations associated with navigating through user interfaces and selectively opening applications as well as the functions and/or operations described above with reference to FIGS. 26-29B.

As will be described in more detail below, operations executed by wrist-wearable device 3000 can include (i) presenting content to a user (e.g., displaying visual content via a display 3005), (ii) detecting (e.g., sensing) user input (e.g., sensing a touch on peripheral button 3023 and/or at a touch screen of the display 3005, a hand gesture detected by sensors (e.g., biopotential sensors)), (iii) sensing biometric data (e.g., neuromuscular signals, heart rate, temperature, sleep, etc.) via one or more sensors 3013, messaging (e.g., text, speech, video, etc.); image capture via one or more imaging devices or cameras 3025, wireless communications (e.g., cellular, near field, Wi-Fi, personal area network, etc.), location determination, financial transactions, providing haptic feedback, providing alarms, providing notifications, providing biometric authentication, providing health monitoring, providing sleep monitoring, etc.

The above-example functions can be executed independently in watch body 3020, independently in wearable band 3010, and/or via an electronic communication between watch body 3020 and wearable band 3010. In some embodiments, functions can be executed on wrist-wearable device 3000 while an AR environment is being presented (e.g., via one of AR systems 2600 to 2900). The wearable devices described herein can also be used with other types of AR environments.

Wearable band 3010 can be configured to be worn by a user such that an inner surface of a wearable structure 3011 of wearable band 3010 is in contact with the user's skin. In this example, when worn by a user, sensors 3013 may contact the user's skin. In some examples, one or more of sensors 3013 can sense biometric data such as a user's heart rate, a saturated oxygen level, temperature, sweat level, neuromuscular signals, or a combination thereof. One or more of sensors 3013 can also sense data about a user's environment including a user's motion, altitude, location, orientation, gait, acceleration, position, or a combination thereof. In some embodiment, one or more of sensors 3013 can be configured to track a position and/or motion of wearable band 3010. One or more of sensors 3013 can include any of the sensors defined above and/or discussed below with respect to FIG. 30.

One or more of sensors 3013 can be distributed on an inside and/or an outside surface of wearable band 3010. In some embodiments, one or more of sensors 3013 are uniformly spaced along wearable band 3010. Alternatively, in some embodiments, one or more of sensors 3013 are positioned at distinct points along wearable band 3010. As shown in FIG. 30, one or more of sensors 3013 can be the same or distinct. For example, in some embodiments, one or more of sensors 3013 can be shaped as a pill (e.g., sensor 3013a), an oval, a circle a square, an oblong (e.g., sensor 3013c) and/or any other shape that maintains contact with the user's skin (e.g., such that neuromuscular signal and/or other biometric data can be accurately measured at the user's skin). In some embodiments, one or more sensors of 3013 are aligned to form pairs of sensors (e.g., for sensing neuromuscular signals based on differential sensing within each respective sensor). For example, sensor 3013b may be aligned with an adjacent sensor to form sensor pair 3014a and sensor 3013d may be aligned with an adjacent sensor to form sensor pair 3014b. In some embodiments, wearable band 3010 does not have a sensor pair. Alternatively, in some embodiments, wearable band 3010 has a predetermined number of sensor pairs (one pair of sensors, three pairs of sensors, four pairs of sensors, six pairs of sensors, sixteen pairs of sensors, etc.).

Wearable band 3010 can include any suitable number of sensors 3013. In some embodiments, the number and arrangement of sensors 3013 depends on the particular application for which wearable band 3010 is used. For instance, wearable band 3010 can be configured as an armband, wristband, or chest-band that include a plurality of sensors 3013 with different number of sensors 3013, a variety of types of individual sensors with the plurality of sensors 3013, and different arrangements for each use case, such as medical use cases as compared to gaming or general day-to-day use cases.

In accordance with some embodiments, wearable band 3010 further includes an electrical ground electrode and a shielding electrode. The electrical ground and shielding electrodes, like the sensors 3013, can be distributed on the inside surface of the wearable band 3010 such that they contact a portion of the user's skin. For example, the electrical ground and shielding electrodes can be at an inside surface of a coupling mechanism 3016 or an inside surface of a wearable structure 3011. The electrical ground and shielding electrodes can be formed and/or use the same components as sensors 3013. In some embodiments, wearable band 3010 includes more than one electrical ground electrode and more than one shielding electrode.

Sensors 3013 can be formed as part of wearable structure 3011 of wearable band 3010. In some embodiments, sensors 3013 are flush or substantially flush with wearable structure 3011 such that they do not extend beyond the surface of wearable structure 3011. While flush with wearable structure 3011, sensors 3013 are still configured to contact the user's skin (e.g., via a skin-contacting surface). Alternatively, in some embodiments, sensors 3013 extend beyond wearable structure 3011 a predetermined distance (e.g., 0.1-2 mm) to make contact and depress into the user's skin. In some embodiment, sensors 3013 are coupled to an actuator (not shown) configured to adjust an extension height (e.g., a distance from the surface of wearable structure 3011) of sensors 3013 such that sensors 3013 make contact and depress into the user's skin. In some embodiments, the actuators adjust the extension height between 0.01 mm-1.2 mm. This may allow a user to customize the positioning of sensors 3013 to improve the overall comfort of the wearable band 3010 when worn while still allowing sensors 3013 to contact the user's skin. In some embodiments, sensors 3013 are indistinguishable from wearable structure 3011 when worn by the user.

Wearable structure 3011 can be formed of an elastic material, elastomers, etc., configured to be stretched and fitted to be worn by the user. In some embodiments, wearable structure 3011 is a textile or woven fabric. As described above, sensors 3013 can be formed as part of a wearable structure 3011. For example, sensors 3013 can be molded into the wearable structure 3011, be integrated into a woven fabric (e.g., sensors 3013 can be sewn into the fabric and mimic the pliability of fabric and can and/or be constructed from a series woven strands of fabric).

Wearable structure 3011 can include flexible electronic connectors that interconnect sensors 3013, the electronic circuitry, and/or other electronic components (described below in reference to FIG. 31) that are enclosed in wearable band 3010. In some embodiments, the flexible electronic connectors are configured to interconnect sensors 3013, the electronic circuitry, and/or other electronic components of wearable band 3010 with respective sensors and/or other electronic components of another electronic device (e.g., watch body 3020). The flexible electronic connectors are configured to move with wearable structure 3011 such that the user adjustment to wearable structure 3011 (e.g., resizing, pulling, folding, etc.) does not stress or strain the electrical coupling of components of wearable band 3010.

As described above, wearable band 3010 is configured to be worn by a user. In particular, wearable band 3010 can be shaped or otherwise manipulated to be worn by a user. For example, wearable band 3010 can be shaped to have a substantially circular shape such that it can be configured to be worn on the user's lower arm or wrist. Alternatively, wearable band 3010 can be shaped to be worn on another body part of the user, such as the user's upper arm (e.g., around a bicep), forearm, chest, legs, etc. Wearable band 3010 can include a retaining mechanism 3012 (e.g., a buckle, a hook and loop fastener, etc.) for securing wearable band 3010 to the user's wrist or other body part. While wearable band 3010 is worn by the user, sensors 3013 sense data (referred to as sensor data) from the user's skin. In some examples, sensors 3013 of wearable band 3010 obtain (e.g., sense and record) neuromuscular signals.

The sensed data (e.g., sensed neuromuscular signals) can be used to detect and/or determine the user's intention to perform certain motor actions. In some examples, sensors 3013 may sense and record neuromuscular signals from the user as the user performs muscular activations (e.g., movements, gestures, etc.). The detected and/or determined motor actions (e.g., phalange (or digit) movements, wrist movements, hand movements, and/or other muscle intentions) can be used to determine control commands or control information (instructions to perform certain commands after the data is sensed) for causing a computing device to perform one or more input commands. For example, the sensed neuromuscular signals can be used to control certain user interfaces displayed on display 3005 of wrist-wearable device 3000 and/or can be transmitted to a device responsible for rendering an artificial-reality environment (e.g., a head-mounted display) to perform an action in an associated artificial-reality environment, such as to control the motion of a virtual device displayed to the user. The muscular activations performed by the user can include static gestures, such as placing the user's hand palm down on a table, dynamic gestures, such as grasping a physical or virtual object, and covert gestures that are imperceptible to another person, such as slightly tensing a joint by co-contracting opposing muscles or using sub-muscular activations. The muscular activations performed by the user can include symbolic gestures (e.g., gestures mapped to other gestures, interactions, or commands, for example, based on a gesture vocabulary that specifies the mapping of gestures to commands).

The sensor data sensed by sensors 3013 can be used to provide a user with an enhanced interaction with a physical object (e.g., devices communicatively coupled with wearable band 3010) and/or a virtual object in an artificial-reality application generated by an artificial-reality system (e.g., user interface objects presented on the display 3005, or another computing device (e.g., a smartphone)).

In some embodiments, wearable band 3010 includes one or more haptic devices 3146 (e.g., a vibratory haptic actuator) that are configured to provide haptic feedback (e.g., a cutaneous and/or kinesthetic sensation, etc.) to the user's skin. Sensors 3013 and/or haptic devices 3146 (shown in FIG. 31) can be configured to operate in conjunction with multiple applications including, without limitation, health monitoring, social media, games, and artificial reality (e.g., the applications associated with artificial reality).

Wearable band 3010 can also include coupling mechanism 3016 for detachably coupling a capsule (e.g., a computing unit) or watch body 3020 (via a coupling surface of the watch body 3020) to wearable band 3010. For example, a cradle or a shape of coupling mechanism 3016 can correspond to shape of watch body 3020 of wrist-wearable device 3000. In particular, coupling mechanism 3016 can be configured to receive a coupling surface proximate to the bottom side of watch body 3020 (e.g., a side opposite to a front side of watch body 3020 where display 3005 is located), such that a user can push watch body 3020 downward into coupling mechanism 3016 to attach watch body 3020 to coupling mechanism 3016. In some embodiments, coupling mechanism 3016 can be configured to receive a top side of the watch body 3020 (e.g., a side proximate to the front side of watch body 3020 where display 3005 is located) that is pushed upward into the cradle, as opposed to being pushed downward into coupling mechanism 3016. In some embodiments, coupling mechanism 3016 is an integrated component of wearable band 3010 such that wearable band 3010 and coupling mechanism 3016 are a single unitary structure. In some embodiments, coupling mechanism 3016 is a type of frame or shell that allows watch body 3020 coupling surface to be retained within or on wearable band 3010 coupling mechanism 3016 (e.g., a cradle, a tracker band, a support base, a clasp, etc.).

Coupling mechanism 3016 can allow for watch body 3020 to be detachably coupled to the wearable band 3010 through a friction fit, magnetic coupling, a rotation-based connector, a shear-pin coupler, a retention spring, one or more magnets, a clip, a pin shaft, a hook and loop fastener, or a combination thereof. A user can perform any type of motion to couple the watch body 3020 to wearable band 3010 and to decouple the watch body 3020 from the wearable band 3010. For example, a user can twist, slide, turn, push, pull, or rotate watch body 3020 relative to wearable band 3010, or a combination thereof, to attach watch body 3020 to wearable band 3010 and to detach watch body 3020 from wearable band 3010. Alternatively, as discussed below, in some embodiments, the watch body 3020 can be decoupled from the wearable band 3010 by actuation of a release mechanism 3029.

Wearable band 3010 can be coupled with watch body 3020 to increase the functionality of wearable band 3010 (e.g., converting wearable band 3010 into wrist-wearable device 3000, adding an additional computing unit and/or battery to increase computational resources and/or a battery life of wearable band 3010, adding additional sensors to improve sensed data, etc.). As described above, wearable band 3010 and coupling mechanism 3016 are configured to operate independently (e.g., execute functions independently) from watch body 3020. For example, coupling mechanism 3016 can include one or more sensors 3013 that contact a user's skin when wearable band 3010 is worn by the user, with or without watch body 3020 and can provide sensor data for determining control commands.

A user can detach watch body 3020 from wearable band 3010 to reduce the encumbrance of wrist-wearable device 3000 to the user. For embodiments in which watch body 3020 is removable, watch body 3020 can be referred to as a removable structure, such that in these embodiments wrist-wearable device 3000 includes a wearable portion (e.g., wearable band 3010) and a removable structure (e.g., watch body 3020).

Turning to watch body 3020, in some examples watch body 3020 can have a substantially rectangular or circular shape. Watch body 3020 is configured to be worn by the user on their wrist or on another body part. More specifically, watch body 3020 is sized to be easily carried by the user, attached on a portion of the user's clothing, and/or coupled to wearable band 3010 (forming the wrist-wearable device 3000). As described above, watch body 3020 can have a shape corresponding to coupling mechanism 3016 of wearable band 3010. In some embodiments, watch body 3020 includes a single release mechanism 3029 or multiple release mechanisms (e.g., two release mechanisms 3029 positioned on opposing sides of watch body 3020, such as spring-loaded buttons) for decoupling watch body 3020 from wearable band 3010. Release mechanism 3029 can include, without limitation, a button, a knob, a plunger, a handle, a lever, a fastener, a clasp, a dial, a latch, or a combination thereof.

A user can actuate release mechanism 3029 by pushing, turning, lifting, depressing, shifting, or performing other actions on release mechanism 3029. Actuation of release mechanism 3029 can release (e.g., decouple) watch body 3020 from coupling mechanism 3016 of wearable band 3010, allowing the user to use watch body 3020 independently from wearable band 3010 and vice versa. For example, decoupling watch body 3020 from wearable band 3010 can allow a user to capture images using rear-facing camera 3025b. Although release mechanism 3029 is shown positioned at a corner of watch body 3020, release mechanism 3029 can be positioned anywhere on watch body 3020 that is convenient for the user to actuate. In addition, in some embodiments, wearable band 3010 can also include a respective release mechanism for decoupling watch body 3020 from coupling mechanism 3016. In some embodiments, release mechanism 3029 is optional and watch body 3020 can be decoupled from coupling mechanism 3016 as described above (e.g., via twisting, rotating, etc.).

Watch body 3020 can include one or more peripheral buttons 3023 and 3027 for performing various operations at watch body 3020. For example, peripheral buttons 3023 and 3027 can be used to turn on or wake (e.g., transition from a sleep state to an active state) display 3005, unlock watch body 3020, increase or decrease a volume, increase or decrease a brightness, interact with one or more applications, interact with one or more user interfaces, etc. Additionally, or alternatively, in some embodiments, display 3005 operates as a touch screen and allows the user to provide one or more inputs for interacting with watch body 3020.

In some embodiments, watch body 3020 includes one or more sensors 3021. Sensors 3021 of watch body 3020 can be the same or distinct from sensors 3013 of wearable band 3010. Sensors 3021 of watch body 3020 can be distributed on an inside and/or an outside surface of watch body 3020. In some embodiments, sensors 3021 are configured to contact a user's skin when watch body 3020 is worn by the user. For example, sensors 3021 can be placed on the bottom side of watch body 3020 and coupling mechanism 3016 can be a cradle with an opening that allows the bottom side of watch body 3020 to directly contact the user's skin. Alternatively, in some embodiments, watch body 3020 does not include sensors that are configured to contact the user's skin (e.g., including sensors internal and/or external to the watch body 3020 that are configured to sense data of watch body 3020 and the surrounding environment). In some embodiments, sensors 3021 are configured to track a position and/or motion of watch body 3020.

Watch body 3020 and wearable band 3010 can share data using a wired communication method (e.g., a Universal Asynchronous Receiver/Transmitter (UART), a USB transceiver, etc.) and/or a wireless communication method (e.g., near field communication, Bluetooth, etc.). For example, watch body 3020 and wearable band 3010 can share data sensed by sensors 3013 and 3021, as well as application and device specific information (e.g., active and/or available applications, output devices (e.g., displays, speakers, etc.), input devices (e.g., touch screens, microphones, imaging sensors, etc.).

In some embodiments, watch body 3020 can include, without limitation, a front-facing camera 3025a and/or a rear-facing camera 3025b, sensors 3021 (e.g., a biometric sensor, an IMU, a heart rate sensor, a saturated oxygen sensor, a neuromuscular signal sensor, an altimeter sensor, a temperature sensor, a bioimpedance sensor, a pedometer sensor, an optical sensor (e.g., imaging sensor 3163), a touch sensor, a sweat sensor, etc.). In some embodiments, watch body 3020 can include one or more haptic devices 3176 (e.g., a vibratory haptic actuator) that is configured to provide haptic feedback (e.g., a cutaneous and/or kinesthetic sensation, etc.) to the user. Sensors 3121 and/or haptic device 3176 can also be configured to operate in conjunction with multiple applications including, without limitation, health monitoring applications, social media applications, game applications, and artificial reality applications (e.g., the applications associated with artificial reality).

As described above, watch body 3020 and wearable band 3010, when coupled, can form wrist-wearable device 3000. When coupled, watch body 3020 and wearable band 3010 may operate as a single device to execute functions (operations, detections, communications, etc.) described herein. In some embodiments, each device may be provided with particular instructions for performing the one or more operations of wrist-wearable device 3000. For example, in accordance with a determination that watch body 3020 does not include neuromuscular signal sensors, wearable band 3010 can include alternative instructions for performing associated instructions (e.g., providing sensed neuromuscular signal data to watch body 3020 via a different electronic device). Operations of wrist-wearable device 3000 can be performed by watch body 3020 alone or in conjunction with wearable band 3010 (e.g., via respective processors and/or hardware components) and vice versa. In some embodiments, operations of wrist-wearable device 3000, watch body 3020, and/or wearable band 3010 can be performed in conjunction with one or more processors and/or hardware components.

As described below with reference to the block diagram of FIG. 31, wearable band 3010 and/or watch body 3020 can each include independent resources required to independently execute functions. For example, wearable band 3010 and/or watch body 3020 can each include a power source (e.g., a battery), a memory, data storage, a processor (e.g., a central processing unit (CPU)), communications, a light source, and/or input/output devices.

FIG. 31 shows block diagrams of a computing system 3130 corresponding to wearable band 3010 and a computing system 3160 corresponding to watch body 3020 according to some embodiments. Computing system 3100 of wrist-wearable device 3000 may include a combination of components of wearable band computing system 3130 and watch body computing system 3160, in accordance with some embodiments.

Watch body 3020 and/or wearable band 3010 can include one or more components shown in watch body computing system 3160. In some embodiments, a single integrated circuit may include all or a substantial portion of the components of watch body computing system 3160 included in a single integrated circuit. Alternatively, in some embodiments, components of the watch body computing system 3160 may be included in a plurality of integrated circuits that are communicatively coupled. In some embodiments, watch body computing system 3160 may be configured to couple (e.g., via a wired or wireless connection) with wearable band computing system 3130, which may allow the computing systems to share components, distribute tasks, and/or perform other operations described herein (individually or as a single device).

Watch body computing system 3160 can include one or more processors 3179, a controller 3177, a peripherals interface 3161, a power system 3195, and memory (e.g., a memory 3180).

Power system 3195 can include a charger input 3196, a power-management integrated circuit (PMIC) 3197, and a battery 3198. In some embodiments, a watch body 3020 and a wearable band 3010 can have respective batteries (e.g., battery 3198 and 3159) and can share power with each other. Watch body 3020 and wearable band 3010 can receive a charge using a variety of techniques. In some embodiments, watch body 3020 and wearable band 3010 can use a wired charging assembly (e.g., power cords) to receive the charge. Alternatively, or in addition, watch body 3020 and/or wearable band 3010 can be configured for wireless charging. For example, a portable charging device can be designed to mate with a portion of watch body 3020 and/or wearable band 3010 and wirelessly deliver usable power to battery 3198 of watch body 3020 and/or battery 3159 of wearable band 3010. Watch body 3020 and wearable band 3010 can have independent power systems (e.g., power system 3195 and 3156, respectively) to enable each to operate independently. Watch body 3020 and wearable band 3010 can also share power (e.g., one can charge the other) via respective PMICs (e.g., PMICs 3197 and 3158) and charger inputs (e.g., 3157 and 3196) that can share power over power and ground conductors and/or over wireless charging antennas.

In some embodiments, peripherals interface 3161 can include one or more sensors 3121. Sensors 3121 can include one or more coupling sensors 3162 for detecting when watch body 3020 is coupled with another electronic device (e.g., a wearable band 3010). Sensors 3121 can include one or more imaging sensors 3163 (e.g., one or more of cameras 3125, and/or separate imaging sensors 3163 (e.g., thermal-imaging sensors)). In some embodiments, sensors 3121 can include one or more SpO2 sensors 3164. In some embodiments, sensors 3121 can include one or more biopotential-signal sensors (e.g., EMG sensors 3165, which may be disposed on an interior, user-facing portion of watch body 3020 and/or wearable band 3010). In some embodiments, sensors 3121 may include one or more capacitive sensors 3166. In some embodiments, sensors 3121 may include one or more heart rate sensors 3167. In some embodiments, sensors 3121 may include one or more IMU sensors 3168. In some embodiments, one or more IMU sensors 3168 can be configured to detect movement of a user's hand or other location where watch body 3020 is placed or held.

In some embodiments, one or more of sensors 3121 may provide an example human-machine interface. For example, a set of neuromuscular sensors, such as EMG sensors 3165, may be arranged circumferentially around wearable band 3010 with an interior surface of EMG sensors 3165 being configured to contact a user's skin. Any suitable number of neuromuscular sensors may be used (e.g., between 2 and 20 sensors). The number and arrangement of neuromuscular sensors may depend on the particular application for which the wearable device is used. For example, wearable band 3010 can be used to generate control information for controlling an augmented reality system, a robot, controlling a vehicle, scrolling through text, controlling a virtual avatar, or any other suitable control task.

In some embodiments, neuromuscular sensors may be coupled together using flexible electronics incorporated into the wireless device, and the output of one or more of the sensing components can be optionally processed using hardware signal processing circuitry (e.g., to perform amplification, filtering, and/or rectification). In other embodiments, at least some signal processing of the output of the sensing components can be performed in software such as processors 3179. Thus, signal processing of signals sampled by the sensors can be performed in hardware, software, or by any suitable combination of hardware and software, as aspects of the technology described herein are not limited in this respect.

Neuromuscular signals may be processed in a variety of ways. For example, the output of EMG sensors 3165 may be provided to an analog front end, which may be configured to perform analog processing (e.g., amplification, noise reduction, filtering, etc.) on the recorded signals. The processed analog signals may then be provided to an analog-to-digital converter, which may convert the analog signals to digital signals that can be processed by one or more computer processors. Furthermore, although this example is as discussed in the context of interfaces with EMG sensors, the embodiments described herein can also be implemented in wearable interfaces with other types of sensors including, but not limited to, mechanomyography (MMG) sensors, sonomyography (SMG) sensors, and electrical impedance tomography (EIT) sensors.

In some embodiments, peripherals interface 3161 includes a near-field communication (NFC) component 3169, a global-position system (GPS) component 3170, a long-term evolution (LTE) component 3171, and/or a Wi-Fi and/or Bluetooth communication component 3172. In some embodiments, peripherals interface 3161 includes one or more buttons 3173 (e.g., peripheral buttons 3023 and 3027 in FIG. 30), which, when selected by a user, cause operation to be performed at watch body 3020. In some embodiments, the peripherals interface 3161 includes one or more indicators, such as a light emitting diode (LED), to provide a user with visual indicators (e.g., message received, low battery, active microphone and/or camera, etc.).

Watch body 3020 can include at least one display 3005 for displaying visual representations of information or data to a user, including user-interface elements and/or three-dimensional virtual objects. The display can also include a touch screen for inputting user inputs, such as touch gestures, swipe gestures, and the like. Watch body 3020 can include at least one speaker 3174 and at least one microphone 3175 for providing audio signals to the user and receiving audio input from the user. The user can provide user inputs through microphone 3175 and can also receive audio output from speaker 3174 as part of a haptic event provided by haptic controller 3178. Watch body 3020 can include at least one camera 3125, including a front camera 3125a and a rear camera 3125b. Cameras 3125 can include ultra-wide-angle cameras, wide angle cameras, fish-eye cameras, spherical cameras, telephoto cameras, depth-sensing cameras, or other types of cameras.

Watch body computing system 3160 can include one or more haptic controllers 3178 and associated componentry (e.g., haptic devices 3176) for providing haptic events at watch body 3020 (e.g., a vibrating sensation or audio output in response to an event at the watch body 3020). Haptic controllers 3178 can communicate with one or more haptic devices 3176, such as electroacoustic devices, including a speaker of the one or more speakers 3174 and/or other audio components and/or electromechanical devices that convert energy into linear motion such as a motor, solenoid, electroactive polymer, piezoelectric actuator, electrostatic actuator, or other tactile output generating components (e.g., a component that converts electrical signals into tactile outputs on the device). Haptic controller 3178 can provide haptic events to that are capable of being sensed by a user of watch body 3020. In some embodiments, one or more haptic controllers 3178 can receive input signals from an application of applications 3182.

In some embodiments, wearable band computing system 3130 and/or watch body computing system 3160 can include memory 3180, which can be controlled by one or more memory controllers of controllers 3177. In some embodiments, software components stored in memory 3180 include one or more applications 3182 configured to perform operations at the watch body 3020. In some embodiments, one or more applications 3182 may include games, word processors, messaging applications, calling applications, web browsers, social media applications, media streaming applications, financial applications, calendars, clocks, etc. In some embodiments, software components stored in memory 3180 include one or more communication interface modules 3183 as defined above. In some embodiments, software components stored in memory 3180 include one or more graphics modules 3184 for rendering, encoding, and/or decoding audio and/or visual data and one or more data management modules 3185 for collecting, organizing, and/or providing access to data 3187 stored in memory 3180. In some embodiments, one or more of applications 3182 and/or one or more modules can work in conjunction with one another to perform various tasks at the watch body 3020.

In some embodiments, software components stored in memory 3180 can include one or more operating systems 3181 (e.g., a Linux-based operating system, an Android operating system, etc.). Memory 3180 can also include data 3187. Data 3187 can include profile data 3188A, sensor data 3189A, media content data 3190, and application data 3191.

It should be appreciated that watch body computing system 3160 is an example of a computing system within watch body 3020, and that watch body 3020 can have more or fewer components than shown in watch body computing system 3160, can combine two or more components, and/or can have a different configuration and/or arrangement of the components. The various components shown in watch body computing system 3160 are implemented in hardware, software, firmware, or a combination thereof, including one or more signal processing and/or application-specific integrated circuits.

Turning to the wearable band computing system 3130, one or more components that can be included in wearable band 3010 are shown. Wearable band computing system 3130 can include more or fewer components than shown in watch body computing system 3160, can combine two or more components, and/or can have a different configuration and/or arrangement of some or all of the components. In some embodiments, all, or a substantial portion of the components of wearable band computing system 3130 are included in a single integrated circuit. Alternatively, in some embodiments, components of wearable band computing system 3130 are included in a plurality of integrated circuits that are communicatively coupled. As described above, in some embodiments, wearable band computing system 3130 is configured to couple (e.g., via a wired or wireless connection) with watch body computing system 3160, which allows the computing systems to share components, distribute tasks, and/or perform other operations described herein (individually or as a single device).

Wearable band computing system 3130, similar to watch body computing system 3160, can include one or more processors 3149, one or more controllers 3147 (including one or more haptics controllers 3148), a peripherals interface 3131 that can includes one or more sensors 3113 and other peripheral devices, a power source (e.g., a power system 3156), and memory (e.g., a memory 3150) that includes an operating system (e.g., an operating system 3151), data (e.g., data 3154 including profile data 3188B, sensor data 3189B, etc.), and one or more modules (e.g., a communications interface module 3152, a data management module 3153, etc.).

One or more of sensors 3113 can be analogous to sensors 3121 of watch body computing system 3160. For example, sensors 3113 can include one or more coupling sensors 3132, one or more SpO2 sensors 3134, one or more EMG sensors 3135, one or more capacitive sensors 3136, one or more heart rate sensors 3137, and one or more IMU sensors 3138.

Peripherals interface 3131 can also include other components analogous to those included in peripherals interface 3161 of watch body computing system 3160, including an NFC component 3139, a GPS component 3140, an LTE component 3141, a Wi-Fi and/or Bluetooth communication component 3142, and/or one or more haptic devices 3146 as described above in reference to peripherals interface 3161. In some embodiments, peripherals interface 3131 includes one or more buttons 3143, a display 3133, a speaker 3144, a microphone 3145, and a camera 3155. In some embodiments, peripherals interface 3131 includes one or more indicators, such as an LED.

It should be appreciated that wearable band computing system 3130 is an example of a computing system within wearable band 3010, and that wearable band 3010 can have more or fewer components than shown in wearable band computing system 3130, combine two or more components, and/or have a different configuration and/or arrangement of the components. The various components shown in wearable band computing system 3130 can be implemented in one or more of a combination of hardware, software, or firmware, including one or more signal processing and/or application-specific integrated circuits.

Wrist-wearable device 3000 with respect to FIG. 30 is an example of wearable band 3010 and watch body 3020 coupled together, so wrist-wearable device 3000 will be understood to include the components shown and described for wearable band computing system 3130 and watch body computing system 3160. In some embodiments, wrist-wearable device 3000 has a split architecture (e.g., a split mechanical architecture, a split electrical architecture, etc.) between watch body 3020 and wearable band 3010. In other words, all of the components shown in wearable band computing system 3130 and watch body computing system 3160 can be housed or otherwise disposed in a combined wrist-wearable device 3000 or within individual components of watch body 3020, wearable band 3010, and/or portions thereof (e.g., a coupling mechanism 3016 of wearable band 3010).

The techniques described above can be used with any device for sensing neuromuscular signals but could also be used with other types of wearable devices for sensing neuromuscular signals (such as body-wearable or head-wearable devices that might have neuromuscular sensors closer to the brain or spinal column).

In some embodiments, wrist-wearable device 3000 can be used in conjunction with a head-wearable device (e.g., AR system 3200 and VR system 3300) and/or an HIPD, and wrist-wearable device 3000 can also be configured to be used to allow a user to control any aspect of the artificial reality (e.g., by using EMG-based gestures to control user interface objects in the artificial reality and/or by allowing a user to interact with the touchscreen on the wrist-wearable device to also control aspects of the artificial reality). Having thus described example wrist-wearable devices, attention will now be turned to example head-wearable devices, such AR system 3200 and VR system 3300.

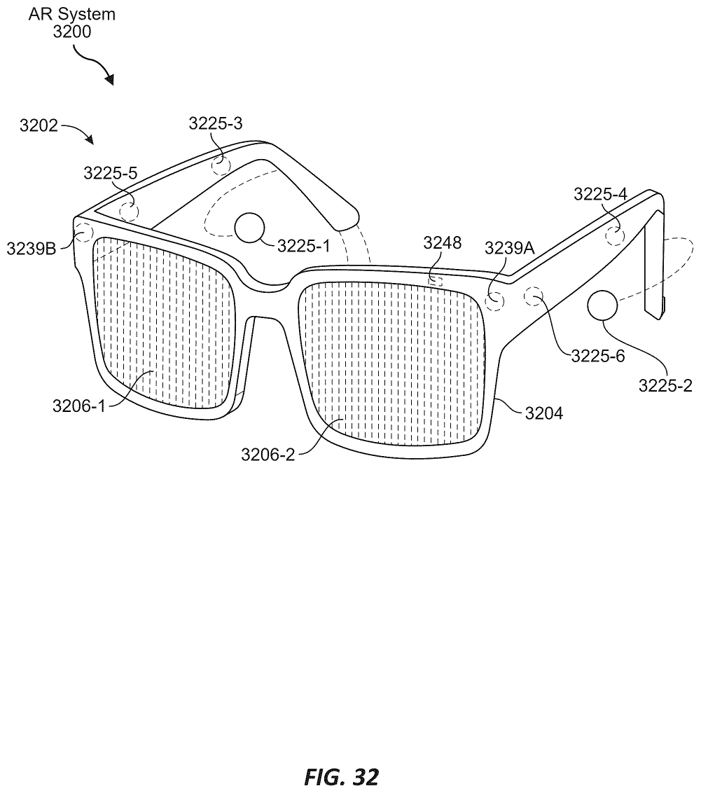

FIGS. 32 to 34 show example artificial-reality systems, which can be used as or in connection with wrist-wearable device 3000. In some embodiments, AR system 3200 includes an eyewear device 3202, as shown in FIG. 32. In some embodiments, VR system 3300 includes a head-mounted display (HMD) 3312, as shown in FIGS. 33A and 33B. In some embodiments, AR system 3200 and VR system 3300 can include one or more analogous components (e.g., components for presenting interactive artificial-reality environments, such as processors, memory, and/or presentation devices, including one or more displays and/or one or more waveguides), some of which are described in more detail with respect to FIG. 34. As described herein, a head-wearable device can include components of eyewear device 3202 and/or head-mounted display 3312. Some embodiments of head-wearable devices do not include any displays, including any of the displays described with respect to AR system 3200 and/or VR system 3300. While the example artificial-reality systems are respectively described herein as AR system 3200 and VR system 3300, either or both of the example AR systems described herein can be configured to present fully-immersive virtual-reality scenes presented in substantially all of a user's field of view or subtler augmented-reality scenes that are presented within a portion, less than all, of the user's field of view.

FIG. 32 show an example visual depiction of AR system 3200, including an eyewear device 3202 (which may also be described herein as augmented-reality glasses, and/or smart glasses). AR system 3200 can include additional electronic components that are not shown in FIG. 32, such as a wearable accessory device and/or an intermediary processing device, in electronic communication or otherwise configured to be used in conjunction with the eyewear device 3202. In some embodiments, the wearable accessory device and/or the intermediary processing device may be configured to couple with eyewear device 3202 via a coupling mechanism in electronic communication with a coupling sensor 3424 (FIG. 34), where coupling sensor 3424 can detect when an electronic device becomes physically or electronically coupled with eyewear device 3202. In some embodiments, eyewear device 3202 can be configured to couple to a housing 3490 (FIG. 34), which may include one or more additional coupling mechanisms configured to couple with additional accessory devices. The components shown in FIG. 32 can be implemented in hardware, software, firmware, or a combination thereof, including one or more signal-processing components and/or application-specific integrated circuits (ASICs).

Eyewear device 3202 includes mechanical glasses components, including a frame 3204 configured to hold one or more lenses (e.g., one or both lenses 3206-1 and 3206-2). One of ordinary skill in the art will appreciate that eyewear device 3202 can include additional mechanical components, such as hinges configured to allow portions of frame 3204 of eyewear device 3202 to be folded and unfolded, a bridge configured to span the gap between lenses 3206-1 and 3206-2 and rest on the user's nose, nose pads configured to rest on the bridge of the nose and provide support for eyewear device 3202, earpieces configured to rest on the user's ears and provide additional support for eyewear device 3202, temple arms configured to extend from the hinges to the earpieces of eyewear device 3202, and the like. One of ordinary skill in the art will further appreciate that some examples of AR system 3200 can include none of the mechanical components described herein. For example, smart contact lenses configured to present artificial reality to users may not include any components of eyewear device 3202.

Eyewear device 3202 includes electronic components, many of which will be described in more detail below with respect to FIG. 10. Some example electronic components are illustrated in FIG. 32, including acoustic sensors 3225-1, 3225-2, 3225-3, 3225-4, 3225-5, and 3225-6, which can be distributed along a substantial portion of the frame 3204 of eyewear device 3202. Eyewear device 3202 also includes a left camera 3239A and a right camera 3239B, which are located on different sides of the frame 3204. Eyewear device 3202 also includes a processor 3248 (or any other suitable type or form of integrated circuit) that is embedded into a portion of the frame 3204.

FIGS. 33A and 33B show a VR system 3300 that includes a head-mounted display (HMD) 3312 (e.g., also referred to herein as an artificial-reality headset, a head-wearable device, a VR headset, etc.), in accordance with some embodiments. As noted, some artificial-reality systems (e.g., AR system 3200) may, instead of blending an artificial reality with actual reality, substantially replace one or more of a user's visual and/or other sensory perceptions of the real world with a virtual experience (e.g., AR systems 2800 and 2900).

HMD 3312 includes a front body 3314 and a frame 3316 (e.g., a strap or band) shaped to fit around a user's head. In some embodiments, front body 3314 and/or frame 3316 include one or more electronic elements for facilitating presentation of and/or interactions with an AR and/or VR system (e.g., displays, IMUs, tracking emitter or detectors). In some embodiments, HMD 3312 includes output audio transducers (e.g., an audio transducer 3318), as shown in FIG. 33B. In some embodiments, one or more components, such as the output audio transducer(s) 3318 and frame 3316, can be configured to attach and detach (e.g., are detachably attachable) to HMD 3312 (e.g., a portion or all of frame 3316, and/or audio transducer 3318), as shown in FIG. 33B. In some embodiments, coupling a detachable component to HMD 3312 causes the detachable component to come into electronic communication with HMD 3312.

FIGS. 33A and 33B also show that VR system 3300 includes one or more cameras, such as left camera 3339A and right camera 3339B, which can be analogous to left and right cameras 3239A and 3239B on frame 3204 of eyewear device 3202. In some embodiments, VR system 3300 includes one or more additional cameras (e.g., cameras 3339C and 3339D), which can be configured to augment image data obtained by left and right cameras 3339A and 3339B by providing more information. For example, camera 3339C can be used to supply color information that is not discerned by cameras 3339A and 3339B. In some embodiments, one or more of cameras 3339A to 3339D can include an optional IR cut filter configured to remove IR light from being received at the respective camera sensors.

FIG. 34 illustrates a computing system 3420 and an optional housing 3490, each of which show components that can be included in AR system 3200 and/or VR system 3300. In some embodiments, more or fewer components can be included in optional housing 3490 depending on practical restraints of the respective AR system being described.

In some embodiments, computing system 3420 can include one or more peripherals interfaces 3422A and/or optional housing 3490 can include one or more peripherals interfaces 3422B. Each of computing system 3420 and optional housing 3490 can also include one or more power systems 3442A and 3442B, one or more controllers 3446 (including one or more haptic controllers 3447), one or more processors 3448A and 3448B (as defined above, including any of the examples provided), and memory 3450A and 3450B, which can all be in electronic communication with each other. For example, the one or more processors 3448A and 3448B can be configured to execute instructions stored in memory 3450A and 3450B, which can cause a controller of one or more of controllers 3446 to cause operations to be performed at one or more peripheral devices connected to peripherals interface 3422A and/or 3422B. In some embodiments, each operation described can be powered by electrical power provided by power system 3442A and/or 3442B.

In some embodiments, peripherals interface 3422A can include one or more devices configured to be part of computing system 3420, some of which have been defined above and/or described with respect to the wrist-wearable devices shown in FIGS. 30 and 31. For example, peripherals interface 3422A can include one or more sensors 3423A. Some example sensors 3423A include one or more coupling sensors 3424, one or more acoustic sensors 3425, one or more imaging sensors 3426, one or more EMG sensors 3427, one or more capacitive sensors 3428, one or more IMU sensors 3429, and/or any other types of sensors explained above or described with respect to any other embodiments discussed herein.

In some embodiments, peripherals interfaces 3422A and 3422B can include one or more additional peripheral devices, including one or more NFC devices 3430, one or more GPS devices 3431, one or more LTE devices 3432, one or more Wi-Fi and/or Bluetooth devices 3433, one or more buttons 3434 (e.g., including buttons that are slidable or otherwise adjustable), one or more displays 3435A and 3435B, one or more speakers 3436A and 3436B, one or more microphones 3437, one or more cameras 3438A and 3438B (e.g., including the left camera 3439A and/or a right camera 3439B), one or more haptic devices 3440, and/or any other types of peripheral devices defined above or described with respect to any other embodiments discussed herein.

AR systems can include a variety of types of visual feedback mechanisms (e.g., presentation devices). For example, display devices in AR system 3200 and/or VR system 3300 can include one or more liquid-crystal displays (LCDs), light emitting diode (LED) displays, organic LED (OLED) displays, and/or any other suitable types of display screens. Artificial-reality systems can include a single display screen (e.g., configured to be seen by both eyes), and/or can provide separate display screens for each eye, which can allow for additional flexibility for varifocal adjustments and/or for correcting a refractive error associated with a user's vision. Some embodiments of AR systems also include optical subsystems having one or more lenses (e.g., conventional concave or convex lenses, Fresnel lenses, or adjustable liquid lenses) through which a user can view a display screen.

For example, respective displays 3435A and 3435B can be coupled to each of the lenses 3206-1 and 3206-2 of AR system 3200. Displays 3435A and 3435B may be coupled to each of lenses 3206-1 and 3206-2, which can act together or independently to present an image or series of images to a user. In some embodiments, AR system 3200 includes a single display 3435A or 3435B (e.g., a near-eye display) or more than two displays 3435A and 3435B. In some embodiments, a first set of one or more displays 3435A and 3435B can be used to present an augmented-reality environment, and a second set of one or more display devices 3435A and 3435B can be used to present a virtual-reality environment. In some embodiments, one or more waveguides are used in conjunction with presenting artificial-reality content to the user of AR system 3200 (e.g., as a means of delivering light from one or more displays 3435A and 3435B to the user's eyes). In some embodiments, one or more waveguides are fully or partially integrated into the eyewear device 3202. Additionally, or alternatively to display screens, some artificial-reality systems include one or more projection systems. For example, display devices in AR system 3200 and/or VR system 3300 can include micro-LED projectors that project light (e.g., using a waveguide) into display devices, such as clear combiner lenses that allow ambient light to pass through. The display devices can refract the projected light toward a user's pupil and can enable a user to simultaneously view both artificial-reality content and the real world. Artificial-reality systems can also be configured with any other suitable type or form of image projection system. In some embodiments, one or more waveguides are provided additionally or alternatively to the one or more display(s) 3435A and 3435B.

Computing system 3420 and/or optional housing 3490 of AR system 3200 or VR system 3300 can include some or all of the components of a power system 3442A and 3442B. Power systems 3442A and 3442B can include one or more charger inputs 3443, one or more PMICs 3444, and/or one or more batteries 3445A and 3444B.

Memory 3450A and 3450B may include instructions and data, some or all of which may be stored as non-transitory computer-readable storage media within the memories 3450A and 3450B. For example, memory 3450A and 3450B can include one or more operating systems 3451, one or more applications 3452, one or more communication interface applications 3453A and 3453B, one or more graphics applications 3454A and 3454B, one or more AR processing applications 3455A and 3455B, and/or any other types of data defined above or described with respect to any other embodiments discussed herein.

Memory 3450A and 3450B also include data 3460A and 3460B, which can be used in conjunction with one or more of the applications discussed above. Data 3460A and 3460B can include profile data 3461, sensor data 3462A and 3462B, media content data 3463A, AR application data 3464A and 3464B, and/or any other types of data defined above or described with respect to any other embodiments discussed herein.

In some embodiments, controller 3446 of eyewear device 3202 may process information generated by sensors 3423A and/or 3423B on eyewear device 3202 and/or another electronic device within AR system 3200. For example, controller 3446 can process information from acoustic sensors 3225-1 and 3225-2. For each detected sound, controller 3446 can perform a direction of arrival (DOA) estimation to estimate a direction from which the detected sound arrived at eyewear device 3202 of AR system 3200. As one or more of acoustic sensors 3425 (e.g., the acoustic sensors 3225-1, 3225-2) detects sounds, controller 3446 can populate an audio data set with the information (e.g., represented as sensor data 3462A and 3462B).

In some embodiments, a physical electronic connector can convey information between eyewear device 3202 and another electronic device and/or between one or more processors 3248, 3448A, 3448B of AR system 3200 or VR system 3300 and controller 3446. The information can be in the form of optical data, electrical data, wireless data, or any other transmittable data form. Moving the processing of information generated by eyewear device 3202 to an intermediary processing device can reduce weight and heat in the eyewear device, making it more comfortable and safer for a user. In some embodiments, an optional wearable accessory device (e.g., an electronic neckband) is coupled to eyewear device 3202 via one or more connectors. The connectors can be wired or wireless connectors and can include electrical and/or non-electrical (e.g., structural) components. In some embodiments, eyewear device 3202 and the wearable accessory device can operate independently without any wired or wireless connection between them.

In some situations, pairing external devices, such as an intermediary processing device (e.g., HIPD 2606, 2706, 2806) with eyewear device 3202 (e.g., as part of AR system 3200) enables eyewear device 3202 to achieve a similar form factor of a pair of glasses while still providing sufficient battery and computation power for expanded capabilities. Some, or all, of the battery power, computational resources, and/or additional features of AR system 3200 can be provided by a paired device or shared between a paired device and eyewear device 3202, thus reducing the weight, heat profile, and form factor of eyewear device 3202 overall while allowing eyewear device 3202 to retain its desired functionality. For example, the wearable accessory device can allow components that would otherwise be included on eyewear device 3202 to be included in the wearable accessory device and/or intermediary processing device, thereby shifting a weight load from the user's head and neck to one or more other portions of the user's body. In some embodiments, the intermediary processing device has a larger surface area over which to diffuse and disperse heat to the ambient environment. Thus, the intermediary processing device can allow for greater battery and computation capacity than might otherwise have been possible on eyewear device 3202 standing alone. Because weight carried in the wearable accessory device can be less invasive to a user than weight carried in the eyewear device 3202, a user may tolerate wearing a lighter eyewear device and carrying or wearing the paired device for greater lengths of time than the user would tolerate wearing a heavier eyewear device standing alone, thereby enabling an artificial-reality environment to be incorporated more fully into a user's day-to-day activities.

AR systems can include various types of computer vision components and subsystems. For example, AR system 3200 and/or VR system 3300 can include one or more optical sensors such as two-dimensional (2D) or three-dimensional (3D) cameras, time-of-flight depth sensors, structured light transmitters and detectors, single-beam or sweeping laser rangefinders, 3D LiDAR sensors, and/or any other suitable type or form of optical sensor. An AR system can process data from one or more of these sensors to identify a location of a user and/or aspects of the use's real-world physical surroundings, including the locations of real-world objects within the real-world physical surroundings. In some embodiments, the methods described herein are used to map the real world, to provide a user with context about real-world surroundings, and/or to generate digital twins (e.g., interactable virtual objects), among a variety of other functions. For example, FIGS. 33A and 33B show VR system 3300 having cameras 3339A to 3339D, which can be used to provide depth information for creating a voxel field and a two-dimensional mesh to provide object information to the user to avoid collisions.

In some embodiments, AR system 3200 and/or VR system 3300 can include haptic (tactile) feedback systems, which may be incorporated into headwear, gloves, body suits, handheld controllers, environmental devices (e.g., chairs or floormats), and/or any other type of device or system, such as the wearable devices discussed herein. The haptic feedback systems may provide various types of cutaneous feedback, including vibration, force, traction, shear, texture, and/or temperature. The haptic feedback systems may also provide various types of kinesthetic feedback, such as motion and compliance. The haptic feedback may be implemented using motors, piezoelectric actuators, fluidic systems, and/or a variety of other types of feedback mechanisms. The haptic feedback systems may be implemented independently of other artificial-reality devices, within other artificial-reality devices, and/or in conjunction with other artificial-reality devices.

In some embodiments of an artificial reality system, such as AR system 3200 and/or VR system 3300, ambient light (e.g., a live feed of the surrounding environment that a user would normally see) can be passed through a display element of a respective head-wearable device presenting aspects of the AR system. In some embodiments, ambient light can be passed through a portion less that is less than all of an AR environment presented within a user's field of view (e.g., a portion of the AR environment co-located with a physical object in the user's real-world environment that is within a designated boundary (e.g., a guardian boundary) configured to be used by the user while they are interacting with the AR environment). For example, a visual user interface element (e.g., a notification user interface element) can be presented at the head-wearable device, and an amount of ambient light (e.g., 15-50% of the ambient light) can be passed through the user interface element such that the user can distinguish at least a portion of the physical environment over which the user interface element is being displayed.

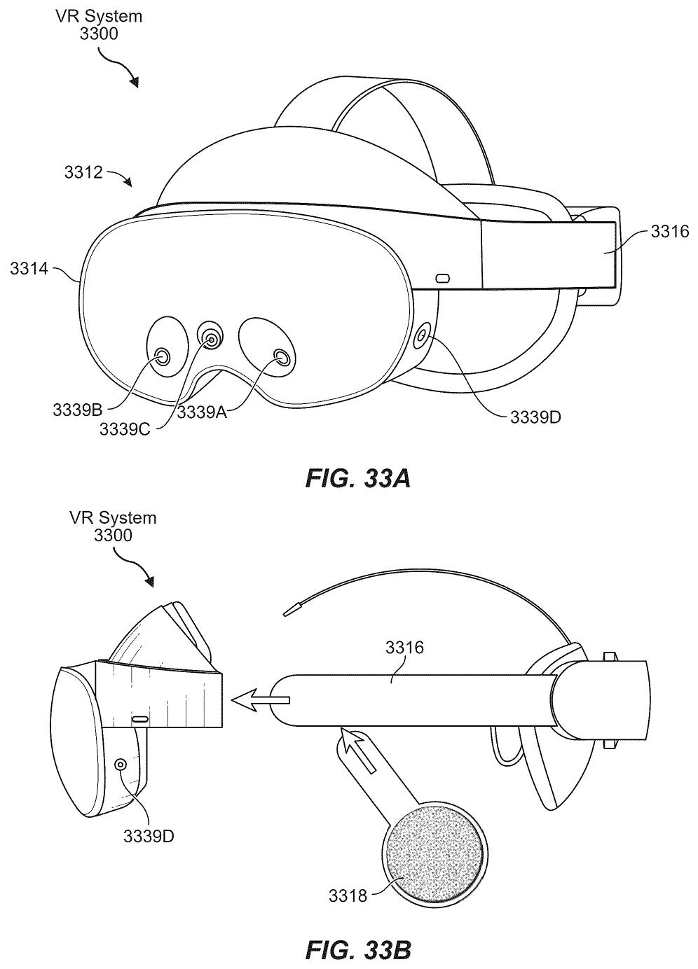

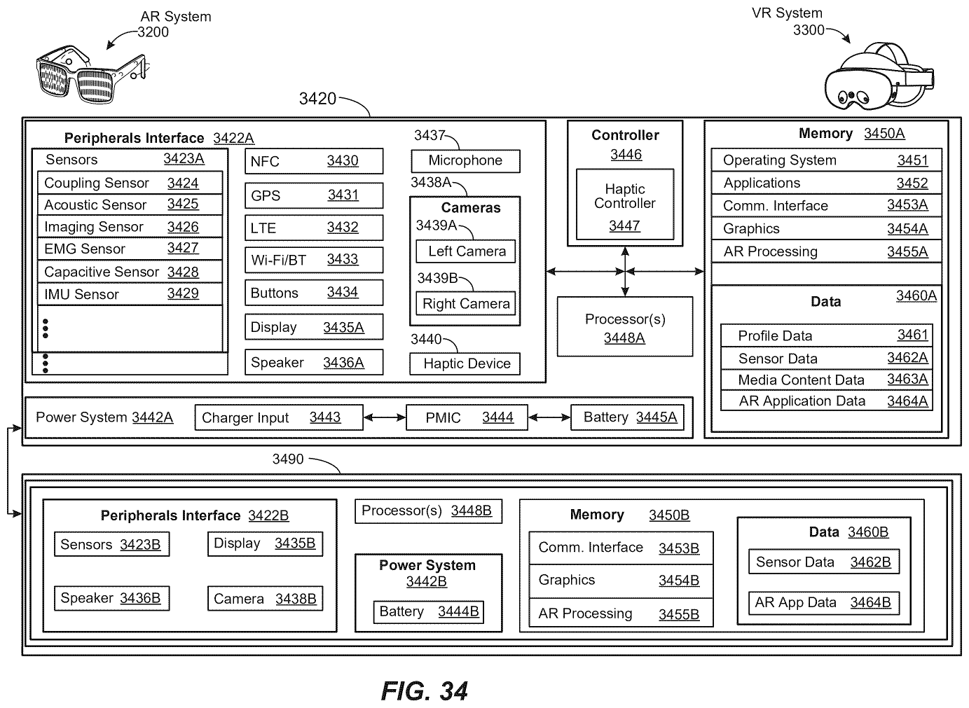

FIGS. 35A and 35B illustrate an example handheld intermediary processing device (HIPD) 3500 in accordance with some embodiments. HIPD 3500 is an instance of the intermediary device described herein, such that HIPD 3500 should be understood to have the features described with respect to any intermediary device defined above or otherwise described herein and vice versa. FIG. 35A shows a top view and FIG. 35B shows a side view of the HIPD 3500. HIPD 3500 is configured to communicatively couple with one or more wearable devices (or other electronic devices) associated with a user. For example, HIPD 3500 is configured to communicatively couple with a user's wrist-wearable device 2602, 2702 (or components thereof, such as watch body 3020 and wearable band 3010), AR glasses 3200, and/or VR headset 2850 and 3300. HIPD 3500 can be configured to be held by a user (e.g., as a handheld controller), carried on the user's person (e.g., in their pocket, in their bag, etc.), placed in proximity of the user (e.g., placed on their desk while seated at their desk, on a charging dock, etc.), and/or placed at or within a predetermined distance from a wearable device or other electronic device (e.g., where, in some embodiments, the predetermined distance is the maximum distance (e.g., 10 meters) at which HIPD 3500 can successfully be communicatively coupled with an electronic device, such as a wearable device).

HIPD 3500 can perform various functions independently and/or in conjunction with one or more wearable devices (e.g., wrist-wearable device 2602, AR glasses 3200, VR system 3310, etc.). HIPD 3500 can be configured to increase and/or improve the functionality of communicatively coupled devices, such as the wearable devices. HIPD 3500 can be configured to perform one or more functions or operations associated with interacting with user interfaces and applications of communicatively coupled devices, interacting with an AR environment, interacting with VR environment, and/or operating as a human-machine interface controller, as well as functions and/or operations described above with reference to FIGS. 26-28B. Additionally, as will be described in more detail below, functionality and/or operations of HIPD 3500 can include, without limitation, task offloading and/or handoffs; thermals offloading and/or handoffs; six degrees of freedom (6DoF) raycasting and/or gaming (e.g., using imaging devices or cameras 3514A, 3514B, which can be used for simultaneous localization and mapping (SLAM) and/or with other image processing techniques), portable charging, messaging, image capturing via one or more imaging devices or cameras 3522A and 3522B, sensing user input (e.g., sensing a touch on a touch input surface 3502), wireless communications and/or interlining (e.g., cellular, near field, Wi-Fi, personal area network, etc.), location determination, financial transactions, providing haptic feedback, alarms, notifications, biometric authentication, health monitoring, sleep monitoring, etc. The above-described example functions can be executed independently in HIPD 3500 and/or in communication between HIPD 3500 and another wearable device described herein. In some embodiments, functions can be executed on HIPD 3500 in conjunction with an AR environment. As the skilled artisan will appreciate upon reading the descriptions provided herein that HIPD 3500 can be used with any type of suitable AR environment.

While HIPD 3500 is communicatively coupled with a wearable device and/or other electronic device, HIPD 3500 is configured to perform one or more operations initiated at the wearable device and/or the other electronic device. In particular, one or more operations of the wearable device and/or the other electronic device can be offloaded to HIPD 3500 to be performed. HIPD 3500 performs the one or more operations of the wearable device and/or the other electronic device and provides to data corresponded to the completed operations to the wearable device and/or the other electronic device. For example, a user can initiate a video stream using AR glasses 3200 and back-end tasks associated with performing the video stream (e.g., video rendering) can be offloaded to HIPD 3500, which HIPD 3500 performs and provides corresponding data to AR glasses 3200 to perform remaining front-end tasks associated with the video stream (e.g., presenting the rendered video data via a display of AR glasses 3200). In this way, HIPD 3500, which has more computational resources and greater thermal headroom than a wearable device, can perform computationally intensive tasks for the wearable device, thereby improving performance of an operation performed by the wearable device.

HIPD 3500 includes a multi-touch input surface 3502 on a first side (e.g., a front surface) that is configured to detect one or more user inputs. In particular, multi-touch input surface 3502 can detect single tap inputs, multi-tap inputs, swipe gestures and/or inputs, force-based and/or pressure-based touch inputs, held taps, and the like. Multi-touch input surface 3502 is configured to detect capacitive touch inputs and/or force (and/or pressure) touch inputs. Multi-touch input surface 3502 includes a first touch-input surface 3504 defined by a surface depression and a second touch-input surface 3506 defined by a substantially planar portion. First touch-input surface 3504 can be disposed adjacent to second touch-input surface 3506. In some embodiments, first touch-input surface 3504 and second touch-input surface 3506 can be different dimensions and/or shapes. For example, first touch-input surface 3504 can be substantially circular and second touch-input surface 3506 can be substantially rectangular. In some embodiments, the surface depression of multi-touch input surface 3502 is configured to guide user handling of HIPD 3500. In particular, the surface depression can be configured such that the user holds HIPD 3500 upright when held in a single hand (e.g., such that the using imaging devices or cameras 3514A and 3514B are pointed toward a ceiling or the sky). Additionally, the surface depression is configured such that the user's thumb rests within first touch-input surface 3504.

In some embodiments, the different touch-input surfaces include a plurality of touch-input zones. For example, second touch-input surface 3506 includes at least a second touch-input zone 3508 within a first touch-input zone 3507 and a third touch-input zone 3510 within second touch-input zone 3508. In some embodiments, one or more of touch-input zones 3508 and 3510 are optional and/or user defined (e.g., a user can specific a touch-input zone based on their preferences). In some embodiments, each touch-input surface 3504 and 3506 and/or touch-input zone 3508 and 3510 are associated with a predetermined set of commands. For example, a user input detected within first touch-input zone 3508 may cause HIPD 3500 to perform a first command and a user input detected within second touch-input surface 3506 may cause HIPD 3500 to perform a second command, distinct from the first. In some embodiments, different touch-input surfaces and/or touch-input zones are configured to detect one or more types of user inputs. The different touch-input surfaces and/or touch-input zones can be configured to detect the same or distinct types of user inputs. For example, first touch-input zone 3508 can be configured to detect force touch inputs (e.g., a magnitude at which the user presses down) and capacitive touch inputs, and second touch-input zone 3510 can be configured to detect capacitive touch inputs.

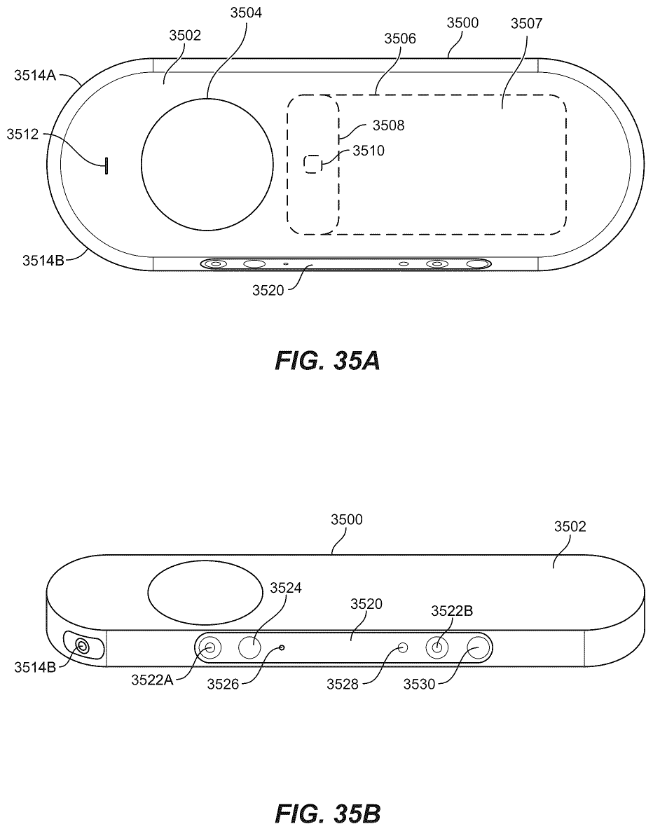

As shown in FIG. 36, HIPD 3500 includes one or more sensors 3651 for sensing data used in the performance of one or more operations and/or functions. For example, HIPD 3500 can include an IMU sensor that is used in conjunction with cameras 3514A, 3514B (FIGS. 35A-35B) for 3-dimensional object manipulation (e.g., enlarging, moving, destroying, etc., an object) in an AR or VR environment. Non-limiting examples of sensors 3651 included in HIPD 3500 include a light sensor, a magnetometer, a depth sensor, a pressure sensor, and a force sensor.

HIPD 3500 can include one or more light indicators 3512 to provide one or more notifications to the user. In some embodiments, light indicators 3512 are LEDs or other types of illumination devices. Light indicators 3512 can operate as a privacy light to notify the user and/or others near the user that an imaging device and/or microphone are active. In some embodiments, a light indicator is positioned adjacent to one or more touch-input surfaces. For example, a light indicator can be positioned around first touch-input surface 3504. Light indicators 3512 can be illuminated in different colors and/or patterns to provide the user with one or more notifications and/or information about the device. For example, a light indicator positioned around first touch-input surface 3504 may flash when the user receives a notification (e.g., a message), change red when HIPD 3500 is out of power, operate as a progress bar (e.g., a light ring that is closed when a task is completed (e.g., 0% to 100%)), operate as a volume indicator, etc.

In some embodiments, HIPD 3500 includes one or more additional sensors on another surface. For example, as shown FIG. 35A, HIPD 3500 includes a set of one or more sensors (e.g., sensor set 3520) on an edge of HIPD 3500. Sensor set 3520, when positioned on an edge of the of HIPD 3500, can be pe positioned at a predetermined tilt angle (e.g., 26 degrees), which allows sensor set 3520 to be angled toward the user when placed on a desk or other flat surface. Alternatively, in some embodiments, sensor set 3520 is positioned on a surface opposite the multi-touch input surface 3502 (e.g., a back surface). The one or more sensors of sensor set 3520 are discussed in further detail below.

The side view of the of HIPD 3500 in FIG. 35B shows sensor set 3520 and camera 3514B. Sensor set 3520 can include one or more cameras 3522A and 3522B, a depth projector 3524, an ambient light sensor 3528, and a depth receiver 3530. In some embodiments, sensor set 3520 includes a light indicator 3526. Light indicator 3526 can operate as a privacy indicator to let the user and/or those around them know that a camera and/or microphone is active. Sensor set 3520 is configured to capture a user's facial expression such that the user can puppet a custom avatar (e.g., showing emotions, such as smiles, laughter, etc., on the avatar or a digital representation of the user). Sensor set 3520 can be configured as a side stereo RGB system, a rear indirect Time-of-Flight (iToF) system, or a rear stereo RGB system. As the skilled artisan will appreciate upon reading the descriptions provided herein, HIPD 3500 described herein can use different sensor set 3520 configurations and/or sensor set 3520 placement.

Turning to FIG. 36, in some embodiments, a computing system 3640 of HIPD 3500 can include one or more haptic devices 3671 (e.g., a vibratory haptic actuator) that are configured to provide haptic feedback (e.g., kinesthetic sensation). Sensors 3651 and/or the haptic devices 3671 can be configured to operate in conjunction with multiple applications and/or communicatively coupled devices including, without limitation, a wearable devices, health monitoring applications, social media applications, game applications, and artificial reality applications (e.g., the applications associated with artificial reality).

In some embodiments, HIPD 3500 is configured to operate without a display. However, optionally, computing system 3640 of the HIPD 3500 can include a display 3668. HIPD 3500 can also include one or more optional peripheral buttons 3667. For example, peripheral buttons 3667 can be used to turn on or turn off HIPD 3500. Further, HIPD 3500 housing can be formed of polymers and/or elastomers. In other words, HIPD 3500 may be designed such that it would not easily slide off a surface. In some embodiments, HIPD 3500 includes one or magnets to couple HIPD 3500 to another surface. This allows the user to mount HIPD 3500 to different surfaces and provide the user with greater flexibility in use of HIPD 3500.

As described above, HIPD 3500 can distribute and/or provide instructions for performing the one or more tasks at HIPD 3500 and/or a communicatively coupled device. For example, HIPD 3500 can identify one or more back-end tasks to be performed by HIPD 3500 and one or more front-end tasks to be performed by a communicatively coupled device. While HIPD 3500 is configured to offload and/or handoff tasks of a communicatively coupled device, HIPD 3500 can perform both back-end and front-end tasks (e.g., via one or more processors, such as CPU 3677). HIPD 3500 can, without limitation, can be used to perform augmented calling (e.g., receiving and/or sending 3D or 2.5D live volumetric calls, live digital human representation calls, and/or avatar calls), discreet messaging, 6DoF portrait/landscape gaming, AR/VR object manipulation, AR/VR content display (e.g., presenting content via a virtual display), and/or other AR/VR interactions. HIPD 3500 can perform the above operations alone or in conjunction with a wearable device (or other communicatively coupled electronic device).

FIG. 36 shows a block diagram of a computing system 3640 of HIPD 3500 in accordance with some embodiments. HIPD 3500, described in detail above, can include one or more components shown in HIPD computing system 3640. HIPD 3500 will be understood to include the components shown and described below for HIPD computing system 3640. In some embodiments, all, or a substantial portion of the components of HIPD computing system 3640 are included in a single integrated circuit. Alternatively, in some embodiments, components of HIPD computing system 3640 are included in a plurality of integrated circuits that are communicatively coupled.

HIPD computing system 3640 can include a processor (e.g., a CPU 3677, a GPU, and/or a CPU with integrated graphics), a controller 3675, a peripherals interface 3650 that includes one or more sensors 3651 and other peripheral devices, a power source (e.g., a power system 3695), and memory (e.g., a memory 3678) that includes an operating system (e.g., an operating system 3679), data (e.g., data 3688), one or more applications (e.g., applications 3680), and one or more modules (e.g., a communications interface module 3681, a graphics module 3682, a task and processing management module 3683, an interoperability module 3684, an AR processing module 3685, a data management module 3686, etc.). HIPD computing system 3640 further includes a power system 3695 that includes a charger input and output 3696, a PMIC 3697, and a battery 3698, all of which are defined above.

In some embodiments, peripherals interface 3650 can include one or more sensors 3651. Sensors 3651 can include analogous sensors to those described above in reference to FIG. 30. For example, sensors 3651 can include imaging sensors 3654, (optional) EMG sensors 3656, IMU sensors 3658, and capacitive sensors 3660. In some embodiments, sensors 3651 can include one or more pressure sensors 3652 for sensing pressure data, an altimeter 3653 for sensing an altitude of the HIPD 3500, a magnetometer 3655 for sensing a magnetic field, a depth sensor 3657 (or a time-of flight sensor) for determining a difference between the camera and the subject of an image, a position sensor 3659 (e.g., a flexible position sensor) for sensing a relative displacement or position change of a portion of the HIPD 3500, a force sensor 3661 for sensing a force applied to a portion of the HIPD 3500, and a light sensor 3662 (e.g., an ambient light sensor) for detecting an amount of lighting. Sensors 3651 can include one or more sensors not shown in FIG. 36.

Analogous to the peripherals described above in reference to FIG. 30, peripherals interface 3650 can also include an NFC component 3663, a GPS component 3664, an LTE component 3665, a Wi-Fi and/or Bluetooth communication component 3666, a speaker 3669, a haptic device 3671, and a microphone 3673. As noted above, HIPD 3500 can optionally include a display 3668 and/or one or more peripheral buttons 3667. Peripherals interface 3650 can further include one or more cameras 3670, touch surfaces 3672, and/or one or more light emitters 3674. Multi-touch input surface 3502 described above in reference to FIGS. 35A and 35B is an example of touch surface 3672. Light emitters 3674 can be one or more LEDs, lasers, etc. and can be used to project or present information to a user. For example, light emitters 3674 can include light indicators 3512 and 3526 described above in reference to FIGS. 35A and 35B. Cameras 3670 (e.g., cameras 3514A, 3514B, 3522A, and 3522B described above in reference to FIGS. 35A and 35B) can include one or more wide angle cameras, fish-eye cameras, spherical cameras, compound eye cameras (e.g., stereo and multi cameras), depth cameras, RGB cameras, ToF cameras, RGB-D cameras (depth and ToF cameras), and/or other suitable cameras. Cameras 3670 can be used for SLAM, 6DoF ray casting, gaming, object manipulation and/or other rendering, facial recognition and facial expression recognition, etc.

Similar to watch body computing system 3160 and watch band computing system 3130 described above in reference to FIG. 31, HIPD computing system 3640 can include one or more haptic controllers 3676 and associated componentry (e.g., haptic devices 3671) for providing haptic events at HIPD 3500.

Memory 3678 can include high-speed random-access memory and/or non-volatile memory, such as one or more magnetic disk storage devices, flash memory devices, or other non-volatile solid-state memory devices. Access to memory 3678 by other components of HIPD 3500, such as the one or more processors and peripherals interface 3650, can be controlled by a memory controller of controllers 3675.

In some embodiments, software components stored in memory 3678 include one or more operating systems 3679, one or more applications 3680, one or more communication interface modules 3681, one or more graphics modules 3682, and/or one or more data management modules 3686, which are analogous to the software components described above in reference to FIG. 30.

In some embodiments, software components stored in memory 3678 include a task and processing management module 3683 for identifying one or more front-end and back-end tasks associated with an operation performed by the user, performing one or more front-end and/or back-end tasks, and/or providing instructions to one or more communicatively coupled devices that cause performance of the one or more front-end and/or back-end tasks. In some embodiments, task and processing management module 3683 uses data 3688 (e.g., device data 3690) to distribute the one or more front-end and/or back-end tasks based on communicatively coupled devices'computing resources, available power, thermal headroom, ongoing operations, and/or other factors. For example, task and processing management module 3683 can cause the performance of one or more back-end tasks (of an operation performed at communicatively coupled AR system 3200) at HIPD 3500 in accordance with a determination that the operation is utilizing a predetermined amount (e.g., at least 70%) of computing resources available at AR system 3200.

In some embodiments, software components stored in memory 3678 include an interoperability module 3684 for exchanging and utilizing information received and/or provided to distinct communicatively coupled devices. Interoperability module 3684 allows for different systems, devices, and/or applications to connect and communicate in a coordinated way without user input. In some embodiments, software components stored in memory 3678 include an AR processing module 3685 that is configured to process signals based at least on sensor data for use in an AR and/or VR environment. For example, AR processing module 3685 can be used for 3D object manipulation, gesture recognition, facial and facial expression recognition, etc.

Memory 3678 can also include data 3688. In some embodiments, data 3688 can include profile data 3689, device data 3690 (including device data of one or more devices communicatively coupled with HIPD 3500, such as device type, hardware, software, configurations, etc.), sensor data 3691, media content data 3692, and application data 3693.

It should be appreciated that HIPD computing system 3640 is an example of a computing system within HIPD 3500, and that HIPD 3500 can have more or fewer components than shown in HIPD computing system 3640, combine two or more components, and/or have a different configuration and/or arrangement of the components. The various components shown HIPD computing system 3640 are implemented in hardware, software, firmware, or a combination thereof, including one or more signal processing and/or application-specific integrated circuits.

The techniques described above in FIGS. 35A, 35B, and 36 can be used with any device used as a human-machine interface controller. In some embodiments, an HIPD 3500 can be used in conjunction with one or more wearable device such as a head-wearable device (e.g., AR system 3200 and VR system 3310) and/or a wrist-wearable device 3000 (or components thereof).

In some embodiments, the artificial reality devices and/or accessory devices disclosed herein may include haptic interfaces with transducers that provide haptic feedback and/or that collect haptic information about a user's interaction with an environment. The artificial-reality systems disclosed herein may include various types of haptic interfaces that detect or convey various types of haptic information, including tactile feedback (e.g., feedback that a user detects via nerves in the skin, which may also be referred to as cutaneous feedback) and/or kinesthetic feedback (e.g., feedback that a user detects via receptors located in muscles, joints, and/or tendons). In some examples, cutaneous feedback may include vibration, force, traction, texture, and/or temperature. Similarly, kinesthetic feedback, may include motion and compliance. Cutaneous and/or kinesthetic feedback may be provided using motors, piezoelectric actuators, fluidic systems, and/or a variety of other types of feedback mechanisms. Furthermore, haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The haptics assemblies disclosed herein may enable or enhance a user's artificial-reality experience in one or more of these contexts and environments and/or in other contexts and environments.

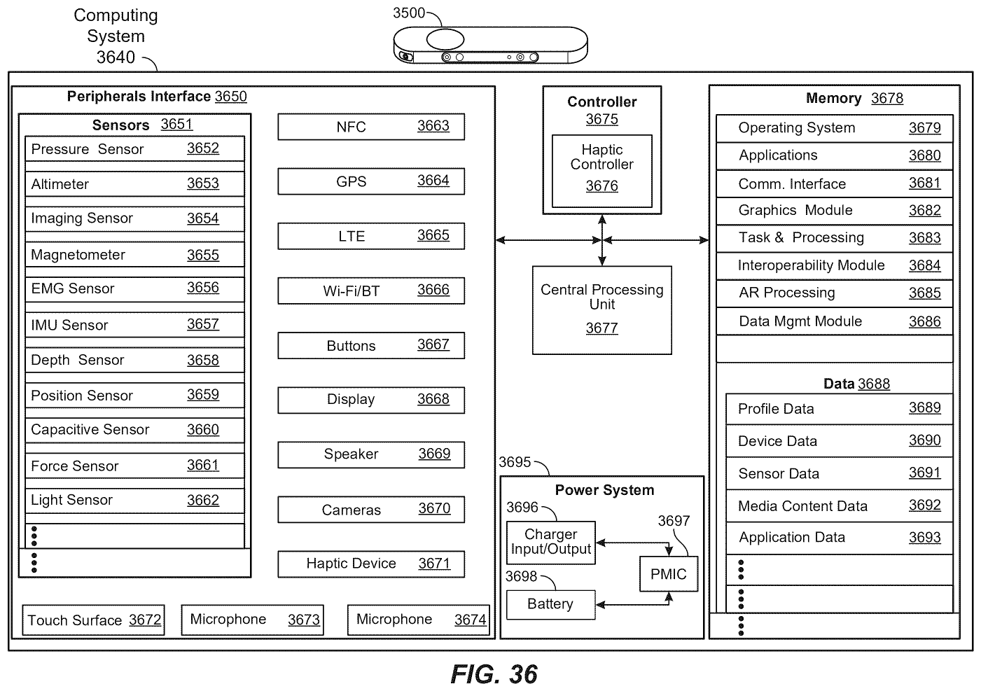

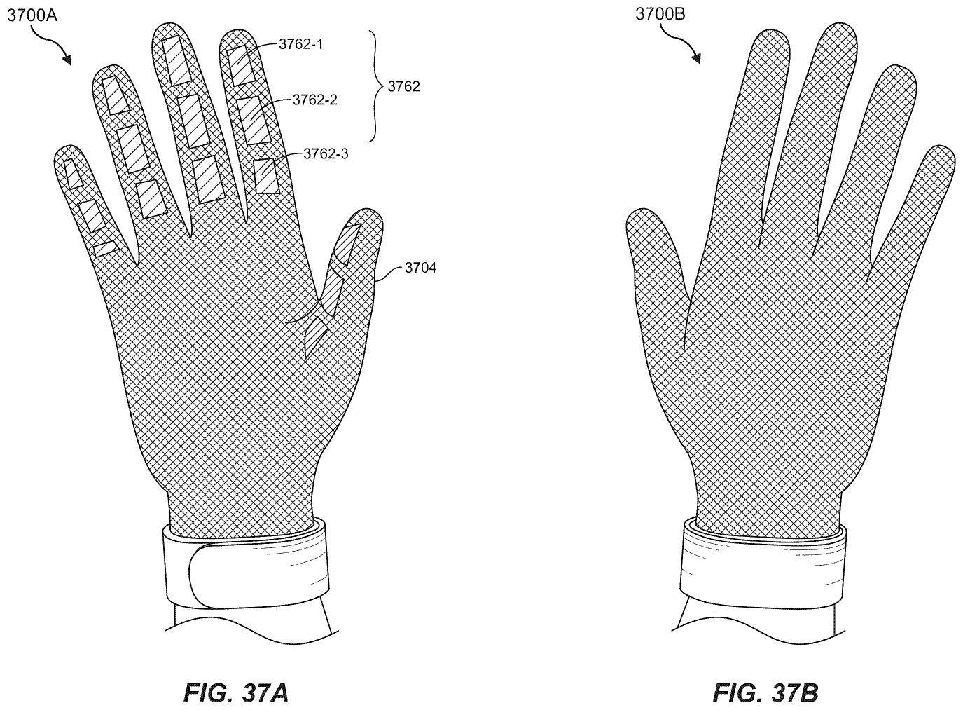

FIGS. 37A and 37B show example haptic feedback systems (e.g., hand-wearable devices) for providing feedback to a user regarding the user's interactions with a computing system (e.g., an artificial-reality environment presented by the AR system 3200 or the VR system 3310). In some embodiments, a computing system (e.g., the AR systems 2800 and/or 2900) may also provide feedback to one or more users based on an action that was performed within the computing system and/or an interaction provided by the AR system (e.g., which may be based on instructions that are executed in conjunction with performing operations of an application of the computing system). Such feedback may include visual and/or audio feedback and may also include haptic feedback provided by a haptic assembly, such as one or more haptic assemblies 3762 of haptic device 3700 (e.g., haptic assemblies 3762-1, 3762-2, 3762-3, etc.). For example, the haptic feedback may prevent (or, at a minimum, hinder/resist movement of) one or more fingers of a user from bending past a certain point to simulate the sensation of touching a solid coffee mug. In actuating such haptic effects, haptic device 3700 can change (either directly or indirectly) a pressurized state of one or more of haptic assemblies 3762.

Vibrotactile system 3700 may optionally include other subsystems and components, such as touch-sensitive pads, pressure sensors, motion sensors, position sensors, lighting elements, and/or user interface elements (e.g., an on/off button, a vibration control element, etc.). During use, haptic assemblies 3762 may be configured to be activated for a variety of different reasons, such as in response to the user's interaction with user interface elements, a signal from the motion or position sensors, a signal from the touch-sensitive pads, a signal from the pressure sensors, a signal from the other device or system, etc.

In FIGS. 37A and 37B, each of haptic assemblies 3762 may include a mechanism that, at a minimum, provides resistance when the respective haptic assembly 3762 is transitioned from a first pressurized state (e.g., atmospheric pressure or deflated) to a second pressurized state (e.g., inflated to a threshold pressure). Structures of haptic assemblies 3762 can be integrated into various devices configured to be in contact or proximity to a user's skin, including, but not limited to devices such as glove worn devices, body worn clothing device, headset devices.

As noted above, haptic assemblies 3762 described herein can be configured to transition between a first pressurized state and a second pressurized state to provide haptic feedback to the user. Due to the ever-changing nature of artificial-reality, haptic assemblies 3762 may be required to transition between the two states hundreds, or perhaps thousands of times, during a single use. Thus, haptic assemblies 3762 described herein are durable and designed to quickly transition from state to state. To provide some context, in the first pressurized state, haptic assemblies 3762 do not impede free movement of a portion of the wearer's body. For example, one or more haptic assemblies 3762 incorporated into a glove are made from flexible materials that do not impede free movement of the wearer's hand and fingers (e.g., an electrostatic-zipping actuator). Haptic assemblies 3762 may be configured to conform to a shape of the portion of the wearer's body when in the first pressurized state. However, once in the second pressurized state, haptic assemblies 3762 can be configured to restrict and/or impede free movement of the portion of the wearer's body (e.g., appendages of the user's hand). For example, the respective haptic assembly 3762 (or multiple respective haptic assemblies) can restrict movement of a wearer's finger (e.g., prevent the finger from curling or extending) when haptic assembly 3762 is in the second pressurized state. Moreover, once in the second pressurized state, haptic assemblies 3762 may take different shapes, with some haptic assemblies 3762 configured to take a planar, rigid shape (e.g., flat and rigid), while some other haptic assemblies 3762 are configured to curve or bend, at least partially.

As a non-limiting example, haptic device 3700 includes a plurality of haptic devices (e.g., a pair of haptic gloves, a haptics component of a wrist-wearable device (e.g., any of the wrist-wearable devices described with respect to FIGS. 26-30), etc.), each of which can include a garment component (e.g., a garment 3704) and one or more haptic assemblies coupled (e.g., physically coupled) to the garment component. For example, each of the haptic assemblies 3762-1, 3762-2, 3762-3, . . . 3762-N are physically coupled to the garment 3704 and are configured to contact respective phalanges of a user's thumb and fingers. As explained above, haptic assemblies 3762 are configured to provide haptic simulations to a wearer of device 3700. Garment 3704 of each device 3700 can be one of various articles of clothing (e.g., gloves, socks, shirts, pants, etc.). Thus, a user may wear multiple haptic devices 3700 that are each configured to provide haptic stimulations to respective parts of the body where haptic devices 3700 are being worn.

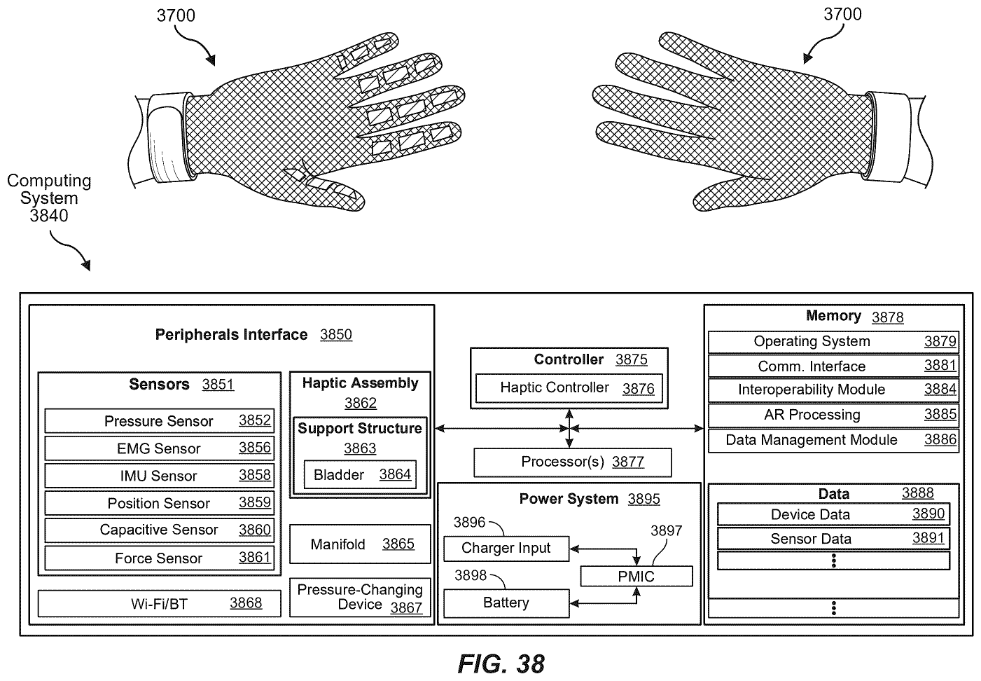

FIG. 38 shows block diagrams of a computing system 3840 of haptic device 3700, in accordance with some embodiments. Computing system 3840 can include one or more peripherals interfaces 3850, one or more power systems 3895, one or more controllers 3875 (including one or more haptic controllers 3876), one or more processors 3877 (as defined above, including any of the examples provided), and memory 3878, which can all be in electronic communication with each other. For example, one or more processors 3877 can be configured to execute instructions stored in the memory 3878, which can cause a controller of the one or more controllers 3875 to cause operations to be performed at one or more peripheral devices of peripherals interface 3850. In some embodiments, each operation described can occur based on electrical power provided by the power system 3895. The power system 3895 can include a charger input 3896, a PMIC 3897, and a battery 3898.

In some embodiments, peripherals interface 3850 can include one or more devices configured to be part of computing system 3840, many of which have been defined above and/or described with respect to wrist-wearable devices shown in FIGS. 30 and 31. For example, peripherals interface 3850 can include one or more sensors 3851. Some example sensors include: one or more pressure sensors 3852, one or more EMG sensors 3856, one or more IMU sensors 3858, one or more position sensors 3859, one or more capacitive sensors 3860, one or more force sensors 3861; and/or any other types of sensors defined above or described with respect to any other embodiments discussed herein.

In some embodiments, the peripherals interface can include one or more additional peripheral devices, including one or more Wi-Fi and/or Bluetooth devices 3868; one or more haptic assemblies 3862; one or more support structures 3863 (which can include one or more bladders 3864; one or more manifolds 3865; one or more pressure-changing devices 3867; and/or any other types of peripheral devices defined above or described with respect to any other embodiments discussed herein.

In some embodiments, each haptic assembly 3862 includes a support structure 3863 and at least one bladder 3864. Bladder 3864 (e.g., a membrane) may be a sealed, inflatable pocket made from a durable and puncture-resistant material, such as thermoplastic polyurethane (TPU), a flexible polymer, or the like. Bladder 3864 contains a medium (e.g., a fluid such as air, inert gas, or even a liquid) that can be added to or removed from bladder 3864 to change a pressure (e.g., fluid pressure) inside the bladder 3864. Support structure 3863 is made from a material that is stronger and stiffer than the material of bladder 3864. A respective support structure 3863 coupled to a respective bladder 3864 is configured to reinforce the respective bladder 3864 as the respective bladder 3864 changes shape and size due to changes in pressure (e.g., fluid pressure) inside the bladder.

The system 3840 also includes a haptic controller 3876 and a pressure-changing device 3867. In some embodiments, haptic controller 3876 is part of the computer system 3840 (e.g., in electronic communication with one or more processors 3877 of the computer system 3840). Haptic controller 3876 is configured to control operation of pressure-changing device 3867, and in turn operation of haptic device 3700. For example, haptic controller 3876 sends one or more signals to pressure-changing device 3867 to activate pressure-changing device 3867 (e.g., turn it on and off). The one or more signals may specify a desired pressure (e.g., pounds-per-square inch) to be output by pressure-changing device 3867. Generation of the one or more signals, and in turn the pressure output by pressure-changing device 3867, may be based on information collected by sensors 3851. For example, the one or more signals may cause pressure-changing device 3867 to increase the pressure (e.g., fluid pressure) inside a first haptic assembly 3862 at a first time, based on the information collected by sensors 3851 (e.g., the user makes contact with an artificial coffee mug or other artificial object). Then, the controller may send one or more additional signals to pressure-changing device 3867 that cause pressure-changing device 3867 to further increase the pressure inside first haptic assembly 3862 at a second time after the first time, based on additional information collected by sensors 3851. Further, the one or more signals may cause pressure-changing device 3867 to inflate one or more bladders 3864 in a first device 3700A, while one or more bladders 3864 in a second device 3700B remain unchanged. Additionally, the one or more signals may cause pressure-changing device 3867 to inflate one or more bladders 3864 in a first device 3700A to a first pressure and inflate one or more other bladders 3864 in first device 3700A to a second pressure different from the first pressure. Depending on number of devices 3700 serviced by pressure-changing device 3867, and the number of bladders therein, many different inflation configurations can be achieved through the one or more signals and the examples above are not meant to be limiting.

The system 3840 may include an optional manifold 3865 between pressure-changing device 3867 and haptic devices 3700. Manifold 3865 may include one or more valves (not shown) that pneumatically couple each of haptic assemblies 3862 with pressure-changing device 3867 via tubing. In some embodiments, manifold 3865 is in communication with controller 3875, and controller 3875 controls the one or more valves of manifold 3865 (e.g., the controller generates one or more control signals). Manifold 3865 is configured to switchably couple pressure-changing device 3867 with one or more haptic assemblies 3862 of the same or different haptic devices 3700 based on one or more control signals from controller 3875. In some embodiments, instead of using manifold 3865 to pneumatically couple pressure-changing device 3867 with haptic assemblies 3862, system 3840 may include multiple pressure-changing devices 3867, where each pressure-changing device 3867 is pneumatically coupled directly with a single haptic assembly 3862 or multiple haptic assemblies 3862. In some embodiments, pressure-changing device 3867 and optional manifold 3865 can be configured as part of one or more of the haptic devices 3700 while, in other embodiments, pressure-changing device 3867 and optional manifold 3865 can be configured as external to haptic device 3700. A single pressure-changing device 3867 may be shared by multiple haptic devices 3700.

In some embodiments, pressure-changing device 3867 is a pneumatic device, hydraulic device, a pneudraulic device, or some other device capable of adding and removing a medium (e.g., fluid, liquid, gas) from the one or more haptic assemblies 3862.

The devices shown in FIGS. 37A-38 may be coupled via a wired connection (e.g., via busing). Alternatively, one or more of the devices shown in FIGS. 37A-38 may be wirelessly connected (e.g., via short-range communication signals).

Memory 3878 includes instructions and data, some or all of which may be stored as non-transitory computer-readable storage media within memory 3878. For example, memory 3878 can include one or more operating systems 3879; one or more communication interface applications 3881; one or more interoperability modules 3884; one or more AR processing applications 3885; one or more data management modules 3886; and/or any other types of applications or modules defined above or described with respect to any other embodiments discussed herein.

Memory 3878 also includes data 3888 which can be used in conjunction with one or more of the applications discussed above. Data 3888 can include: device data 3890; sensor data 3891; and/or any other types of data defined above or described with respect to any other embodiments discussed herein.

In some embodiments, the systems described herein may also include an eye-tracking subsystem designed to identify and track various characteristics of a user's eye(s), such as the user's gaze direction. The phrase “eye tracking” may, in some examples, refer to a process by which the position, orientation, and/or motion of an eye is measured, detected, sensed, determined, and/or monitored. The disclosed systems may measure the position, orientation, and/or motion of an eye in a variety of different ways, including through the use of various optical-based eye-tracking techniques, ultrasound-based eye-tracking techniques, etc. An eye-tracking subsystem may be configured in a number of different ways and may include a variety of different eye-tracking hardware components or other computer-vision components. For example, an eye-tracking subsystem may include a variety of different optical sensors, such as two-dimensional (2D) or 3D cameras, time-of-flight depth sensors, single-beam or sweeping laser rangefinders, 3D LiDAR sensors, and/or any other suitable type or form of optical sensor. In this example, a processing subsystem may process data from one or more of these sensors to measure, detect, determine, and/or otherwise monitor the position, orientation, and/or motion of the user's eye(s).

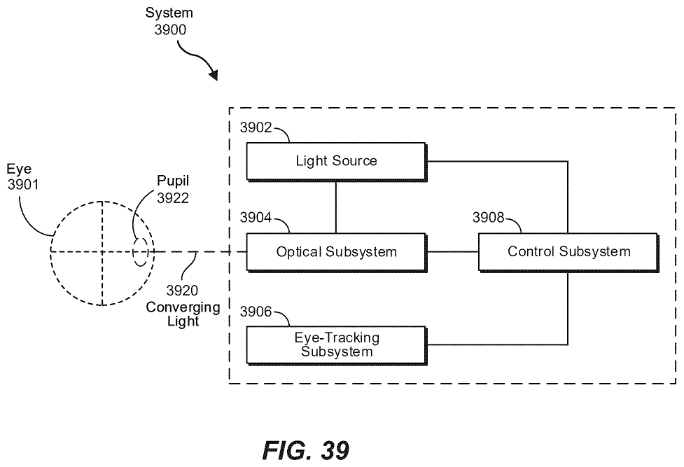

FIG. 39 is an illustration of an example system 3900 that incorporates an eye-tracking subsystem capable of tracking a user's eye(s). As depicted in FIG. 39, system 3900 may include a light source 3902, an optical subsystem 3904, an eye-tracking subsystem 3906, and/or a control subsystem 3908. In some examples, light source 3902 may generate light for an image (e.g., to be presented to an eye 3901 of the viewer). Light source 3902 may represent any of a variety of suitable devices. For example, light source 3902 can include a two-dimensional projector (e.g., an LCoS display), a scanning source (e.g., a scanning laser), or other device (e.g., an LCD, an LED display, an OLED display, an active-matrix OLED display (AMOLED), a transparent OLED display (TOLED), a waveguide, or some other display capable of generating light for presenting an image to the viewer). In some examples, the image may represent a virtual image, which may refer to an optical image formed from the apparent divergence of light rays from a point in space, as opposed to an image formed from the light ray's actual divergence.

In some embodiments, optical subsystem 3904 may receive the light generated by light source 3902 and generate, based on the received light, converging light 3920 that includes the image. In some examples, optical subsystem 3904 may include any number of lenses (e.g., Fresnel lenses, convex lenses, concave lenses), apertures, filters, mirrors, prisms, and/or other optical components, possibly in combination with actuators and/or other devices. In particular, the actuators and/or other devices may translate and/or rotate one or more of the optical components to alter one or more aspects of converging light 3920. Further, various mechanical couplings may serve to maintain the relative spacing and/or the orientation of the optical components in any suitable combination.

In one embodiment, eye-tracking subsystem 3906 may generate tracking information indicating a gaze angle of an eye 3901 of the viewer. In this embodiment, control subsystem 3908 may control aspects of optical subsystem 3904 (e.g., the angle of incidence of converging light 3920) based at least in part on this tracking information. Additionally, in some examples, control subsystem 3908 may store and utilize historical tracking information (e.g., a history of the tracking information over a given duration, such as the previous second or fraction thereof) to anticipate the gaze angle of eye 3901 (e.g., an angle between the visual axis and the anatomical axis of eye 3901). In some embodiments, eye-tracking subsystem 3906 may detect radiation emanating from some portion of eye 3901 (e.g., the cornea, the iris, the pupil, or the like) to determine the current gaze angle of eye 3901. In other examples, eye-tracking subsystem 3906 may employ a wavefront sensor to track the current location of the pupil.

Any number of techniques can be used to track eye 3901. Some techniques may involve illuminating eye 3901 with infrared light and measuring reflections with at least one optical sensor that is tuned to be sensitive to the infrared light. Information about how the infrared light is reflected from eye 3901 may be analyzed to determine the position(s), orientation(s), and/or motion(s) of one or more eye feature(s), such as the cornea, pupil, iris, and/or retinal blood vessels.

In some examples, the radiation captured by a sensor of eye-tracking subsystem 3906 may be digitized (i.e., converted to an electronic signal). Further, the sensor may transmit a digital representation of this electronic signal to one or more processors (for example, processors associated with a device including eye-tracking subsystem 3906). Eye-tracking subsystem 3906 may include any of a variety of sensors in a variety of different configurations. For example, eye-tracking subsystem 3906 may include an infrared detector that reacts to infrared radiation. The infrared detector may be a thermal detector, a photonic detector, and/or any other suitable type of detector. Thermal detectors may include detectors that react to thermal effects of the incident infrared radiation.

In some examples, one or more processors may process the digital representation generated by the sensor(s) of eye-tracking subsystem 3906 to track the movement of eye 3901. In another example, these processors may track the movements of eye 3901 by executing algorithms represented by computer-executable instructions stored on non-transitory memory. In some examples, on-chip logic (e.g., an application-specific integrated circuit or ASIC) may be used to perform at least portions of such algorithms. As noted, eye-tracking subsystem 3906 may be programmed to use an output of the sensor(s) to track movement of eye 3901. In some embodiments, eye-tracking subsystem 3906 may analyze the digital representation generated by the sensors to extract eye rotation information from changes in reflections. In one embodiment, eye-tracking subsystem 3906 may use corneal reflections or glints (also known as Purkinje images) and/or the center of the eye's pupil 3922 as features to track over time.

In some embodiments, eye-tracking subsystem 3906 may use the center of the eye's pupil 3922 and infrared or near-infrared, non-collimated light to create corneal reflections. In these embodiments, eye-tracking subsystem 3906 may use the vector between the center of the eye's pupil 3922 and the corneal reflections to compute the gaze direction of eye 3901. In some embodiments, the disclosed systems may perform a calibration procedure for an individual (using, e.g., supervised or unsupervised techniques) before tracking the user's eyes. For example, the calibration procedure may include directing users to look at one or more points displayed on a display while the eye-tracking system records the values that correspond to each gaze position associated with each point.

In some embodiments, eye-tracking subsystem 3906 may use two types of infrared and/or near-infrared (also known as active light) eye-tracking techniques: bright-pupil and dark-pupil eye tracking, which may be differentiated based on the location of an illumination source with respect to the optical elements used. If the illumination is coaxial with the optical path, then eye 3901 may act as a retroreflector as the light reflects off the retina, thereby creating a bright pupil effect similar to a red-eye effect in photography. If the illumination source is offset from the optical path, then the eye's pupil 3922 may appear dark because the retroreflection from the retina is directed away from the sensor. In some embodiments, bright-pupil tracking may create greater iris/pupil contrast, allowing more robust eye tracking with iris pigmentation, and may feature reduced interference (e.g., interference caused by eyelashes and other obscuring features). Bright-pupil tracking may also allow tracking in lighting conditions ranging from total darkness to a very bright environment.

In some embodiments, control subsystem 3908 may control light source 3902 and/or optical subsystem 3904 to reduce optical aberrations (e.g., chromatic aberrations and/or monochromatic aberrations) of the image that may be caused by or influenced by eye 3901. In some examples, as mentioned above, control subsystem 3908 may use the tracking information from eye-tracking subsystem 3906 to perform such control. For example, in controlling light source 3902, control subsystem 3908 may alter the light generated by light source 3902 (e.g., by way of image rendering) to modify (e.g., pre-distort) the image so that the aberration of the image caused by eye 3901 is reduced.

The disclosed systems may track both the position and relative size of the pupil (since, e.g., the pupil dilates and/or contracts). In some examples, the eye-tracking devices and components (e.g., sensors and/or sources) used for detecting and/or tracking the pupil may be different (or calibrated differently) for different types of eyes. For example, the frequency range of the sensors may be different (or separately calibrated) for eyes of different colors and/or different pupil types, sizes, and/or the like. As such, the various eye-tracking components (e.g., infrared sources and/or sensors) described herein may need to be calibrated for each individual user and/or eye.

The disclosed systems may track both eyes with and without ophthalmic correction, such as that provided by contact lenses worn by the user. In some embodiments, ophthalmic correction elements (e.g., adjustable lenses) may be directly incorporated into the artificial reality systems described herein. In some examples, the color of the user's eye may necessitate modification of a corresponding eye-tracking algorithm. For example, eye-tracking algorithms may need to be modified based at least in part on the differing color contrast between a brown eye and, for example, a blue eye.

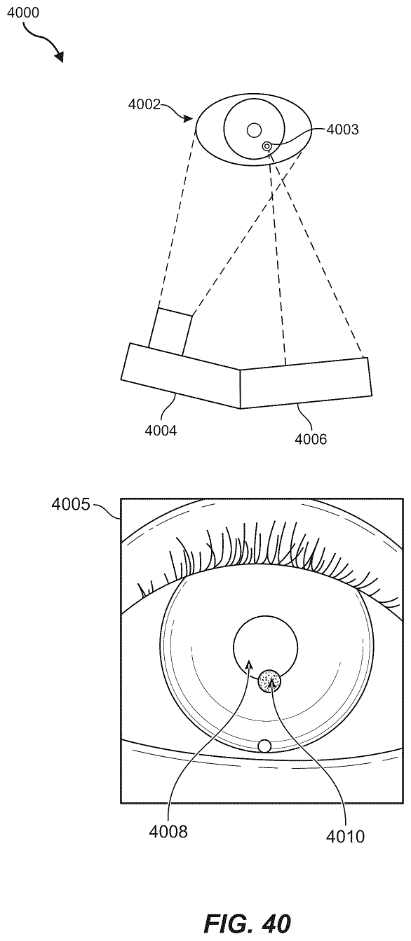

FIG. 40 is a more detailed illustration of various aspects of the eye-tracking subsystem illustrated in FIG. 39. As shown in this figure, an eye-tracking subsystem 4000 may include at least one source 4004 and at least one sensor 4006. Source 4004 generally represents any type or form of element capable of emitting radiation. In one example, source 4004 may generate visible, infrared, and/or near-infrared radiation. In some examples, source 4004 may radiate non-collimated infrared and/or near-infrared portions of the electromagnetic spectrum towards an eye 4002 of a user. Source 4004 may utilize a variety of sampling rates and speeds. For example, the disclosed systems may use sources with higher sampling rates in order to capture fixational eye movements of a user's eye 4002 and/or to correctly measure saccade dynamics of the user's eye 4002. As noted above, any type or form of eye-tracking technique may be used to track the user's eye 4002, including optical-based eye-tracking techniques, ultrasound-based eye-tracking techniques, etc.

Sensor 4006 generally represents any type or form of element capable of detecting radiation, such as radiation reflected off the user's eye 4002. Examples of sensor 4006 include, without limitation, a charge coupled device (CCD), a photodiode array, a complementary metal-oxide-semiconductor (CMOS) based sensor device, and/or the like. In one example, sensor 4006 may represent a sensor having predetermined parameters, including, but not limited to, a dynamic resolution range, linearity, and/or other characteristic selected and/or designed specifically for eye tracking.

As detailed above, eye-tracking subsystem 4000 may generate one or more glints. As detailed above, a glint 4003 may represent reflections of radiation (e.g., infrared radiation from an infrared source, such as source 4004) from the structure of the user's eye. In various embodiments, glint 4003 and/or the user's pupil may be tracked using an eye-tracking algorithm executed by a processor (either within or external to an artificial reality device). For example, an artificial reality device may include a processor and/or a memory device in order to perform eye tracking locally and/or a transceiver to send and receive the data necessary to perform eye tracking on an external device (e.g., a mobile phone, cloud server, or other computing device).

FIG. 40 shows an example image 4005 captured by an eye-tracking subsystem, such as eye-tracking subsystem 4000. In this example, image 4005 may include both the user's pupil 4008 and a glint 4010 near the same. In some examples, pupil 4008 and/or glint 4010 may be identified using an artificial-intelligence-based algorithm, such as a computer-vision-based algorithm. In one embodiment, image 4005 may represent a single frame in a series of frames that may be analyzed continuously in order to track the eye 4002 of the user. Further, pupil 4008 and/or glint 4010 may be tracked over a period of time to determine a user's gaze.

In one example, eye-tracking subsystem 4000 may be configured to identify and measure the inter-pupillary distance (IPD) of a user. In some embodiments, eye-tracking subsystem 4000 may measure and/or calculate the IPD of the user while the user is wearing the artificial reality system. In these embodiments, eye-tracking subsystem 4000 may detect the positions of a user's eyes and may use this information to calculate the user's IPD.

As noted, the eye-tracking systems or subsystems disclosed herein may track a user's eye position and/or eye movement in a variety of ways. In one example, one or more light sources and/or optical sensors may capture an image of the user's eyes. The eye-tracking subsystem may then use the captured information to determine the user's inter-pupillary distance, interocular distance, and/or a 3D position of each eye (e.g., for distortion adjustment purposes), including a magnitude of torsion and rotation (i.e., roll, pitch, and yaw) and/or gaze directions for each eye. In one example, infrared light may be emitted by the eye-tracking subsystem and reflected from each eye. The reflected light may be received or detected by an optical sensor and analyzed to extract eye rotation data from changes in the infrared light reflected by each eye.

The eye-tracking subsystem may use any of a variety of different methods to track the eyes of a user. For example, a light source (e.g., infrared light-emitting diodes) may emit a dot pattern onto each eye of the user. The eye-tracking subsystem may then detect (e.g., via an optical sensor coupled to the artificial reality system) and analyze a reflection of the dot pattern from each eye of the user to identify a location of each pupil of the user. Accordingly, the eye-tracking subsystem may track up to six degrees of freedom of each eye (i.e., 3D position, roll, pitch, and yaw) and at least a subset of the tracked quantities may be combined from two eyes of a user to estimate a gaze point (i.e., a 3D location or position in a virtual scene where the user is looking) and/or an IPD.

In some cases, the distance between a user's pupil and a display may change as the user's eye moves to look in different directions. The varying distance between a pupil and a display as viewing direction changes may be referred to as “pupil swim” and may contribute to distortion perceived by the user as a result of light focusing in different locations as the distance between the pupil and the display changes. Accordingly, measuring distortion at different eye positions and pupil distances relative to displays and generating distortion corrections for different positions and distances may allow mitigation of distortion caused by pupil swim by tracking the 3D position of a user's eyes and applying a distortion correction corresponding to the 3D position of each of the user's eyes at a given point in time. Thus, knowing the 3D position of each of a user's eyes may allow for the mitigation of distortion caused by changes in the distance between the pupil of the eye and the display by applying a distortion correction for each 3D eye position. Furthermore, as noted above, knowing the position of each of the user's eyes may also enable the eye-tracking subsystem to make automated adjustments for a user's IPD.

In some embodiments, a display subsystem may include a variety of additional subsystems that may work in conjunction with the eye-tracking subsystems described herein. For example, a display subsystem may include a varifocal subsystem, a scene-rendering module, and/or a vergence-processing module. The varifocal subsystem may cause left and right display elements to vary the focal distance of the display device. In one embodiment, the varifocal subsystem may physically change the distance between a display and the optics through which it is viewed by moving the display, the optics, or both. Additionally, moving or translating two lenses relative to each other may also be used to change the focal distance of the display. Thus, the varifocal subsystem may include actuators or motors that move displays and/or optics to change the distance between them. This varifocal subsystem may be separate from or integrated into the display subsystem. The varifocal subsystem may also be integrated into or separate from its actuation subsystem and/or the eye-tracking subsystems described herein.

In one example, the display subsystem may include a vergence-processing module configured to determine a vergence depth of a user's gaze based on a gaze point and/or an estimated intersection of the gaze lines determined by the eye-tracking subsystem. Vergence may refer to the simultaneous movement or rotation of both eyes in opposite directions to maintain single binocular vision, which may be naturally and automatically performed by the human eye. Thus, a location where a user's eyes are verged is where the user is looking and is also typically the location where the user's eyes are focused. For example, the vergence-processing module may triangulate gaze lines to estimate a distance or depth from the user associated with intersection of the gaze lines. The depth associated with intersection of the gaze lines may then be used as an approximation for the accommodation distance, which may identify a distance from the user where the user's eyes are directed. Thus, the vergence distance may allow for the determination of a location where the user's eyes should be focused and a depth from the user's eyes at which the eyes are focused, thereby providing information (such as an object or plane of focus) for rendering adjustments to the virtual scene.

The vergence-processing module may coordinate with the eye-tracking subsystems described herein to make adjustments to the display subsystem to account for a user's vergence depth. When the user is focused on something at a distance, the user's pupils may be slightly farther apart than when the user is focused on something close. The eye-tracking subsystem may obtain information about the user's vergence or focus depth and may adjust the display subsystem to be closer together when the user's eyes focus or verge on something close and to be farther apart when the user's eyes focus or verge on something at a distance.

The eye-tracking information generated by the above-described eye-tracking subsystems may also be used, for example, to modify various aspect of how different computer-generated images are presented. For example, a display subsystem may be configured to modify, based on information generated by an eye-tracking subsystem, at least one aspect of how the computer-generated images are presented. For instance, the computer-generated images may be modified based on the user's eye movement, such that if a user is looking up, the computer-generated images may be moved upward on the screen. Similarly, if the user is looking to the side or down, the computer-generated images may be moved to the side or downward on the screen. If the user's eyes are closed, the computer-generated images may be paused or removed from the display and resumed once the user's eyes are back open.

The above-described eye-tracking subsystems can be incorporated into one or more of the various artificial reality systems described herein in a variety of ways. For example, one or more of the various components of system 3900 and/or eye-tracking subsystem 4000 may be incorporated into any of the augmented-reality systems in and/or virtual-reality systems described herein in to enable these systems to perform various eye-tracking tasks (including one or more of the eye-tracking operations described herein).

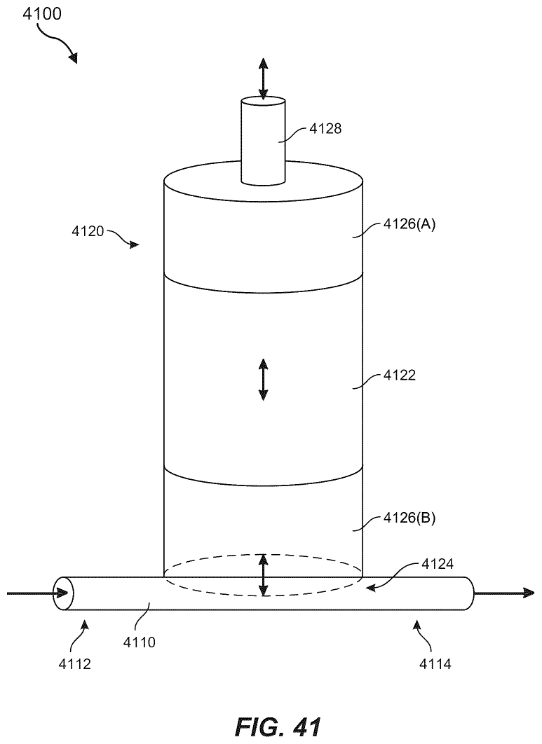

As noted above, the present disclosure may also include haptic fluidic systems that involve the control (e.g., stopping, starting, restricting, increasing, etc.) of fluid flow through a fluid channel. The control of fluid flow may be accomplished with a fluidic valve. FIG. 41 shows a schematic diagram of a fluidic valve 4100 for controlling flow through a fluid channel 4110, according to at least one embodiment of the present disclosure. Fluid from a fluid source (e.g., a pressurized fluid source, a fluid pump, etc.) may flow through the fluid channel 4110 from an inlet port 4112 to an outlet port 4114, which may be operably coupled to, for example, a fluid-driven mechanism, another fluid channel, or a fluid reservoir.

Fluidic valve 4100 may include a gate 4120 for controlling the fluid flow through fluid channel 4110. Gate 4120 may include a gate transmission element 4122, which may be a movable component that is configured to transmit an input force, pressure, or displacement to a restricting region 4124 to restrict or stop flow through the fluid channel 4110. Conversely, in some examples, application of a force, pressure, or displacement to gate transmission element 4122 may result in opening restricting region 4124 to allow or increase flow through the fluid channel 4110. The force, pressure, or displacement applied to gate transmission element 4122 may be referred to as a gate force, gate pressure, or gate displacement. Gate transmission element 4122 may be a flexible element (e.g., an elastomeric membrane, a diaphragm, etc.), a rigid element (e.g., a movable piston, a lever, etc.), or a combination thereof (e.g., a movable piston or a lever coupled to an elastomeric membrane or diaphragm).

As illustrated in FIG. 41, gate 4120 of fluidic valve 4100 may include one or more gate terminals, such as an input gate terminal 4126(A) and an output gate terminal 4126(B) (collectively referred to herein as “gate terminals 4126”) on opposing sides of gate transmission element 4122. Gate terminals 4126 may be elements for applying a force (e.g., pressure) to gate transmission element 4122. By way of example, gate terminals 4126 may each be or include a fluid chamber adjacent to gate transmission element 4122. Alternatively or additionally, one or more of gate terminals 4126 may include a solid component, such as a lever, screw, or piston, that is configured to apply a force to gate transmission element 4122.

In some examples, a gate port 4128 may be in fluid communication with input gate terminal 4126(A) for applying a positive or negative fluid pressure within the input gate terminal 4126(A). A control fluid source (e.g., a pressurized fluid source, a fluid pump, etc.) may be in fluid communication with gate port 4128 to selectively pressurize and/or depressurize input gate terminal 4126(A). In additional embodiments, a force or pressure may be applied at the input gate terminal 4126(A) in other ways, such as with a piezoelectric element or an electromechanical actuator, etc.

In the embodiment illustrated in FIG. 41, pressurization of the input gate terminal 4126(A) may cause the gate transmission element 4122 to be displaced toward restricting region 4124, resulting in a corresponding pressurization of output gate terminal 4126(B). Pressurization of output gate terminal 4126(B) may, in turn, cause restricting region 4124 to partially or fully restrict to reduce or stop fluid flow through the fluid channel 4110. Depressurization of input gate terminal 4126(A) may cause gate transmission element 4122 to be displaced away from restricting region 4124, resulting in a corresponding depressurization of the output gate terminal 4126(B). Depressurization of output gate terminal 4126(B) may, in turn, cause restricting region 4124 to partially or fully expand to allow or increase fluid flow through fluid channel 4110. Thus, gate 4120 of fluidic valve 4100 may be used to control fluid flow from inlet port 4112 to outlet port 4114 of fluid channel 4110.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

As used herein, the term “substantially” in reference to a given parameter, property, or condition may mean and include to a degree that one of ordinary skill in the art would understand that the given parameter, property, or condition is met with a small degree of variance, such as within acceptable manufacturing tolerances. By way of example, depending on the particular parameter, property, or condition that is substantially met, the parameter, property, or condition may be at least approximately 90% met, at least approximately 95% met, or even at least approximately 99% met.

As used herein, the term “approximately” in reference to a particular numeric value or range of values may, in certain embodiments, mean and include the stated value as well as all values within 10% of the stated value. Thus, by way of example, reference to the numeric value “50” as “approximately 50” may, in certain embodiments, include values equal to 50±5, i.e., values within the range 45 to 55.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

It will be understood that when an element such as a layer or a region is referred to as being formed on, deposited on, or disposed “on” or “over” another element, it may be located directly on at least a portion of the other element, or one or more intervening elements may also be present. In contrast, when an element is referred to as being “directly on” or “directly over” another element, it may be located on at least a portion of the other element, with no intervening elements present.

While various features, elements or steps of particular embodiments may be disclosed using the transitional phrase “comprising,” it is to be understood that alternative embodiments, including those that may be described using the transitional phrases “consisting of” or “consisting essentially of,” are implied. Thus, for example, implied alternative embodiments to a lens that comprises or includes polycarbonate include embodiments where a lens consists essentially of polycarbonate and embodiments where a lens consists of polycarbonate.

What is claimed is:

1. A display system comprising:
a narrow band light source having a bandwidth (Δλ);
an illumination module optically coupled to the light source,
wherein the illumination module comprises a 2D array of diffusing elements,
wherein a coherent length (λ²/Δλ) of the light source is less than a difference between an optical path length from the light source to a first diffusing element and an optical path length from the light source to a second diffusing element;
a spatial light modulator arranged to be illuminated by the array of diffusing elements; and
a projector system configured to substantially collimate light received from the spatial light modulator.

2. The display system of claim 1, wherein the narrow band light source comprises a laser.

3. The display system of claim 1, wherein the illumination module comprises a polarization selective diffuser configured to diffuse light having a first polarization state and transmit light having a second polarization state.

4. The display system of claim 1, wherein the 2D array of diffusing elements is configured as a microlens array.

5. The display system of claim 1, wherein the 2D array of diffusing elements is arranged such that a period of the array defines an optical path length difference between the light source and each diffusing element that is greater than the coherent length of the light source.

6. The display system of claim 1, wherein the spatial light modulator is configured to modulate red, green, and blue light sequentially to generate a color image.

7. The display system of claim 1, wherein the spatial light modulator comprises a liquid crystal on silicon (LCoS) display panel.

8. The display system of claim 1, wherein the projector system is optically coupled to a waveguide configured to direct image light to a user's eye.

9. The display system of claim 1, further comprising a polarization beam splitter located between the illumination module and the spatial light modulator.

10. A display engine comprising:
a light source;
an illumination module optically coupled to the light source;
a liquid crystal on silicon (LCoS) display panel; and
a polarization selective diffuser located between the illumination module and the LCoS display panel, wherein the polarization selective diffuser is configured to diffuse light having a first polarization state and transmit light having a second polarization state.

11. The display engine of claim 10, wherein the illumination module comprises a microlens array configured to diffuse light passing from the illumination module to the LCoS display panel.

12. The display engine of claim 10, wherein the illumination module comprises a diffractive grating element disposed over a surface of the illumination module.

13. The display engine of claim 10, wherein the LCoS display panel is configured to modulate red, green, and blue light sequentially to generate a color image.

14. The display engine of claim 10, wherein the polarization selective diffuser comprises a liquid crystal-polymer network located between opposing electrodes.

15. The display engine of claim 10, wherein the polarization selective diffuser comprises a piezoelectrically-actuatable volumetric Bragg grating.

16. The display engine of claim 10, further comprising projection optics configured to direct image light emitted from the LCoS display panel.

17. The display engine of claim 16, further comprising a waveguide configured to receive the image light from the projection optics.

18. A display engine comprising:
a light source;
an illumination module optically coupled to the light source;
a diffractive grating element disposed over a surface of the illumination module;
a liquid crystal on silicon (LCoS) display panel arranged to receive light from the illumination module; and
a microlens array co-integrated with the diffractive grating element, wherein the microlens array is configured to diffuse source light directed toward the display panel.

19. The display engine of claim 18, wherein the microlens array comprises a plurality of lenslets distributed across two dimensions, each lenslet having a defined optical power.

20. The display engine of claim 18, wherein the microlens array is co-extensive with the diffractive grating element and is configured to increase the angular spread of source light directed toward the display panel.
